(19) United States
(12) Patent Application Publication
(10) Pub. No.: US 2026/0327521 A1
(43) Pub. Date: Oct. 22, 2026

(54) DRYER SHEET AND PROCESS OF MAKING

(71) Applicant: The Procter & Gamble Company, Cincinnati, OH (US)

(72) Inventors: Renae Dianna FOSSUM, Middletown, OH (US); William Peter MCDERMOTT, III, Cincinnati, OH (US); Rafael TRUJILLO, Mason, OH (US); Laura ORLANDINI, Le Mont-sur-Lausanne (CH); Jennifer Lea RINKER, Hamilton, OH (US); Sebastien GROFILS, Spy (BE); Rahma BENBAKOURA, Quaregnon (BE)

(21) Appl. No.: 19/175,465

(22) Filed: Apr. 10, 2025

(51) Int. Cl. C11D 3/37; C11D 3/00; C11D 3/12; C11D 3/20; C11D 3/34; C11D 3/50; C11D 17/06

(52) U.S. Cl. CPC C11D 3/373; C11D 3/0005; C11D 3/1253; C11D 3/2079; C11D 3/3409; C11D 3/505; C11D 17/06; C11D 2111/12

(57) ABSTRACT

A dryer sheet including a nonwoven fibrous substrate and a fabric care composition associated with the nonwoven fibrous substrate. The dryer sheet includes about 10 to about 60 wt. % of a fabric softening active, by weight of the dryer sheet; and about 0.2 to about 8 wt. % of a silicic acid perfume ester, by weight of the dryer sheet. The silicic acid perfume ester includes a silicon moiety and a fragrance moiety. The fragrance moiety comprises an alcohol-based perfume, and optionally a neat perfume. The dryer sheet includes from about 50 to about 95 wt. % of the fabric care composition, by weight of the dryer sheet.

### TECHNICAL FIELD

Dryer sheets for use in a tumble dryer.

### BACKGROUND

Dryer sheets are commonly employed in automatic laundry drying machines to provide softening, anti-static, scent, and other benefits to garments and other textiles. There are a few performance metrics which consumers typically associate with dryer sheets. Typically, consumers add dryer sheets to help reduce or eliminate static cling for fabrics within the dryer, to soften fabrics, help reduce wrinkles for fabrics within the dryer, and to provide a freshness or scent benefit to the user and/or fabrics within the dryer.

In conventional dryer sheets, there are two mechanisms of delivering freshness and scent benefits. First, many conventional dryer sheets comprise a neat perfume. The neat perfume can provide a freshness and scent benefit at different touchpoints to the consumer. For example, when a user first opens the package of dryer sheets, neat perfume can provide a freshness and scent benefit to the user when perfume diffuses into the air. During use in the dryer, the neat perfume can deposit onto fabrics, however, in use, the heat of the dryer can cause most of the volatile perfume raw materials (PRM) in the neat perfume to evaporate rather quickly with some highly volatile PRM evaporating in the first few minutes of the drying time. As such, the deposition of neat perfume onto fabrics may be very low and the user may not experience sufficient freshness intensity. Another problem that arises from loss of volatile PRM is that the character on treated fabrics may not be the same as what the consumer smells from a single dryer sheet or from an open package of dryer sheets. Low freshness performance after using scented dryer sheets is disappointing to consumers.

Pro-perfumes are known to mitigate perfume loss during the laundry process and can be used to deliver controlled release for a long-lasting scent, however typical commercially-available pro-perfumes suffer from efficient transfer from the dryer sheet to the fabric. Thus, there remains a need for more efficient delivery of perfume to fabric. As a second mechanism of freshness and scent benefit delivery, some conventional dryer sheets may include encapsulated perfume particles which are designed to provide a freshness and scent benefit by diffusion of the encapsulated perfume through the encapsulated perfume particle wall, as well as releasing perfume when encapsulated perfume particles are ruptured. However, in a dryer sheet application, perfume diffusion may be limited when the encapsulated perfume is coated with other dryer sheet ingredients that decrease diffusion of the encapsulated perfume through the particle wall. Furthermore, deposition of encapsulated perfumes onto fabrics from dryer sheets is extremely low.

The underperformance of the above two freshness mechanisms can frustrate the consumer if their experience with dryer sheets does not satisfactorily meet the user's expectations on freshness or scent which is one of the key performance metrics of the dryer sheet. With these limitations in mind, there is a continuing unmet need for dryer sheets that can provide the user with a noticeable and pleasurable scent for much longer period than that of conventional dryer sheets.

### SUMMARY

Dryer sheets of the present disclosure provide improved deposition and release of perfume to textile articles within the automatic dryer and can additionally provide improved perfume release of encapsulated perfumes/benefit agents. Furthermore, dryer sheets of the present disclosure can provide improved perfume release from the neat product from a single dryer sheet and even a package of dryer sheets. Dryer sheets of the present disclosure include a nonwoven fibrous substrate and a fabric care composition associated with the nonwoven fibrous substrate. The dryer sheet includes about 10 to about 60 wt. % of a fabric softening active, by weight of the dryer sheet; and about 0.2 to about 10 wt. % of a silicic acid perfume ester, by weight of the dryer sheet. The silicic acid perfume ester includes a silicon moiety and a fragrance moiety. The fragrance moiety comprises an alcohol-based perfume, and optionally a neat perfume. The dryer sheet includes from about 50 to about 95 wt. % of the fabric care composition, by weight of the dryer sheet.

### DETAILED DESCRIPTION

Dryer sheets of the present disclosure can provide improved freshness performance by improving deposition and release of neat perfume and/or improved deposition of encapsulated perfumes. The dryer sheets of the present disclosure comprise a nonwoven fibrous substrate and a fabric care composition which is associated with the nonwoven fibrous substrate. For example, the fabric care composition may be coated onto the nonwoven fibrous substrate. Any suitable method for deposition of the fabric care composition may be utilized.

In examples, the fabric care composition may be loaded onto the dryer sheet at a weight ratio of fabric care composition to nonwoven substrate from about 0.3:1 to about 10:1, from about 0.3:1 to about 8:1, from about 0.3:1 to about 5:1, from about 0.3:1 to about 3:1, from about 0.3:1 to about 2:1, from about 0.3:1 to about 1:1, from about 0.5:1 to about 10:1, from about 0.5:1 to about 8:1, from about 0.5:1 to about 5:1, from about 0.5:1 to about 3:1, from about 0.5:1 to about 2:1, from about 0.5:1 to about 1:1, from about 1:1 to about 10:1, from about 1:1 to about 8:1, from about 1:1 to about 5:1, from about 1:1 to about 3:1, from about 1:1 to about 2:1, from about 2:1 to about 10:1, from about 2:1 to about 8:1, from about 2:1 to about 5:1, from about 2:1 to about 3:1, from about 3:1 to about 10:1, from about 3:1 to about 8:1, from about 3:1 to about 5:1, from about 5:1 to about 10:1, from about 5:1 to about 8:1, from about 8:1 to about 10:1, or any ranges created thereby.

### Fabric Care Composition

The fabric care composition may include a fabric softening active and a silicic acid perfume ester. The fabric care composition may optionally include a neat perfume, an encapsulated perfume, and/or a benefit agent. While conventional wisdom would suggest that improved delivery of freshness and scent benefits to a user can be achieved via a higher weight percentage of perfume or encapsulated perfume in a fabric care composition coated onto the nonwoven fibrous substrate, the inventors have discovered differently. Increasing neat perfume in the dryer sheet composition does not substantially improve freshness on treated fabrics since most of the neat perfume is lost during the drying cycle and in fact sets up an imbalance in consumer expectations between a strong neat product scent of the dryer sheet and weak scent on treated fabrics. Increasing the amount of encapsulated perfume particles does not noticeably help with increased scent since deposition efficiency from a dryer sheet is so low unless 10-times or 20-times the amount of encapsulated perfume particles is used, which is cost prohibitive. The inventors have also found that increasing the basis weight of the fabric care composition is not advantageous for freshness since the hydrophobic ingredients of the fabric care composition can actually suppress freshness release into the atmosphere. The fabric care composition may include a fabric softening active with a quaternary ammonium compound with a long-chain fatty chain that forms a lamellar sheet microstructure on the non-woven fibrous substrate. The lamellar sheet microstructure has hydrophilic quaternary ammonium headgroups and hydrophobic tails where the PRM that are hydrophobic can be associated with the hydrophobic tail region thus remaining associated with the hydrophobic matrix versus diffusing into the air thereby decreasing perfume release.

However, since the dryer sheet is viewed as providing a multitude of benefits, there is similarly a minimal amount of fabric care composition required to deliver these benefits. For example, a minimal amount of fabric care composition, used only as a carrier, could be utilized for the increased release of neat perfume and encapsulated perfume particles. Such a configuration could provide a user with a freshness benefit, i.e., a pleasant fragrance bloom when opening the dryer door and/or an additional freshness benefit when the capsules are ruptured and release fragrance. However, dryer sheets, according to many mindsets of users, are also expected to provide other benefits as well, e.g., prevention of static cling of textiles to one another, softening and feel benefits, wrinkle benefits, etc. To accommodate these textile benefits in conjunction with the freshness benefit, a minimal amount of composition mixture is required. The dryer sheet may include from about 50 wt. % to about 95 wt. %, preferably about 60 wt. % to about 90 wt. %, even more preferably from about 65 wt. % to about 85 wt. %, or any ranges created thereby, of the fabric care composition by weight of the dryer sheet.

### Fabric Softening Active

The fabric softening active can be the fabric softening active used presently or in the past or like that used presently or in the past in BOUNCE dryer sheets, available from The Procter & Gamble Company, Cincinnati, OH, United States of America, SNUGGLE dryer sheets, available from Henkel Corporation, Stamford, Connecticut, United States of America, and or SUAVITEL dryer sheets, available from Colgate-Palmolive Company, New York, New York, United States of America. The fabric care composition may include from about 40% to about 75% of fabric softening active, by weight of the composition mixture. The fabric softening active may include a quaternary ammonium compound, a fatty acid, or both.

The fabric care composition may include from 40% to 75%, from 40% to 70%, from 40% to 65%, from 40% to 60%, from 40% to 55%, from 40% to 50%, from 40% to 45%, from 45% to 75%, from 45% to 70%, from 45% to 65%, from 45% to 60%, from 45% to 55%, from 45% to 50%, from 50% to 75%, from 50% to 70%, from 50% to 65%, from 50% to 60%, from 50% to 55%, from 55% to 75%, from 55% to 70%, from 55% to 65%, from 55% to 60%, from 60% to 75%, from 60% to 70%, from 60% to 65%, from 65% to 75%, from 65% to 70%, or from 70% to 75% fabric softening active, by weight of the fabric care composition. In examples, the dryer sheet may include from 10 to 60 wt. %, from 10 to 55 wt. %, from 10 to 50 wt. %, from 10 to 45 wt. %, from 10 to 40 wt. %, from 10 to 35 wt. %, from 10 to 30 wt. %, from 10 to 25 wt. %, from 10 to 20 wt. %, from 10 to 15 wt. %, from 15 to 60 wt. %, from 15 to 55 wt. %, from 15 to 50 wt. %, from 15 to 45 wt. %, from 15 to 40 wt. %, from 15 to 35 wt. %, from 15 to 30 wt. %, from 15 to 25 wt. %, from 15 to 20 wt. %, from 20 to 60 wt. %, from 20 to 55 wt. %, from 20 to 50 wt. %, from 20 to 45 wt. %, from 20 to 40 wt. %, from 20 to 35 wt. %, from 20 to 30 wt. %, from 20 to 25 wt. %, from 25 to 60 wt. %, from 25 to 55 wt. %, from 25 to 50 wt. %, from 25 to 45 wt. %, from 25 to 40 wt. %, from 25 to 35 wt. %, from 25 to 30 wt. %, from 30 to 60 wt. %, from 30 to 55 wt. %, from 30 to 50 wt. %, from 30 to 45 wt. %, from 30 to 40 wt. %, from 30 to 35 wt. %, from 35 to 60 wt. %, from 35 to 55 wt. %, from 35 to 50 wt. %, from 35 to 45 wt. %, from 35 to 40 wt. %, from 40 to 60 wt. %, from 40 to 55 wt. %, from 40 to 50 wt. %, from 40 to 45 wt. %, from 45 to 60 wt. %, from 45 to 55 wt. %, from 45 to 50 wt. %, from 50 to 60 wt. %, from 50 to 55 wt. %, from 55 to 60 wt. %, or any combination of ranges created thereby, of fabric softening active, by weight of the dryer sheet.

### Quaternary Ammonium Compound

The quaternary ammonium compound can be an ester quaternary ammonium compound. Suitable quaternary ammonium compounds include but are not limited to, materials selected from the group consisting of ester quats, amide quats, imidazoline quats, alkyl quats, amidoester quats and combinations thereof. Suitable ester quats include but are not limited to, materials selected from the group consisting of monoester quats, diester quats, triester quats and combinations thereof. The fabric softening active can be a branched polyester.

The quaternary ammonium compound can have an iodine value of from about 0 to about 65, from about 0 to about 45, from about 0 to about 35, preferably from about 5 to about 50, even more preferably from about 5 to about 35. Optionally, the iodine value of the parent fatty acid from which the quaternary ammonium compound is formed can be from about 0 to about 50, optionally from about 30 to about 48, optionally from about 32 to 45. Optionally, the parent fatty acid from which the quaternary ammonium compound is formed can comprise from about 2 to about 20 percent by weight of the total fatty acid chains double unsaturated C18 chains.

The quaternary ammonium compound may be derived from fatty acids and optionally from triethanolamine, optionally unsaturated fatty acids that include eighteen carbons (“C18 fatty acids”), optionally C18 fatty acids that include a single double bone (“C18:1 fatty acids”). The quaternary ammonium compound may comprise from about 10% to about 95%, or from about 10% to about 90%, or from about 15% to about 80%, by weight of the quaternary ammonium compound, of compounds derived from triethanolamine and C18:1 fatty acids.

Suitable quaternary ammonium ester compounds may be derived from alkanolamines, for example, C1-C4 alkanolamines, optionally C2 alkanolamines (e.g., ethanolamines). The quaternary ammonium ester compounds may be derived from monoalkanolamines, dialkanolamines, trialkanolamines, or mixtures thereof, optionally monoethanolamines, diethanolamines, di-isopropanolamines, triethanolamines, or mixtures thereof. The alkanolamines from which the quaternary ammonium ester compounds are derived may be alkylated mono- or dialkanolamines, for example C1-C4 alkylated alkanolamines, optionally C1 alkylated alkanolamines (e.g., N-methyldiethanolamine).

The quaternary ammonium ester compound may comprise a quaternized nitrogen atom that is substituted, at least in part. The quaternized nitrogen atom may be substituted, at least in part, with one or more C1-C3 alkyl or C1-C3 hydroxyl alkyl groups. The quaternized nitrogen atom may be substituted, at least in part, with a moiety selected from the group consisting of methyl, ethyl, propyl, hydroxyethyl, 2-hydroxypropyl, 1-methyl-2-hydroxyethyl, poly(C₂-C₃ alkoxy), polyethoxy, benzyl, optionally methyl or hydroxyethyl.

The quaternary ammonium ester compound may comprise compounds according to Formula (I):

{R²₍₄₋ₘ₎−N+−[X−Y−R¹]ₘ}A⁻ Formula (I)
wherein:

m is 1, 2 or 3, with provisos that, in a given molecule, the value of each m is identical, and when (a) the quaternary ammonium ester compound comprises triester quaternary ammonium material (“triester quat”), for at least some of the compounds according to Formula (I), m is 3 (i.e., a triester);
each R¹, which may comprise from 13 to 22 carbon atoms, is independently a linear hydrocarbyl or branched hydrocarbyl group, optionally R¹ is linear, optionally R¹ is partially unsaturated linear alkyl chain;
each R² is independently a C₁-C₃ alkyl or hydroxyalkyl group and/or each R² is selected from methyl, ethyl, propyl, hydroxyethyl, 2-hydroxypropyl, 1-methyl-2-hydroxyethyl, poly(C₂-C₃ alkoxy), polyethoxy, benzyl, optionally methyl or hydroxyethyl;
each X is independently —(CH₂)ₙ—, —CH₂—CH(CH₃)— or —CH(CH₃)—CH₂—, where each n is independently 1, 2, 3 or 4, optionally each n is 2;
each Y is independently —O—(O)C— or —C(O)—O—; and
A- is independently selected from the group consisting of chloride, bromide, methyl sulfate, ethyl sulfate, sulfate, and nitrate, optionally A- is selected from the group consisting of chloride and methyl sulfate, optionally A- is methyl sulfate.

At least one X, optionally each X, may be independently selected from —CH₂—CH(CH₃)— or —CH(CH₃)—CH₂—. When m is 2, X may be selected from *—CH₂—CH(CH₃)—, *—CH(CH₃)—CH₂—, or a mixture thereof, where the * indicates the end nearest the nitrogen of the quaternary ammonium ester compound. When there are two or more X groups present in a single compound, at least two of the X groups may be different from each other. For example, when m is 2, one X (e.g., a first X) may be *—CH₂—CH(CH₃)—, and the other X (e.g., a second X) may be *—CH(CH₃)—CH₂—, where the * indicates the end nearest the nitrogen of the quaternary ammonium ester compound. It has been found that such selections of the m index and X groups can improve the hydrolytic stability of the quaternary ammonium ester compound, and hence further improve the stability of the composition.

For similar stability reasons, the quaternary ammonium ester compound may comprise a mixture of: bis-(2-hydroxypropyl)-dimethylammonium methylsulfate fatty acid ester and isomers of bis-(2-hydroxypropyl)-dimethylammonium methylsulfate fatty acid ester and/or mixtures thereof, N,N-bis(stearoyl-oxy-ethyl)-N-(2 hydroxyethyl)-N-methyl ammonium methylsulfate, N,N-bis-(stearoyl-2-hydroxypropyl)-N,N-dimethylammonium methylsulfate, N,N-di(tallowyl-oxy-ethyl)-N-methyl, N-(2-hydroxyethyl) ammonium methyl sulfate, N,N-bis-(tallowoyl-2-hydroxypropyl)-N,N-dimethylammonium methylsulfate, N,N-bis-(palmitoyl-2-hydroxypropyl)-N,N-dimethylammoniummethylsulfate, dicanoladimethylammonium methylsulfate, 1-methyl-1-stearoylamidoethyl-2-stearoylimidazolinium methylsulfate, 1-tallowylamidoethyl-2-tallowylimidazoline, dipalmylmethyl hydroxyethylammonium methylsulfate and combinations thereof; where the fatty acid esters are produced from a C12-C18 fatty acid mixture. The quaternary ammonium ester compound may comprise any of the fatty acid esters, individually or as a mixture, listed in this paragraph.

Each X may be —(CH₂)ₙ—, where each n is independently 1, 2, 3 or 4, optionally each n is 2. Each R¹ group may correspond to, and/or be derived from, the alkyl portion(s) of any of the fatty acids provided above. The R¹ groups may comprise, by weight average, from about 13 to about 22 carbon atoms, or from about 14 to about 20 carbon atoms, optionally from about 16 to about 18 carbon atoms. It may be that when Y is *—O—(O)C— (where the * indicates the end nearest the X moiety), the sum of carbons in each R₁ is from 13 to 21, optionally from 13 to 19.

The quaternary ammonium compounds of the present disclosure may include a mixture of quaternary ammonium compounds according to Formula (I), for example, having some compounds where m=1 (e.g., monoesters) and some compounds where m=2 (e.g., diesters). Some mixtures may even contain compounds where m=3 (e.g., triesters). The quaternary ammonium compounds may include compounds according to Formula (I), where m is 1 or 2, but not 3 (e.g., is substantially free of triesters).

The quaternary ammonium compounds of the present disclosure may include compounds according to Formula (I), wherein each R² is a methyl group. The quaternary ammonium compounds of the present disclosure may include compounds according to Formula (I), wherein at least one R², optionally wherein at least one R² is a hydroxyethyl group and at least one R² is a methyl group. For compounds according to Formula (I), m may equal 1, and only one R² may be a hydroxyethyl group.

The quaternary ammonium compounds of the present disclosure may include methyl sulfate as a counterion. When the quaternary ammonium ester compounds of the present disclosure comprise compounds according to Formula (I), A- may optionally be methyl sulfate.

The quaternary ammonium compounds of the present disclosure may comprise one or members selected from the group consisting of:
(A) bis-(2-hydroxypropyl)-dimethylammonium methylsulfate fatty acid ester and isomers of bis-(2-hydroxypropyl)-dimethylammonium methylsulfate fatty acid ester and/or mixtures thereof; N,N-bis-(2-(acyl-oxy)-propyl)-N,N-dimethylammonium methylsulfate and/or N-(2-(acyl-oxy)-propyl)N-(2-(acyl-oxy) 1-methyl-ethyl) N,N-dimethylammonium methylsulfate and/or mixtures thereof, in which the acyl moiety is derived from c12-c22 fatty acids such as Palm, Tallow, Canola and/or other suitable fatty acids, which can be fractionated and/or hydrogenated, and/or mixtures thereof;
(B) 1,2-di(acyloxy)-3-trimethylammoniopropane chloride in which the acyl moiety is derived from c12-c22 fatty acids such as Palm, Tallow, Canola and/or other suitable fatty acids, which can be fractionated and/or hydrogenated, and/or mixtures thereof;
(C) N,N-bis(hydroxyethyl)-N,N-dimethyl ammonium chloride fatty acid esters; N,N-bis(acyl-oxy-ethyl)-N,N-dimethyl ammonium chloride in which the acyl moiety is derived from C12-C22 fatty acids such as Palm, Tallow, Canola and/or other suitable fatty acids, which can be fractionated and/or hydrogenated, and/or mixtures thereof, such as N,N-bis(tallowoyl-oxy-ethyl) N,N-dimethyl ammonium chloride;
(D) esterification products of Fatty Acids with Triethanolamine, quaternized with Dimethyl Sulphate; N,N-bis(acyl-oxy-ethyl)N-(2-hydroxyethyl)-N-methyl ammonium methylsulfate in which the acyl moiety is derived from C12-C22 fatty acids such as Palm, Tallow, Canola and/or other suitable fatty acids, which can be fractionated and/or hydrogenated, and/or mixtures thereof, such as N,N-bis(tallowoyl-oxy-ethyl)N-(2-hydroxyethyl)-N-methyl ammonium methylsulfate;
(E) dicanoladimethylammonium chloride; di(hard) tallowdimethylammonium chloride; dicanoladimethylammonium methylsulfate; 1-methyl-1-stearoylamidoethyl-2-stearoylimidazolinium methylsulfate; 1-tallowylamidoethyl-2-tallowylimidazoline; dipalmylmethyl hydroxyethylammoinum methylsulfate; and/or
(F) mixtures thereof.

Examples of suitable quaternary ammonium ester compound are commercially available from Evonik under the tradename REWOQUAT WE18 and/or REWOQUAT WE20, and from Stepan under the tradename STEPANTEX GA90, STEPANTEX VK90, and/or STEPANTEX VL90A. These types of agents and general methods of making them are disclosed in United States of America U.S. Pat. No. 4,237,180.

It is understood that compositions that comprise a quaternary ammonium ester compound as a fabric conditioning active may further comprise non-quaternized derivatives of such compounds, as well as unreacted reactants (e.g., free fatty acids).

The quaternary ammonium compound can be that used as part of BOUNCE dryer sheets available from The Procter & Gamble Company, Cincinnati, Ohio, USA. The quaternary ammonium compound can be the reaction product of triethanolamine and partially hydrogenated tallow fatty acids quaternized with dimethyl sulfate.

It will be understood that combinations of quaternary ammonium compounds disclosed above are suitable for use in the present disclosure.

In examples, the dryer sheet may include from about 10 to about 60 wt. %, from about 10 to about 55 wt. %, from about 10 to about 50 wt. %, from about 10 to about 45 wt. %, from about 10 to about 40 wt. %, from about 15 to about 60 wt. %, from about 15 to about 55 wt. %, from about 15 to about 50 wt. %, from about 15 to about 45 wt. %, from about 15 to about 40 wt. %, from about 20 to about 60 wt. %, from about 20 to about 55 wt. %, from about 20 to about 50 wt. %, from about 20 to about 45 wt. %, from about 20 to about 40 wt. %, from about 25 to about 60 wt. %, from about 25 to about 55 wt. %, from about 25 to about 50 wt. %, from about 25 to about 45 wt. %, from about 25 to about 40 wt. %, from about 30 to about 60 wt. %, from about 30 to about 55 wt. %, from about 30 to about 50 wt. %, from about 30 to about 45 wt. %, from about 30 to about 40 wt. %, from about 35 to about 60 wt. %, from about 35 to about 55 wt. %, from about 35 to about 50 wt. %, from about 35 to about 45 wt. %, from about 35 to about 40 wt. %, or any ranges created thereby, of quaternary ammonium compound, by weight of the dryer sheet.

### Fatty Acid

The fabric care composition can comprise fatty acid. The term “fatty acid” is used herein in the broadest sense to include unprotonated or protonated forms of a fatty acid. One skilled in the art will readily appreciate that the pH of an aqueous composition will dictate, in part, whether a fatty acid is protonated or unprotonated. The fatty acid may be in its unprotonated, or salt form, together with a counter ion, such as, but not limited to, calcium, magnesium, sodium, potassium, and the like. The term “free fatty acid” means a fatty acid that is not bound to another chemical moiety (covalently or otherwise).

The fatty acid may include those containing from 12 to 25, from 13 to 22, or even from 16 to 20, total carbon atoms, with the fatty moiety containing from 10 to 22, from 12 to 18, or even from 14 (mid-cut) to 18 carbon atoms.

Mixtures of fatty acids from different fat sources can be used. Branched fatty acids such as isostearic acid are also suitable since they may be more stable with respect to oxidation and the resulting degradation of color and odor quality.

The fatty acid can be selected from the group consisting of saturated fatty acids, unsaturated fatty acid, and mixtures thereof. The fatty acid can be a blend of saturated fatty acids, a blend of unsaturated fatty acids, and mixtures thereof. The fatty acid can be substituted or unsubstituted. The fatty acid can be provided with the quaternary ammonium compound. The fatty acid can have an Iodine Value of zero.

The fatty acid can be selected from the group consisting of stearic acid, isostearic acid, palmitic acid, coconut oil, palm kernel oil, stearic acid palmitic acid blend, oleic acid, linoleic acid, alpha-linolenic acid, myristic acid, behenic acid, erucic acid, vegetable oil, partially hydrogenated vegetable oil, and mixtures thereof.

The fatty acid can be Stearic acid CAS No. 57-11-4. The fatty acid can be palmitic acid CAS No. 57-10-3. The fatty acid can be a blend of stearic acid and coconut oil. The fatty acid can be C12 to C22 fatty acid. C12 to C22 fatty acid can have tallow or vegetable origin, can be saturated or unsaturated, can be substituted or unsubstituted.

Without being bound by theory, fatty acid may help as a processing aid for uniformly mixing the formulation components of the fabric care composition and managing viscosity during processing.

The fabric care composition can comprise from about 5% to about 50%, by weight of the fabric care composition, of fatty acid. The fabric care composition can contain less than about 5% by weight of fatty acid, by weight of the fabric care composition. In examples, the dryer sheet may include from about 5 to about 50 wt. %, from about 5 to about 40 wt. %, from about 5 to about 35 wt. %, from about 5 to about 30 wt. %, from about 10 to about 50 wt. %, from about 10 to about 40 wt. %, from about 10 to about 35 wt. %, from about 10 to about 30 wt. %, from about 15 to about 50 wt. %, from about 15 to about 40 wt. %, from about 15 to about 35 wt. %, from about 15 to about 30 wt. %, from about 20 to about 50 wt. %, from about 20 to about 40 wt. %, from about 20 to about 35 wt. %, from about 20 to about 30 wt. %, from about 25 to about 50 wt. %, from about 25 to about 40 wt. %, from about 25 to about 35 wt. %, from about 25 to about 30 wt. %, from about 20 to about 25 wt. %, or any ranges created thereby, of fatty acid, by weight of the dryer sheet.

Where the fabric softening active comprises a quaternary ammonium compound and a fatty acid, a ratio of quaternary ammonium compound to fatty acid can be from about from about 10:1 to about 1:5, or from about 5:1 to about 1:3, or from 0.5:1.0 to about 5:1, preferably 1:1 to about 3:1. Additionally, the fatty acid, in such configurations, may have an iodine value of from about 0 to about 45, more preferably 0 to about 35, more preferably 0 to about 25.

The fabric softening active may comprise ingredients such as a nonionic material. Suitable nonionic materials may include polyoxyalkylene glycols, higher fatty alcohol esters of polyoxyalkylene glycols, higher fatty alcohol esters of polyoxyalkylene glycols, ethoxylates of long chained alcohols of from 8 to 30 carbon atoms such as the ethoxylates of coconut, palm, tallow alcohols or hydrogenated alcohols with 4 to 40 moles of ethylene oxide, and alkanolamides.

The fabric softening active can comprise one or more organic compounds having at least one relatively long hydrocarbon group serving to provide lubricity and or antistatic effects. Among such groups are alkyl groups containing 8 or more carbon atoms or even 12 to 22 carbon atoms. Suitable fabric care compositions can comprise cationic, anionic, nonionic, or zwitterionic compounds. Cationic nitrogen containing compounds such as quaternary ammonium compounds having one or two straight chain organic groups of at least eight carbon atoms are practical.

The fabric softening active can be selected from the group consisting of polyglyceryl distearate, parrafin wax, branched paraffin wax, polyglyceryl esters, and combinations thereof.

Suitable fabric softening actives include cationic, anionic, nonionic, or zwitterionic compounds. The fabric softening active can be a quaternary imidazolinium salt. Optionally, the fabric softening active can be a polyoxyalkylene glycol, including higher fatty alcohol esters of polyoxyalkylene glycol and higher fatty alcohol ethers of polyoxyalkylene glycol. The fabric softening active can be a fatty acid ester of sorbitan and ethoxylates of such esters.

The fabric softening active can be a branched polyester having a formula of:

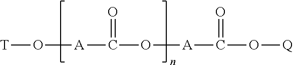

wherein: each A is independently a branched hydrocarbon chain comprising 4 to 100 carbon atoms; Q is selected from an alkyl chain comprising 1 to 30 carbon atoms and a hydrogen atom; T is a hydrogen atom or a —C(O)—R wherein each R is an alkyl chain comprising 1 to 30 carbon atoms and n is an integer from 1 to about 100.

Optionally, each A can be independently a branched hydrocarbon chain comprising from 4 to 40 carbon atoms; Q can be selected from an alkyl chain comprising 1 to 30 carbon atoms and a hydrogen atom; T can be a hydrogen atom or a —C(O)—R wherein each R can be an alkyl chain comprising from 7 to 21 carbon atoms; and n can be an integer from 4 to 40.

Optionally, the branched polyester polymer can have a weight average molecular weight of from about 500 g/mol to about 100,000 g/mol.

Optionally, each A of the polyester polymers can be independently a branched hydrocarbon having the structure:

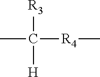

wherein each R₃ can be a monovalent alkyl or substituted alkyl group and R₄ can be an unsaturated or saturated divalent alkylene radical comprising from 1 to about 24 carbon atoms.

### Silicic Acid Perfume Esters

The fabric care composition of the present disclosure may include a silicic acid perfume ester. The silicic acid perfume ester may include a silicon moiety and a fragrance moiety. The fragrance moiety may include an alcohol-based perfume. The fabric care composition may include from 0.2 to 15 wt. %, from 0.2 to 12 wt. %, from 0.2 to 10 wt. %, from 0.2 to 8 wt. %, from 0.2 to 6 wt. %, from 0.2 to 5 wt. %, from 0.2 to 4 wt. %, from 0.2 to 3 wt. %, from 0.2 to 2.5 wt. %, from 0.2 to 2 wt. %, from 0.2 to 1.5 wt. %, from 0.2 to 1 wt. %, from 0.2 to 0.5 wt. %, from 0.5 to 15 wt. %, from 0.5 to 12 wt. %, from 0.5 to 10 wt. %, from 0.5 to 8 wt. %, from 0.5 to 6 wt. %, from 0.5 to 5 wt. %, from 0.5 to 4 wt. %, from 0.5 to 3 wt. %, from 0.5 to 2.5 wt. %, from 0.5 to 2 wt. %, from 0.5 to 1.5 wt. %, from 0.5 to 1 wt. %, from 1 to 15 wt. %, from 1 to 12 wt. %, from 1 to 10 wt. %, from 1 to 8 wt. %, from 1 to 6 wt. %, from 1 to 5 wt. %, from 1 to 4 wt. %, from 1 to 3 wt. %, from 1 to 2.5 wt. %, from 1 to 2 wt. %, from 1 to 1.5 wt. %, from 1.5 to 15 wt. %, from 1.5 to 12 wt. %, from 1.5 to 10 wt. %, from 1.5 to 8 wt. %, from 1.5 to 6 wt. %, from 1.5 to 5 wt. %, from 1.5 to 4 wt. %, from 1.5 to 3 wt. %, from 1.5 to 2.5 wt. %, from 1.5 to 2 wt. %, from 2 to 15 wt. %, from 2 to 12 wt. %, from 2 to 10 wt. %, from 2 to 8 wt. %, from 2 to 6 wt. %, from 2 to 5 wt. %, from 2 to 4 wt. %, from 2 to 3 wt. %, from 2 to 2.5 wt. %, from 2.5 to 15 wt. %, from 2.5 to 12 wt. %, from 2.5 to 10 wt. %, from 2.5 to 8 wt. %, from 2.5 to 6 wt. %, from 2.5 to 5 wt. %, from 2.5 to 4 wt. %, from 2.5 to 3 wt. %, from 3 to 15 wt. %, from 3 to 12 wt. %, from 3 to 10 wt. %, from 3 to 8 wt. %, from 3 to 6 wt. %, from 3 to 5 wt. %, from 3 to 4 wt. %, from 4 to 15 wt. %, from 4 to 12 wt. %, from 4 to 10 wt. %, from 4 to 8 wt. %, from 4 to 6 wt. %, from 4 to 5 wt. %, from 5 to 15 wt. %, from 5 to 12 wt. %, from 5 to 10 wt. %, from 5 to 8 wt. %, from 5 to 6 wt. %, from 6 to 15 wt. %, from 6 to 12 wt. %, from 6 to 10 wt. %, from 6 to 8 wt. %, from 8 to 15 wt. %, from 8 to 12 wt. %, from 8 to 10 wt. %, from 10 to 15 wt. %, from 10 to 12 wt. %, from 12 to 15 wt. %, preferably 0.3% to about 4%, preferably from about 0.4% to about 2.5%, or any ranges created thereby, by weight of the fabric care composition of a silicic acid perfume ester. In examples, the dryer sheet may include from about 0.1 to about 8 wt. %, from about 0.1 to about 6 wt. %, from about 0.1 to about 5 wt. %, from about 0.1 to about 4 wt. %, from about 0.1 to about 3 wt. %, from about 0.1 to about 2.5 wt. %, from about 0.1 to about 2 wt. %, from about 0.1 to about 1.5 wt. %, from about 0.1 to about 1.2 wt. %, from about 0.1 to about 1 wt. %, from about 0.1 to about 0.8 wt. %, about 0.2 to about 8 wt. %, from about 0.2 to about 6 wt. %, from about 0.2 to about 5 wt. %, from about 0.2 to about 4 wt. %, from about 0.2 to about 3 wt. %, from about 0.2 to about 2.5 wt. %, from about 0.2 to about 2 wt. %, from about 0.2 to about 1.5 wt. %, from about 0.2 to about 1.2 wt. %, from about 0.2 to about 1 wt. %, from about 0.2 to about 0.8 wt. %, from about 0.3 to about 8 wt. %, from about 0.3 to about 6 wt. %, from about 0.3 to about 5 wt. %, from about 0.3 to about 4 wt. %, from about 0.3 to about 3 wt. %, from about 0.3 to about 2.5 wt. %, from about 0.3 to about 2 wt. %, from about 0.3 to about 1.5 wt. %, from about 0.3 to about 1.2 wt. %, from about 0.3 to about 1 wt. %, from about 0.3 to about 0.8 wt. %, from about 0.5 to about 8 wt. %, from about 0.5 to about 6 wt. %, from about 0.5 to about 5 wt. %, from about 0.5 to about 4 wt. %, from about 0.5 to about 3 wt. %, from about 0.5 to about 2.5 wt. %, from about 0.5 to about 2 wt. %, from about 0.5 to about 1.5 wt. %, from about 0.5 to about 1.2 wt. %, from about 0.5 to about 1 wt. %, from about 0.5 to about 0.8 wt. %, from about 0.7 to about 8 wt. %, from about 0.7 to about 6 wt. %, from about 0.7 to about 5 wt. %, from about 0.7 to about 4 wt. %, from about 0.7 to about 3 wt. %, from about 0.7 to about 2.5 wt. %, from about 0.7 to about 2 wt. %, from about 0.7 to about 1.5 wt. %, from about 0.7 to about 1.2 wt. %, from about 0.7 to about 1 wt. %, from about 0.7 to about 0.8 wt. %, from about 0.8 to about 8 wt. %, from about 0.8 to about 6 wt. %, from about 0.8 to about 5 wt. %, from about 0.8 to about 4 wt. %, from about 0.8 to about 3 wt. %, from about 0.8 to about 2.5 wt. %, from about 0.8 to about 2 wt. %, from about 0.8 to about 1.5 wt. %, from about 0.8 to about 1.2 wt. %, from about 0.8 to about 1 wt. %, from about 1 to about 8 wt. %, from about 1 to about 6 wt. %, from about 1 to about 5 wt. %, from about 1 to about 4 wt. %, from about 1 to about 3 wt. %, from about 1 to about 2.5 wt. %, from about 1 to about 2 wt. %, from about 1 to about 1.5 wt. %, from about 1 to about 1.2 wt. %, or any ranges created thereby, of silicic acid perfume ester, by weight of the dryer sheet.

As stated previously, the silicic acid perfume ester may include a fragrance moiety, which may include an alcohol-based perfume, which can include one or more hydroxyl-containing perfume raw materials (PRMs). Such compositions are useful in laundry treatment compositions for the delivery of PRMs to treat fabrics in a laundry process. Perfume delivery is important in laundry applications since perfume on fabric conveys cleanliness or freshness to laundered clothes, however most perfume is lost in the process of washing, rinsing, and drying.

The silicic acid perfume ester of the present disclosure may be classified as an improved pro-perfume. Conventional pro-perfumes are known perfume delivery vehicles that covalently bind a perfume moiety to the pro-perfume scaffold for controlled release of an odiferous molecule via moisture, oxygen, light, heat, or enzymatic triggers and are substantially more retained on treated fabrics than the unmodified odiferous molecule during a laundry process. However, conventional pro-perfumes can only deliver one equivalent of the odiferous molecule per pro-perfume molecule, therefore there remains a need for even better pro-perfumes to more efficiently and economically deliver perfume in laundry treatment to be more noticeable to the consumer with less perfume being lost during the wash process or during tumble drying.

The covalent attachment of hydroxyl-group-containing PRMs to a silicic acid ester backbone to form silicic acid perfume esters addresses the challenge of delivering perfume efficiently. These pro-perfumes enhance the freshness of laundered fabrics through improved perfume deposition, release, storage stability, and formulation efficiency through multiple equivalents of perfume loaded onto the backbone. Without wishing to be bound by theory, the release of bound PRMs from silicic acid perfume esters occurs through hydrolysis, a process that can be afforded by sources of water such as ambient moisture or perspiration. Hydrolytically-triggered pro-perfumes are known, however silicic acid perfume esters are advantageous as they provide flexibility in molecular weight, branching, and substitution, further optimizing fragrance delivery and stability in formulated products. Other names for silicic acid esters are silicates, polysilicates, polysilicic acid esters, polyorthosilicic acid esters, polyorthosilicates, and in some cases silyl ethers.

The silicic acid perfume esters of the present disclosure comprise silicic acid ester polymers whose backbones consist of a chain of silicon atoms bound through oxygen atom bridges (i.e., Si—O—Si units) and covalently bound perfume moieties derived from hydroxyl-group-containing PRMs (i.e., R—OH). The silicic acid ester backbone provides the scaffolding to which the perfume moieties are attached (i.e., Si—OR). The silicic acid polymer backbone may be linear or branched with Si—O units defined by the number of bonds to adjacent Si—O units in the polymer backbone. Q-unit nomenclature is used to describe this connectivity, where:
a) Q₀ is a monomeric unit comprising silicon atom with up to four bound perfume moieties: Si(OR)₄,
b) Q₁ is a terminal end-group unit comprising up to three bound perfume moieties and one oxygen bound to the backbone: SiO_{1/2}(OR)₃,
c) Q₂ is a linear unit comprising up to two bound perfume moieties and two oxygens bound to the backbone: SiO_{2/2}(OR)₂,
d) Q₃ is a single branch unit comprising up to one perfume moiety and three oxygens bound to the backbone: SiO_{3/2}(OR),
e) Q₄ is a double branch unit comprising four oxygens bound to the backbone: SiO_{4/2}.

Silicic acid perfume esters may comprise silicic acid esters whose distribution of Q-units independently may be fully or partly substituted with bound perfume moieties, may contain C₁-C₆ alkoxy moieties retained from a precursor silicic acid ester, and may contain silanol groups obtained from hydrolysis, (i.e., Si—OH), and combinations thereof.

The silicic acid perfume esters according to the present disclosure may include a silicic acid perfume ester according to Formula 1:

[R₁R₂R₃SiO_{1/2}]_{(q+2r+2)}[R₄R₅SiO_{2/2}]ₚ[R₆SiO_{3/2}]][SiO_{4/2}]ᵣ Formula I

wherein:
i) p is an integer from 0 to 200, or from 0 to 100, preferably from 0 to 50, preferably from 0 to 20, even more preferably from 1 to 10 and most preferably from 1 to 5;
ii) q is an integer from 0 to 150, more preferably 0 to 75, more preferably 0 to 50, more preferably 0 to 25, more preferably 0 to 15, more preferably 0 to 5;
iii) r is an integer from 0 to 20, preferably 0 to 10, preferably 0 to 2;
   with the proviso p+q+r equals an integer greater than or equal to 1;
iv) each R₁, R₂, R₃, R₄, R₅ and R₆ moiety is independently selected from the group consisting of OH, C₁-C₃₂ alkoxy, C₁-C₃₂ substituted alkoxy, C₆-C₃₂ aryloxy, C₆-C₃₂ substituted aryloxy; and wherein each substituted alkoxy or substituted aryloxy moiety may comprise a linear or cyclic aliphatic chain that may comprise branching or pendant rings wherein branching may be aliphatic or aromatic, and wherein substituted alkoxy and substituted aryloxy moieties may comprise oxygen, nitrogen or sulfur heteroatoms and wherein substituted alkoxy or substituted aryloxy moieties may contain unsaturated aliphatic carbons.

Silicic acid perfume esters can be obtained through the transesterification reaction of hydroxyl-group-containing PRMs with a precursor starting material comprising a silicic acid ester of a C₁-C₆ alcohol, e.g., the silicic acid ester comprising alkoxy moieties derived from methanol, ethanol, isopropanol, 1-propanol, 1-butanol, 2-butanol, tert-butanol, pentanol, or hexanol. This method is preferable for PRMs wherein the hydroxyl-group is a 1° or 2° alcohol, or in some cases, electron-rich phenols. Commercially available silicic acid esters can be used as precursors, such as the silicic acid esters of ethanol available under the tradenames Dynasylan® SilBond 40 (ex Evonik®) and Silicate TES 40 WN (ex Wacker®). During the reaction to make the silicic acid perfume esters, the alkoxy moieties are cleaved and the silicic acid esters of the hydroxyl-group-containing PRM are formed. The use of catalysts is preferred, and typical catalysts that can be used are Lewis acids, such as titanium tetraisopropylate, basic catalysts, such as sodium methoxide, sodium ethoxide or amines, or hindered amines such as 1,8-Diazabicyclo[5.4.0]undec-7-ene (DBU). The transesterification process can be regulated by temperature and removal of volatile byproducts, such as ethanol, through distillation. The conversion of the silicic acid ester can also be influenced by perfume concentration, catalyst loading, pressure, duration, and mixing. Synthesis of silicic acid esters can be performed neat (i.e., in the absence of additional non-reactive solvent) or with a solvent. Removal or purification of residual catalyst and unreacted hydroxyl-group containing perfume may be desired to eliminate side reactions and aesthetic negatives in subsequent formulations.

The selection of the silicic acid ester starting material, the hydroxyl-group-containing PRM(s), and reaction conditions can be used to achieve silicic acid perfume ester composition stability, viscosity, and perfume residue hydrolysis kinetics. Preferably, the silicic acid ester precursor is a silicic acid ester of ethanol, i.e., comprises ethoxy moieties.

The weight average molecular weight (Mw) of the silicic acid ester starting material and the silicic acid perfume ester can be determined using Gel Permeation Chromatography (GPC) in organic solvents such as THF with refractive index detection relative to polystyrene standards. The Mw of the silicic acid ester precursor is preferably from about 250 Da to 10,000 Da, more preferably from about 400 Da to 8000 Da, and most preferably from about 500 Da and 2,000 Da. Without wishing to be bound by theory, substitution of the C₁-C₆ alkoxy group in the silicic acid starting material with hydroxy-group containing PRM will increase the molecular weight by the mass of the PRM and the amount of loading where high PRM loading of >50%, or even 60%, or even 70%, or even 90% is desired for efficiency. The Mw of the resulting silicic acid perfume ester is from about 500 Da to about 100,000 Da, preferably from about 750 Da to about 50,000 Da, more preferably from about 1000 Da to about 20,000 Da and most preferably from about 1,000 Da to about 5,000 Da.

The silicic acid perfume ester R₁, R₂, R₃, R₄, R₅ and R₆ moieties may be selected from the same hydroxy-group containing PRM, or may be a mixture of 1 or more different PRMs and is independently selected from the group consisting of OH, C₁-C₃₂ alkoxy, C₁-C₃₂ substituted alkoxy, C₆-C₃₂ aryloxy, C₆-C₃₂ substituted aryloxy; wherein each substituted alkoxy or substituted aryloxy group moiety may comprise a linear or cyclic aliphatic chain that may comprise branching or pendant rings wherein branching may be aliphatic or aromatic, and wherein substituted alkoxy and substituted aryloxy moiety may comprise oxygen, nitrogen or sulfur heteroatoms and wherein substituted alkoxy or substituted aryloxy group moiety may contain unsaturated aliphatic carbons.

Full perfume compositions generally comprise multiple PRMs, thus it may be desirable for a silicic acid ester starting material to be reacted with individual hydroxyl-group-containing PRMs or mixtures of hydroxyl-group containing PRMs to deliver the desired olfactive experience. The incorporation of two or more different perfume moieties can be achieved through inclusion of multiple hydroxyl-group-containing PRMs during synthesis or through cross-linking different silicic acid perfume esters in a secondary reaction. Yet another way to achieve the desired olfactive character is to combine multiple silicic acid perfume esters of individual PRMs and incorporate separately into a consumer product or as a physical mixture of two or more silicic acid esters to allow flexibility in formulation.

Silicic acid perfume esters may comprise silicic acid perfume esters with varied loading of perfume moieties on the silicic acid ester backbone. Complete conversion of all C₁-C₆ alkoxy moieties of the silicic acid ester precursor to hydroxyl-group-containing PRMs is desirable for efficiency but may be synthetically challenging to drive the reaction to completion due to steric hindrance, for example. Therefore, the preferred silicic acid esters for the present disclosure are those that have been almost completely transesterified, i.e., silicic acid esters comprising a significant amount of perfume moieties with minimal unreacted alkoxy moieties. Higher ratios are preferred so that a single silicic acid perfume ester polymer has a higher loading capacity of PRMs to deliver better freshness benefits more efficiently. However, ratios that are too high may result in challenging physical properties or slow perfume release kinetics. The ratio of bound perfume moieties to unreacted bound C₁-C₆ alkoxy moieties are from about 1:1 to 10:1, or from about 3:1 to 10:1, from about 4:1 to about 10:1, or from about 5:1 to 10:1.

Silicic acid perfume esters may include unreacted PRMs. The unreacted PRMs can contribute to the scent of laundry treatment compositions comprising silicic acid perfume esters and may impart that scent treated fabrics, as the polymer itself has little to no scent. Silicic acid perfume esters preferably comprise no more than 40 wt. % unreacted PRMs, more preferably no more than 20 wt. %, and more preferably no more than 10 wt. %, most preferably no more than 5 wt. %.

Silicic acid perfume esters may comprise monomeric silicic acid esters, i.e., silicic acid esters containing one silicon atom (i.e., Q₀ silicic acid esters). These monomeric silicic acid esters are present in commercially available silicic acid ester precursors or can form during synthesis of silicic acid perfume esters. Without wishing to be bound by theory, the monomeric silicic acid esters Q₀ species are not as desirable as the polymeric species because they deliver less perfume than the polymers. Silicic acid perfume esters preferably comprise less than 30 wt. % of non-polymeric silicic acid esters, more preferably less than 25 wt. %, more preferably less than 20 wt. %, and most preferably less than 15 wt. %.

“Hydroxyl-group-containing PRM” refers to a PRM that has a free hydroxyl group that may be suitable for silicic acid perfume ester formation. These materials can be classified based on the substitution of the α-carbon of the hydroxyl group into 1°, 2°, electron-rich phenolic, or vinylic classifications. An additional classification can be made based on whether the β-carbon is unsaturated or aromatic; these materials are referred to as allylic or benzylic, respectively. Hydroxyl-group-containing PRMs suitable for use in silicic acid perfume esters in the context to the current disclosure are 1°, 1° allylic, 1° benzylic, 2°, 2° allylic, and 2° benzylic. Preferable hydroxyl-group-containing PRMs are 1°, 1° allylic, 2°, and 2° allylic.

PRMs that comprise a hydroxyl group moiety are in Table A. It is believed that the materials provided in Table A are illustrative and non-limiting examples of PRMs that are suitable for use according to the present disclosure. Some PRMs may have multiple hydroxyl groups; without wishing to be bound by theory, the hydroxyl group that defines the reactivity of the material is shown in the classification.

TABLE A
Examples of Hydroxy-group-containing perfume raw materials.

| | | | Hydroxy- |
|---|---|---|---|
| | | | Group |
| Number | Trade Name | IUPAC Name | Classification |
| 1 | Benzyl alcohol | phenylmethanol | 1° Benzylic |
| 2 | 2 6-nonadien-1-ol | (2E,6Z)-nona-2,6-dien-1-ol | 1° Allylic |
| 3 | Cinnamic alcohol | (E)-3-phenylprop-2-en-1-ol | 1° Allylic |
| 4 | α-santalol | (Z)-5-[(1S,3R,6R)-2,3-dimethyl-3- | 1° Allylic |
| | | tricyclo[2.2.1.02,6]heptanyl]-2-methylpent-2-en-1- | |
| | | ol | |
| 5 | Farnesol | (2E,6E)-3,7,11-trimethyldodeca-2,6,10-trien-1-ol | 1° Allylic |
| 6 | Geraniol | (2E)-3,7-dimethylocta-2,6-dien-1-ol | 1° Allylic |
| 7 | Hindinol | 2-methyl-4-(2,2,3-trimethylcyclopent-3-en-1-yl) | 1° Allylic |
| | | but-2-en-1-ol | |
| 8 | Josenol | (E)-2-methyl-3-(4-methylphenyl)prop-2-en-1-ol | 1° Allylic |
| 9 | Laevo trisandol | (E)-2-ethyl-4-(2,2,3-trimethylcyclopent-3-en-1- | 1° Allylic |
| | | yl)but-2-en-1-ol | |
| 10 | Mushroom alcohol | 1-octen-3-ol | 2° Allylic |
| 11 | Nerol | (2Z)-3,7-dimethylocta-2,6-dien-1-ol | 1° Allylic |
| 12 | Phytol | (2E,7R,11R)-3,7,11,15-tetramethylhexadec-2-en-1- | 1° Allylic |
| | | ol | |
| 13 | cis-6-Nonenol | (Z)-non-6-en-1-ol | 1° |
| 14 | 3,6-nonadien-1-ol | nona-3,6-dien-1-ol | 1° |
| 15 | (−)-beta-citronellol | (3S)-3,7-dimethyloct-6-en-1-ol | 1° |
| 16 | Beta gamma | (Z)-hex-3-en-1-ol | 1° |
| | hexenol | | |
| 17 | Bornafix | 2-methyl-3-[(1,7,7-trimethyl-2- | 1° |
| | | bicyclo[2.2.1]heptanyl)oxy]propan-1-ol | |
| 18 | Cis-6-nonen-1-ol | (Z)-non-6-en-1-ol | 1° |
| 19 | Citronellol | 3,7-dimethyloct-6-en-1-ol | 1° |
| 20 | Cyclomethylene | 3-(4-methylcyclohex-3-en-1-yl)butan-1-ol | 1° |
| | citronellol | | |
| 21 | Dimethyl octanol | 3,7-dimethyloctan-1-ol | 1° |
| 22 | Hydratropic | 2-phenylpropan-1-ol | 1° |
| | alcohol | | |
| 23 | Hydroxyambran | 2-cyclododecylpropan-1-ol | 1° |
| 24 | Hydroxyol | 3,7-dimethyloctane-1,7-diol | 1° |
| 25 | Isocyclogeraniol | 2,4,6-trimethylcyclohex-3-en-1-yl)methanol | 1° |
| 26 | Javanol | [1-methyl-2-[(1,2,2-trimethyl-3- | 1° |
| | | bicyclo[3.1.0]hexanyl)methyl]cyclopropyl]methanol | |
| 27 | laevo citronellol | (3S)-3,7-Dimethyl-6-octen-1-ol | 1° |
| 28 | Lavandulol | (2R)-5-methyl-2-prop-1-en-2-ylhex-4-en-1-ol | 1° |
| 29 | Lilyflore | (2,5-dimethyl-1,3-dihydroinden-2-yl)methanol | 1° |
| 30 | Majantol | 2,2-dimethyl-3-(3-methylphenyl)propan-1-ol | 1° |
| 31 | Mayol | (4-propan-2-ylcyclohexyl)methanol | 1° |
| 32 | Rhodinol | (3S)-3,7-dimethyloct-7-en-1-ol | 1° |
| 33 | Octyl alcohol | octan-1-ol | 1° |
| 34 | Phenoxyethanol | 2-Phenoxyethanol | 1° |
| 35 | Phenyl ethyl | 2-phenylethanol | 1° |
| | alcohol | | |
| 36 | Phenyl hexanol | 3-methyl-5-phenylpentan-1-ol | 1° |
| 37 | Phenyl propyl | 3-phenylpropan-1-ol | 1° |
| | alcohol | | |
| 38 | Pomelol | 2,4,7-trimethyloct-6-en-1-ol | 1° |
| 39 | Rosalva | dec-9-en-1-ol | 1° |
| 40 | Rosaphen | 2-methyl-5-phenylpentan-1-ol | 1° |
| 41 | Rosyfolia | [1-methyl-2-(5-methylhex-4-en-2- | 1° |
| | | yl)cyclopropyl]methanol | |
| 42 | Sulfurol | 2-(4-methyl-1,3-thiazol-5-yl)ethanol | 1° |
| 43 | Diacetin | 3-Hydroxy-1,2-propanediyl diacetate | 1° |
| 44 | Amyl vinyl | Oct-1-en-3-ol | 2° Allylic |
| | carbinol | | |
| 45 | Osmantol | (E)-3,5-dimethyloct-5-en-4-ol | 2° Allylic |
| 46 | Undecavertol | (E)-4-methyldec-3-en-5-ol | 2° Allylic |
| 47 | Acetyl methyl | 3-Hydroxy-2-butanone | 2° |
| | carbinol | | |
| 48 | Borneol | (1S,2R,4S)-1,7,7-trimethylbicyclo[2.2.1]heptan-2-ol | 2° |
| 49 | Butyl lactate | butyl 2-hydroxypropanoate | 2° |
| 50 | Coramber | 1-(2-tert-butylcyclohexyl)oxybutan-2-ol | 2° |
| 51 | Cyclopentol | 2-Pentylcyclopentan-1-ol | 2° |
| 52 | Diasmol | 3-hydroxynonyl acetate | 2° |
| 53 | Ebanol | 3-Methyl-5-(2,2,3-trimethylcyclopent-3-enyl)pent- | 2° |
| | | 4-en-2-ol | |
| 54 | Ethyl lactate | ethyl 2-hydroxypropanoate | 2° |
| 55 | Fenchyl alcohol | 1,3,3-trimethylbicyclo[2.2.1]heptan-2-ol | 2° |
| 56 | Geranodyle | 2-(2-hydroxypropan-2-yl)-5-methylcyclohexan-1-ol | 2° |
| 57 | Hyacinth acetals | (2-benzyl-1,3-dioxolan-4-yl)methanol | 2° |
| 58 | Isobornyl | 4-(1,7,7-trimethyl-2- | 2° |
| | cyclohexanol | bicyclo[2.2.1]heptanyl)cyclohexan-1-ol | |
| 59 | Isopulegol | (1R,2S,5R)-5-methyl-2-prop-1-en-2-ylcyclohexan- | 2° |
| | | 1-ol | |
| 60 | Laevo menthol | (1R,2S,5R)-5-methyl-2-propan-2-ylcyclohexan-1-ol | 2° |
| 61 | Menthol | 5-methyl-2-propan-2-ylcyclohexan-1-ol | 2° |
| 62 | Mugetanol | 1-(4-propan-2-ylcyclohexyl)ethanol | 2° |
| 63 | Muguesia | 3-methyl-4-phenylbutan-2-ol | 2° |
| 64 | Octalynol | 2,2,6,8-tetramethyl-3,4,4a,5,8,8a-hexahydro-1H- | 2° |
| | | naphthalen-1-ol | |
| 65 | Osyrol | 7-methoxy-3,7-dimethyloctan-2-ol | 2° |
| 66 | Patchon | 4-tert-butylcyclohexan-1-ol | 2° |
| 67 | Polysantol | (E)-3,3-dimethyl-5-(2,2,3-trimethylcyclopent-3-en- | 2° |
| | | 1-yl)pent-4-en-2-ol | |
| 68 | Sandalore | 3-methyl-5-(2,2,3-trimethylcyclopent-3-en-1- | 2° |
| | | yl)pentan-2-ol | |
| 69 | Sandela | 3-(5,5,6-trimethyl-2- | 2° |
| | | bicyclo[2.2.1]heptanyl)cyclohexan-1-ol | |
| 70 | Timberol | 1-(2,2,6-trimethylcyclohexyl)hexan-3-ol | 2° |
| 71 | Verdol | 2-tert-butylcyclohexan-1-ol | 2° |
| 72 | Yodanol | 4-methyl-6-phenylhexan-2-ol | 2° |

The silicic acid perfume ester according to the present disclosure comprises the formula:

[R₁R₂R₃SiO_{1/2}]_{(q+2r+2)}[R₄R₅SiO_{2/2}]ₚ[R₆SiO_{3/2}]_{q}[SiO_{4/2}]ᵣ Formula I
wherein:
i) q is an integer from 0 to 150, more preferably 0 to 75, more preferably 0 to 15, more preferably 0 to 2, or 1 to 150, or 1 to 75, or 1 to 15, or 1 to 2, or any range created thereby;
ii) r is an integer from 0 to 20, preferably 0 to 10, or 1 to 20, or 1 to 10, or any range created thereby;
iii) p is an integer from 0 to 200, or from 0 to 100, preferably from 0 to 50, preferably from 0 to 20, even more preferably from 1 to 10 and most preferably from 1 to 5, or 1 to 200, or 1 to 100, or 1 to 50, or 1 to 20, or any range created thereby;
with the provisio p+q+r equals an integer greater than or equal to 1;
iv) each of R₁, R₂, R₃, R₄, R₅ and R₆ moiety is independently selected from the group consisting of OH, C₁-C₃₂ alkoxy, C₁-C₃₂ substituted alkoxy, C₆-C₃₂ aryloxy, C₆-C₃₂ substituted aryloxy; and wherein each substituted alkoxy or substituted aryloxy group moiety may comprise a linear or cyclic aliphatic chain that may comprise branching or pendant rings wherein branching may be aliphatic or aromatic, and wherein substituted alkoxy and substituted aryloxy moiety may comprise oxygen, nitrogen or sulfur heteroatoms and wherein substituted alkoxy or substituted aryloxy group moiety may contain unsaturated aliphatic carbons.

In examples, the alcohol-based perfume may include geraniol, citronellol, beta-gamma-hexanol, 9-decen-1-ol, phenyl ethyl alcohol, cinnamic alcohol, undecavertol, cis-6-nonenol, hindinol, 1-octen-3-ol, 2,6-nonadien-1-ol, acetyl methyl carbinol, rosyfolia, (Z)-3-methyl-5-(2,2,3-trimethyl-1-cyclopent-3-enyl) pent-4-en-2-ol, coramber, laevo citronellol, borneol, laevo menthol, laevo trisandol, 2-methyl-3-[(1,7,7-trimethylbicyclo[2.2.1]hept-2-yl)oxy]propan-1-ol, (E)-3,3-dimethyl-5-(2,2,3-trimethyl-3-cyclopenten-1-yl)-4-penten-2-ol, nerol (also known as (2Z)-3,7-dimethylocta-2,6-dien-1-ol), octalynol, (1S,4R,6R)-1,7,7-trimethylbicyclo[2.2.1]heptan-6-ol, [2.2.1]heptan-6-ol, phenyl propyl alcohol, (Z)-non-6-en-1-ol, javanol, 2-tert-butylcyclohexan-1-ol, (Z)-3-methyl-5-(2,2,3-trimethyl-1-cyclopent-3-enyl) pent-4-en-2-ol, 1,3,3-trimethylbicyclo[2.2.1]heptan-2-ol, maltol, josenol, 2-pentylcyclopentan-1-ol, Dimethyloctanol, Benzyl alcohol, (3S)-3,7-dimethyloct-6-en-1-ol, aurantiol, bornafix, octan-1-ol, 5-(3-methylphenyl) pentan-1-ol, octalynol, 3-methoxyl-3-methyl-1-butanol, (E)-3,3-dimethyl-5-(2,2,3-trimethyl-3-cyclopenten-1-yl)-4-penten-2-ol, Hydroxycitronellol, Ethyl maltol, 2-(4-methyl-1,3-thiazol-5-yl) ethanol, Sulfurol, thymol, 2,6-nonadien-1-ol, 2-cyclododecylpropan-1-ol, farnesol, and combinations thereof.

### Perfume Delivery System

In examples, the fabric care composition may optionally further include a perfume delivery system in addition to the silicic acid perfume ester. The perfume delivery system may include at least one of a polymer assisted delivery polymer; a molecule assisted delivery molecule; an amine-assisted delivery polymer or molecule; a non-silicon pro-perfume; a plurality of delivery particles; or combinations thereof. Each of the plurality of particles may include a core surrounded by a polymer wall or a shell. The core may include a benefit agent.

Polymer Assisted Delivery (PAD). This perfume delivery technology uses polymeric materials to deliver perfumes. Classical coacervation, water soluble or partly soluble to insoluble charged or neutral polymers, liquid crystals, hot melts, hydrogels, perfumed plastics, microcapsules, nano- and micro-latexes, polymeric film formers, and polymeric absorbents, polymeric adsorbents, etc. are some examples. PAD includes but is not limited to:

Matrix Systems: The fragrance is dissolved or dispersed in a polymer matrix or particle. Absorption and/or adsorption into or onto polymeric particles, films, solutions, and the like are aspects of this technology. Nano- or micro-particles composed of organic materials (e.g., latexes) are examples. Suitable particles include a wide range of materials including, but not limited to polyacetal, polyacrylate, polyacrylic, polyacrylonitrile, polyamide, polyaryletherketone, polybutadiene, polybutylene, polybutylene terephthalate, polychloroprene, poly ethylene, polyethylene terephthalate, polycyclohexylene dimethylene terephthalate, polycarbonate, polychloroprene, polyhydroxyalkanoate, polyketone, polyester, polyethylene, polyetherimide, polyethersulfone, polyethylenechlorinates, polyimide, polyisoprene, polylactic acid, polymethylpentene, polyphenylene oxide, polyphenylene sulfide, polyphthalamide, polypropylene, polystyrene, polysulfone, polyvinyl acetate, polyvinyl chloride, aminoplast, as well as polymers or copolymers based on acrylonitrile-butadiene, cellulose acetate, ethylene-vinyl acetate, ethylene vinyl alcohol, styrene-butadiene, vinyl acetate-ethylene, and mixtures thereof.

Molecule-Assisted Delivery (MAD). Molecule-assisted delivery uses non-polymeric materials or molecules to improve the delivery of perfume. Without wishing to be bound by theory, perfume may non-covalently interact with organic materials, resulting in altered deposition and/or release. Non-limiting examples of such organic materials include but are not limited to hydrophobic materials such as organic oils, waxes, mineral oils, petrolatum, fatty acids or esters, sugars, surfactants, liposomes and even other perfume raw material (perfume oils), as well as natural oils, including body and/or other soils. Perfume fixatives are yet another example. In one aspect, non-polymeric materials or molecules have a CLogP greater than about 2

Amine-Assisted Delivery (AAD). The amine-assisted delivery technology approach utilizes materials that contain an amine group to increase perfume deposition or modify perfume release during product use. There is no requirement in this approach to pre-complex or pre-react the perfume raw material(s) and amine prior to addition to the product. In one aspect, amine-containing AAD materials suitable for use herein may be non-aromatic; for example, polyalkylimine, such as polyethyleneimine (PEI), or polyvinylamine (PVAm), or aromatic, for example, anthranilates. Such materials may also be polymeric or non-polymeric. In one aspect, such materials contain at least one primary amine. This technology will allow increased longevity and controlled release also of low ODT perfume notes (e.g., aldehydes, ketones, enones) via amine functionality, and delivery of other PRMs, without being bound by theory, via polymer-assisted delivery for polymeric amines.

Non-Silicon Pro-Perfume (PP): The perfume delivery system may comprise a non-silicon pro-perfume. A non-silicon pro-perfume is the result from the reaction of perfume moiety with other scaffolds, substrates or chemicals to form materials that have a covalent bond between the PRM and the carrier. The PRM is converted into a new material called a pro-PRM (i.e., pro-perfume), which then may release the original PRM upon exposure to moisture (water), oxygen, light, heat, or enzymatic triggers. Pro-perfumes may provide enhanced perfume delivery properties such as increased perfume deposition, longevity, stability, retention, and the like. Pro-perfumes include those that are monomeric (non-polymeric) or polymeric and may be pre-formed or may be formed in-situ under equilibrium conditions, such as those that may be present during in-product storage or on the wet or dry situs. Nonlimiting examples of pro-perfumes include Michael adducts (e.g., beta-amino ketones), aromatic or non-aromatic imines (Schiff bases), oxazolidines, beta-keto esters, and orthoesters. Another aspect includes compounds comprising one or more beta-oxy or beta-thio carbonyl moieties capable of releasing a PRM, for example, an alpha, beta-unsaturated ketone, aldehyde or carboxylic ester. Suitable examples of commercially available non-silicon pro-perfumes include HaloScent-C, HaloScent-D®, Haloscent-GR HaloScent-I®, HaloScent-S®, HaloScent-UV® (ex Firmenich) and Scentaurus® Clean, Scentaurus® Juicy (Ex Givauden).

### Delivery Particles.

The perfume delivery system may comprise a plurality of delivery particles or encapsulates, for example, where a perfume core is surrounded by shell material (“core-shell encapsulates” or “core-shell”); the core may comprise perfume and optionally a partitioning modifier (e.g., isopropyl myristate) and optionally a benefit agent. Any suitable delivery particle may be utilized. As used herein, “shell” and “wall” are used interchangeably with regard to the delivery particles, unless indicated otherwise. The delivery particle shell or wall may include at least one of melamine formaldehyde, cross-linked polyacrylate, cross-linked polyurea, or cross-linked bio-polymer, silica encapsulates, or combinations thereof.

The shell or wall may be present at a level of from about 1% to about 25%, preferably from about 1% to about 20%, preferably from about 1% to 15%, more preferably from about 5% to about 15%, even more preferably from about 10% to about 15%, even more preferably from about 10% to about 12%, by weight of the delivery particle.

As used herein, the core: polymer shell weight ratio is be understood as calculated on the basis of the weight of the reacted polymer shell-forming materials and initiators that constitute the polymer shell, and for purposes of the calculation excludes in the calculation entrapped nonstructural materials, such as entrapped emulsifier. The calculation is based the amounts of the starting inputs, namely the input monomers and initiators.

The inventors have discovered that a better shell to core ratio can improve the freshness benefit delivered by the dryer sheets. The delivery particles of the present disclosure may be characterized by a core-to-polymer-shell (or wall) weight ratio (also “core: polymer shell weight ratio,” or even “C: S ratio” and the like, as used herein). Relatively high core: polymer shell ratios are typically preferred to increase the delivery efficiency or relatively payload of the delivery particles. However, if the ratio is too high, then the delivery particle may become too brittle or leaky and provide suboptimal performance.

A delivery particle, optionally the population of delivery particles, may be characterized by a core: polymer shell weight ratio of at least about 96:4, optionally at least about 97:3, optionally at least about 98:2, optionally at least about 99:1. A delivery particle, optionally the population of delivery particles, may be characterized by a core-to-polymer-shell weight ratio of from about 96:4 to about 99.5:0.5, optionally from about 96:4 to about 99:1, optionally from about 97:3 to about 99:1, optionally from about 98:2 to about 99:1. The core-to-polymer-shell weight ratio may be from about 96:4 to about 99:1, or from about 96:4 to about 98:2, or from about 97:3 to about 98:2.

As described in more detail below, the delivery particles of the present disclosure comprise a core and a polymer shell (or wall) surrounding the core. Selecting, among other things, particular ratios of core material to polymer shell material can result in populations of delivery particles that show improved performance. Delivery particles with a high core: polymer shell ratio can deliver a benefit agent more efficiently, requiring less polymer shell material to deliver the same amount of benefit agent. Further, because the delivery particles have relatively high loading of benefit agent, less delivery particle material may be required for a particular composition, saving cost and/or freeing up formulation space.

The shell or wall material may include melamine, polyacrylamide, silicones, silica, polystyrene, polyurea, polyurethanes, polyacrylate based materials, polyacrylate esters-based materials, gelatin, styrene malic anhydride, polyamides, aromatic alcohols, polyvinyl alcohol, or mixtures thereof. The melamine shell material may comprise melamine crosslinked with formaldehyde, melamine-dimethoxyethanol crosslinked with formaldehyde, and mixtures thereof; encapsulates with such shell materials may be used in combination with a formaldehyde scavenger, such as acetoacetamide, urea, or derivatives thereof.

The cross-linked polyacrylate based shell materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The cross-linked polyacrylate-based shell materials may comprise polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof.

Cross-linked shells may also comprise aromatic alcohol-based materials selected from aryloxyalkanols, arylalkanols and oligoalkanolarylethers. It may also comprise aromatic compounds with at least one free hydroxyl-group, especially preferred at least two free hydroxy groups that are directly aromatically coupled, wherein it is especially preferred if at least two free hydroxy-groups are coupled directly to an aromatic ring, and more especially preferred, positioned relative to each other in meta position. It is preferred that the aromatic alcohols are selected from phenols, cresoles (o-, m-, and p-cresol), naphthols (alpha and beta-naphthol) and thymol, as well as ethylphenols, propylphenols, fluorophenols and methoxyphenols.

Cross-linked polyacrylate shells may be comprised of oil-soluble or oil-dispersible multifunctional (meth)acrylate monomers or oligomers and may comprise a multifunctional aromatic urethane acrylate. Optionally, the oil-soluble or oil-dispersible multifunctional (meth)acrylate monomers or oligomers comprise a hexafunctional aromatic urethane acrylate.

Additionally or alternatively, the oil-soluble or oil-dispersible multifunctional (meth)acrylate monomers or oligomers may comprise a multifunctional aliphatic urethane acrylate.

The (meth)acrylate polymer of the polymer shell may be derived from at least two different multifunctional (meth)acrylate monomers, for example first and second multifunctional (meth)acrylate monomers, each of which may optionally be oil-soluble or oil-dispersible. The first multifunctional (meth)acrylate monomer may comprise a different number of radical polymerizable functional groups compared to the second multifunctional (meth)acrylate monomer. For example, the first multifunctional (meth)acrylate monomer may comprise six radical polymerizable functional groups (e.g., hexafunctional), and the second multifunctional (meth)acrylate monomer may comprise less than six radical polymerizable functional groups, such as a number selected from three (e.g., trifunctional), four (e.g., tetrafunctional), or five (e.g., pentafunctional), optionally five. The first and second multifunctional (meth)acrylate monomers may be comprise the same number of radical polymerizable functional groups, such as six (e.g., both monomers are hexafunctional), although the respective monomers are characterized by different structures or chemistries.

The oil-soluble or oil-dispersible (meth)acrylate may further comprise a monomer selected from an amine methacrylate, an acidic methacrylate, or a combination thereof.

The aromatic alcohol-based shell material may comprise aryloxyalkanols, arylalkanols and oligoalkanolarylethers. It may also comprise aromatic compounds with at least one free hydroxyl-group, especially preferred at least two free hydroxy groups that are directly aromatically coupled, wherein it is especially preferred if at least two free hydroxy-groups are coupled directly to an aromatic ring, and more especially preferred, positioned relative to each other in meta position. It is preferred that the aromatic alcohols are selected from phenols, cresoles (o-, m-, and p-cresol), naphthols (alpha and beta-naphthol) and thymol, as well as ethylphenols, propylphenols, fluorophenols and methoxyphenols.

Still another example of delivery particles are available, particularly where cross-linked bio-polymer or bio-based materials are desired. Such delivery particles may comprise chitosan. Such delivery particles are described in U.S. Patent Application Publication No. 2024/0182820 and U.S. Patent Application Ser. No. 63/607,418. Cross-linked bio-polymer based shells may alternatively be comprised of polysaccharides, cellulose, chitin, polyhydroxalkanoates, or polylactic acid.

The cross-linked polyurea based shell material may comprise a polyisocyanate. The shell of the delivery particles may comprise a polymeric material that may be the reaction product of a polyisocyanate and a chitosan. The shell may comprise a polyurea resin, where the polyurea resin comprises the reaction product of a polyisocyanate and chitosan. The delivery particles of the present disclosure may be considered polyurea delivery particles and include a polyurea-chitosan shell. The shell may be derived from isocyanates and chitosan.

The cross-linked polyurea delivery particles may be made according to a process that comprises the following steps: forming a water phase comprising chitosan in an aqueous acidic medium; forming an oil phase comprising dissolving together at least one benefit agent and at least one polyisocyanate; forming an emulsion by mixing under high shear agitation the water phase and the oil phase into an excess of the water phase, thereby forming droplets of the oil phase and benefit agent dispersed in the water phase; curing the emulsion by heating, for a time sufficient to form a shell at an interface of the droplets with the water phase, the shell comprising the reaction product of the polyisocyanate and chitosan, and the shell surrounding the core comprising the droplets of the oil phase and benefit agent. Diluents, for example isopropyl myristate, may be used to adjust the hydrophilicity of the oil phase. The oil phase is then added into the water phase and milled at high speed to obtain a targeted size. The emulsion is then cured in one or more heating steps.

The temperature and time are selected to be sufficient to form and cure a shell at the interface of the droplets of the oil phase with the water continuous phase. For example, the emulsion is heated to 85 ° C in 60 minutes and then held at 85 ° C for 360 minutes to cure the particles. The slurry is then cooled to room temperature.

The polyisocyanate may be an aliphatic or aromatic monomer, oligomer or prepolymer, usefully comprising two or more isocyanate functional groups. The polyisocyanate may preferably be selected from a group comprising toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, and phenylene diisocyanate.

The polyisocyanate, for example, can be selected from aromatic toluene diisocyanate and its derivatives used in shell formation for encapsulates, or aliphatic monomer, oligomer or prepolymer, for example, hexamethylene diisocyanate and dimers or trimers thereof, or 3,3,5-trimethyl-5-isocyanatomethyl-1-isocyanato cyclohexane tetramethylene diisocyanate. The polyisocyanate can be selected from 1,3-diisocyanato-2-methylbenzene, hydrogenated MDI, bis(4-isocyanatocyclohexyl) methane, dicyclohexylmethane-4,4′-diisocyanate, and oligomers and prepolymers thereof. This listing is illustrative and not intended to be limiting of the polyisocyanates useful in the present disclosure.

The polyisocyanates useful in the invention comprise isocyanate monomers, oligomers or prepolymers, or dimers or trimers thereof, having at least two isocyanate groups. Optimal crosslinking can be achieved with polyisocyanates having at least three functional groups.

Polyisocyanates, for purposes of the present disclosure, are understood as encompassing any polyisocyanate having at least two isocyanate groups and comprising an aliphatic or aromatic moiety in the monomer, oligomer, or prepolymer. If aromatic, the aromatic moiety can comprise a phenyl, a toluyl, a xylyl, a naphthyl or a diphenyl moiety, more preferably a toluyl or a xylyl moiety. Aromatic polyisocyanates, for purposes herein, can include diisocyanate derivatives such as biurets and polyisocyanurates. The polyisocyanate, when aromatic, can be, but is not limited to, methylene diphenyl isocyanate, toluene diisocyanate, tetramethylxylidene diisocyanate, polyisocyanurate of toluene diisocyanate (commercially available from Bayer under the tradename Desmodur® RC), trimethylol propane-adduct of toluene diisocyanate (commercially available from Bayer under the tradename Desmodur® L75), or trimethylol propane-adduct of xylylene diisocyanate (commercially available from Mitsui Chemicals under the tradename Takenate® D-110N), naphthalene-1,5-diisocyanate, and phenylene 5 diisocyanate.

There is a preference for aromatic polyisocyanate; however, aliphatic polyisocyanates and blends thereof may be useful. Aliphatic polyisocyanate is understood as a polyisocyanate which does not comprise any aromatic moiety. Aliphatic polyisocyanates include a trimer of hexamethylene diisocyanate, a trimer of isophorone diisocyanate, a trimethylol propane-adduct of hexamethylene diisocyanate (available from Mitsui Chemicals) or a biuret of hexamethylene diisocyanate (commercially available from Bayer under the tradename Desmodur® N 100).

The shell may degrade at least 50% after 20 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

Yet another perfume delivery particle can be silica encapsulates. Silica encapsulate perfume delivery systems may comprise the capsules comprising:
an oil-based core comprising a freshness benefit agent; and a shell surrounding the core, the shell comprising:
a substantially inorganic first shell component comprising:
a condensed layer comprising a condensation product of a precursor; and
a nanoparticle layer comprising inorganic nanoparticles; wherein the
condensed layer is disposed between the core and the nanoparticle layer, and an inorganic second shell component surrounding the first shell component, wherein the second shell component surrounds the nanoparticle layer, and
wherein the precursor comprises at least one compound of Formula (M^{v}O_{z}Yₙ)_{w}
where M is one or more of silicon, titanium and aluminum,
v is the valence number of M and is 3 or 4,
z is from 0.5 to 1.6
each Y is independently selected from —OH, —OR², halo,

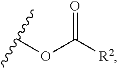

### —NH₂,

—NHR², —N(R²)₂, and

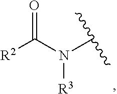

wherein R₂ is a C₁ to C₂₀ alkyl, C₁ to C₂₀ alkylene, C₆ to C₂₂ aryl, or a 5-12 memb roaryl comprising from 1 to 3 ring heteroatoms selected from O, N, and S,

R³ is a H, C₁ to C₂₀ alkyl, C₁ to C₂₀ alkylene, C₆ to C₂₂ aryl, or a 5-12 membered heteroaryl comprising from 1 to 3 ring heteroatoms selected from O, N, and S,
n is from 0.7 to (v−1), and
w is from 2 to 2000.

The fabric care composition may include delivery particles. The dryer sheet may include about 0.2 wt. % to about 20 wt. %, or from 0.3 wt. % to 10 wt. %, or from 0.1% to 5%, or from 0.2% to 2%, by weight of the dryer sheet, of delivery particles. When discussing herein the amount or weight percentage of the delivery particles, it is meant the sum of the shell material and the core material. Delivery particles may include non-benefit agents such as a diluent, or other minor ingredients such as salts (i.e., MgCl2 or CaCl2), or a structurant (e.g., xanthan gum) to stabilize the delivery particle. These ingredients may be considered minor ingredients in the dryer sheet.

The delivery particles according to the present disclosure may be characterized by a volume-weighted median particle size from 1 to 150 microns, preferably from 10 to 100 microns, preferably from 15 to 75 microns, more preferably from 10 to 100 microns, even more preferably from 15 to 75 microns, or more preferably from about 20 to about 50 microns. Different particle sizes are obtainable by controlling droplet size during emulsification.

The delivery particles may be characterized by a ratio of core to shell up to 99:1, or even 99.5:1, on the basis of weight. In examples, the plurality of delivery particles may have a ratio of core to shell of at least 75:25, or 85:15, or 90:10, or even up to 99:1, or even at least 99.5:0.5, on the basis of weight.

The shell may be present at a level of from about 1% to about 25%, preferably from about 1% to about 20%, preferably from about 1% to 15%, more preferably from about 5% to about 15%, even more preferably from about 10% to about 15%, even more preferably from about 10% to about 12%, by weight of the delivery particle.

The core may comprise from about 5% to about 100%, by weight of the core, of a benefit agent. Suitable benefit agents located in the core may include benefit agents that provide benefits to a surface, such as a fabric.

The benefit agent may be selected from the group consisting of fragrance, silicone oils, waxes, hydrocarbons, higher fatty acids, essential oils, lubricants, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, fabric comfort agents, shrinkage resistance agents, stretch resistance agents, stretch recovery agents, skin care agents, glycerin, synthetic or natural actives, antibacterial actives, antiperspirant actives, cationic polymers, dyes, and mixtures thereof.

The benefit agent may optionally be a fragrance, which may include one or more perfume raw materials. The term “perfume raw material” (or “PRM”) as used herein refers to compounds having a molecular weight of at least about 100 g/mol and which are useful in imparting an odor, fragrance, essence or scent, either alone or with other perfume raw materials. Typical PRMs comprise inter alia alcohols, ketones, aldehydes, esters, ethers, nitrites and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The core may optionally include a second benefit agent or a partitioning modifier. The core may comprise from about 45% to about 95%, preferably from about 50% to about 80%, more preferably from about 50% to about 70%, by weight of the core, of the benefit agent, fragrance material, a partitioning modifier or any combination thereof.

The partitioning modifier may be present in the core at a level of from about 5% to about 55%, optionally from about 10% to about 50%, optionally from about 25% to about 50%, by weight of the core.

The partitioning modifier may comprise a material selected from the group consisting of vegetable oil, modified vegetable oil, mono-, di-, and tri-esters of C₄-Cha fatty acids, isopropyl myristate, dodecanophenone, lauryl laurate, methyl behenate, methyl laurate, methyl palmitate, methyl stearate, and mixtures thereof. The partitioning modifier may optionally comprise or even consist of isopropyl myristate. The modified vegetable oil may be esterified and/or brominated. The modified vegetable oil may optionally comprise castor oil and/or soy bean oil. US Patent Application Publication 20110268802, incorporated herein by reference, describes other partitioning modifiers that may be useful in the presently described delivery particles.

Regardless of the delivery particles utilized, the delivery particles may be present in the fabric care composition at from about 0.05% to about 20%, or from about 0.05% to about 10%, or from about 0.1% to about 5%, or from about 0.2% to about 2%, or any range created thereby, by weight of the fabric care composition. The dryer sheet may include from about 0.1 to about 5 wt. %, from about 0.1 to about 4.5 wt. %, from about 0.1 to about 4 wt. %, from about 0.1 to about 3.5 wt. %, from about 0.1 to about 3 wt. %, from about 0.1 to about 2.5 wt. %, from about 0.1 to about 2 wt. %, from about 0.1 to about 1.5 wt. %, from about 0.1 to about 1 wt. %, from about 0.1 to about 0.5 wt. %, from about 0.2 to about 5 wt. %, from about 0.2 to about 4.5 wt. %, from about 0.2 to about 4 wt. %, from about 0.2 to about 3.5 wt. %, from about 0.2 to about 3 wt. %, from about 0.2 to about 2.5 wt. %, from about 0.2 to about 2 wt. %, from about 0.2 to about 1.5 wt. %, from about 0.2 to about 1 wt. %, from about 0.2 to about 0.5 wt. %, from about 0.5 to about 5 wt. %, from about 0.5 to about 4.5 wt. %, from about 0.5 to about 4 wt. %, from about 0.5 to about 3.5 wt. %, from about 0.5 to about 3 wt. %, from about 0.5 to about 2.5 wt. %, from about 0.5 to about 2 wt. %, from about 0.5 to about 1.5 wt. %, from about 0.5 to about 1 wt. %, from about 1 to about 5 wt. %, from about 1 to about 4.5 wt. %, from about 1 to about 4 wt. %, from about 1 to about 3.5 wt. %, from about 1 to about 3 wt. %, from about 1 to about 2.5 wt. %, from about 1 to about 2 wt. %, from about 1 to about 1.5 wt. %, from about 1.5 to about 5 wt. %, from about 1.5 to about 4.5 wt. %, from about 1.5 to about 4 wt. %, from about 1.5 to about 3.5 wt. %, from about 1.5 to about 3 wt. %, from about 1.5 to about 2.5 wt. %, from about 1.5 to about 2 wt. %, from about 2 to about 5 wt. %, from about 2 to about 4.5 wt. %, from about 2 to about 4 wt. %, from about 2 to about 3.5 wt. %, from about 2 to about 3 wt. %, from about 2 to about 2.5 wt. %, from about 2.5 to about 5 wt. %, from about 2.5 to about 4.5 wt. %, from about 2.5 to about 4 wt. %, from about 2.5 to about 3.5 wt. %, from about 2.5 to about 3 wt. %, from about 3 to about 5 wt. %, from about 3 to about 4.5 wt. %, from about 3 to about 4 wt. %, from about 3 to about 3.5 wt. %, from about 3.5 to about 5 wt. %, from about 3.5 to about 4.5 wt. %, from about 3.5 to about 4 wt. %, from about 4 to about 5 wt. %, from about 4 to about 4.5 wt. %, from about 4.5 to about 5 wt. %, or any ranges created thereby, of delivery particles by weight of the dryer sheet. Each of the plurality of particles comprises a core surrounded by a shell, wherein the core comprises a benefit agent.

The polymer shell of the delivery particles may comprise a coating, for example on an outer surface of the polymer shell, away from the core. The delivery particles may be manufactured and be subsequently coated with a coating material. The coating may be useful as a deposition aid. The coating may comprise a cationic material, such as a cationic polymer, a non-ionic polymer, an anionic polymer, or mixtures thereof. A coating that is not a structural or support feature of the polymer shell is not to be included in calculations when determining the core: polymer shell weight ratio. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, a polysaccharide (e.g., chitosan), and combinations thereof.

The perfume delivery system may comprise particles that comprise a graft copolymer and a fragrance material, where the graft copolymer comprises a polyalkylene glycol (e.g., polyethylene glycol) as a graft base and one or more side chains that comprise vinyl acetate moieties.

When the perfume delivery system includes formaldehyde derivatives, such as perfume encapsulates with melamine-formaldehyde shells, the composition may further comprise a formaldehyde scavenger, which may comprise a sulfur-based formaldehyde scavenger, a non-sulfur-based formaldehyde scavenger, or mixtures thereof. Suitable non-sulfur-based formaldehyde scavengers may include urea, ethylene urea, acetoacetamide, or mixtures thereof. Suitable sulfur-based formaldehyde scavengers may include alkali and/or alkali earth metal dithionites, pyrosulfites, sulfites, bisulfites, metasulfites, monoalkyl sulphites, dialkyl sulphites, dialkylene sulphites, sulfides, thiosulfates, thiocyanates, mercaptans, thiourea, and mixtures thereof.

### Adjuncts

The fabric care composition can comprise adjuncts selected from the group consisting of softening agents, soil release agents, anti-static agents, crisping agents, water/stain repellents, stain release agents, refreshing agents, disinfecting agents, wrinkle resistant agents, wrinkle release agents, odor resistance agents, malodor control agents, abrasion resistance and protection agents, solvents, insect/pet repellents, wetting agents, chlorine scavenging agents, optical brighteners, UV protection agents, skin/fabric conditioning agents, skin/fabric nurturing agents, skin/fabric hydrating agents, color protection agents, dye fixatives, dye transfer inhibiting agents, silicones, preservatives and anti-microbials, fungicides, fabric shrinkage-reducing agents, brighteners, hueing dyes, bleaches, chelants, antifoams, anti-scum agents, whitening agents, catalysts, cyclodextrin, zeolites, starch encapsulated accords, petrolatum, glycerin, triglycerides, vitamins, other skin care actives such as aloe vera, chamomile, shea butter and the like, mineral oils, and combinations thereof.

### Neat Perfume

The fabric care composition of the present disclosure may further comprise a neat perfume in addition to the fragrance moiety of the silicic acid perfume esters described herein.

As noted, the fabric care composition can further comprise neat perfume, i.e. unencapsulated. The fabric care composition may comprise about 0.1% to about 20%, preferably from about 1% to about 15%, even more preferably from about 2% to about 10%, or from about 0.1% to about 5% by weight, and combinations thereof and any whole percentages within any of the aforementioned ranges, of unencapsulated perfume by weight of the fabric care composition. In examples, the dryer sheet may include from about 0.1 to about 20 wt. %, from about 0.1 to about 15 wt. %, from about 0.1 to about 10 wt. %, from about 0.1 to about 7 wt. %, from about 0.1 to about 5 wt. %, from about 0.1 to about 4 wt. %, from about 0.3 to about 20 wt. %, from about 0.3 to about 15 wt. %, from about 0.3 to about 10 wt. %, from about 0.3 to about 7 wt. %, from about 0.3 to about 5 wt. %, from about 0.3 to about 4 wt. %, from about 0.5 to about 20 wt. %, from about 0.5 to about 15 wt. %, from about 0.5 to about 10 wt. %, from about 0.5 to about 7 wt. %, from about 0.5 to about 5 wt. %, from about 0.5 to about 4 wt. %, from about 0.7 to about 20 wt. %, from about 0.7 to about 15 wt. %, from about 0.7 to about 10 wt. %, from about 0.7 to about 7 wt. %, from about 0.7 to about 5 wt. %, from about 0.7 to about 4 wt. %, from about 1 to about 20 wt. %, from about 1 to about 15 wt. %, from about 1 to about 10 wt. %, from about 1 to about 7 wt. %, from about 1 to about 5 wt. %, from about 1 to about 4 wt. %, from about 1.3 to about 20 wt. %, from about 1.3 to about 15 wt. %, from about 1.3 to about 10 wt. %, from about 1.3 to about 7 wt. %, from about 1.3 to about 5 wt. %, from about 1.3 to about 4 wt. %, from about 1.5 to about 20 wt. %, from about 1.5 to about 15 wt. %, from about 1.5 to about 10 wt. %, from about 1.5 to about 7 wt. %, from about 1.5 to about 5 wt. %, from about 1.5 to about 4 wt. %, from about 2 to about 20 wt. %, from about 2 to about 15 wt. %, from about 2 to about 10 wt. %, from about 2 to about 7 wt. %, from about 2 to about 5 wt. %, from about 2 to about 4 wt. %, from about 2.5 to about 20 wt. %, from about 2.5 to about 15 wt. %, from about 2.5 to about 10 wt. %, from about 2.5 to about 7 wt. %, from about 2.5 to about 5 wt. %, from about 2.5 to about 4 wt. %, from about 3 to about 20 wt. %, from about 3 to about 15 wt. %, from about 3 to about 10 wt. %, from about 3 to about 7 wt. %, from about 3 to about 5 wt. %, from about 3 to about 4 wt. %, or any ranges created thereby, of neat perfume, by weight of the dryer sheet. Perfumes are generally described in U.S. Pat. No. 7,186,680. Free perfume can be fragrance oil/perfume oil.

The relationship between free perfume and encapsulated perfume can require some balance. In an effort to create anti-habituating fragrances for the user, it may be beneficial to configure the free perfume with less than 50% overlap/similarity to that of the encapsulated perfume. Anti-habituating fragrances and PRM's are described in additional detail in U.S. Pat. No. 11,844,854. The less than 50% overlap can be created via the use of different PRM's in the free perfume versus the encapsulated wherein less than 50% of the PRM's in the free perfume are the same as those of the encapsulated perfume. The less than 50% overlap can be created via the use of different weight percentages of PRM's over that of the free perfume. For example, at least 50% of the PRM's of the encapsulated perfume can have a weight percentage difference over the same PRM's in the free perfume. Alternatively, combinations of weight percentages and different PRM's can be utilized to formulate anti-habituating fragrances.

When the fabric care composition includes encapsulated perfume oil (such as examples where the fabric care composition includes a plurality of delivery particles, wherein each of the plurality of particles comprises a core surrounded by a shell, wherein the core comprises a benefit agent), the dryer sheet may include from about 0.1 to about 20 wt. %, from about 0.1 to about 15 wt. %, from about 0.1 to about 10 wt. %, from about 0.1 to about 7 wt. %, from about 0.1 to about 5 wt. %, from about 0.1 to about 4 wt. %, from about 0.1 to about 3 wt. %, from about 0.1 to about 2.5 wt. %, from about 0.1 to about 2 wt. %, from about 0.1 to about 1.5 wt. %, from about 0.1 to about 1 wt. %, from about 0.1 to about 0.7 wt. %, from about 0.1 to about 0.5 wt. %, from about 0.5 to about 20 wt. %, from about 0.5 to about 15 wt. %, from about 0.5 to about 10 wt. %, from about 0.5 to about 7 wt. %, from about 0.5 to about 5 wt. %, from about 0.5 to about 4 wt. %, from about 0.5 to about 3 wt. %, from about 0.5 to about 2.5 wt. %, from about 0.5 to about 2 wt. %, from about 0.5 to about 1.5 wt. %, from about 0.5 to about 1 wt. %, from about 0.5 to about 0.7 wt. %, from about 0.7 to about 20 wt. %, from about 0.7 to about 15 wt. %, from about 0.7 to about 10 wt. %, from about 0.7 to about 7 wt. %, from about 0.7 to about 5 wt. %, from about 0.7 to about 4 wt. %, from about 0.7 to about 3 wt. %, from about 0.7 to about 2.5 wt. %, from about 0.7 to about 2 wt. %, from about 0.7 to about 1.5 wt. %, from about 0.7 to about 1 wt. %, from about 1 to about 20 wt. %, from about 1 to about 15 wt. %, from about 1 to about 10 wt. %, from about 1 to about 7 wt. %, from about 1 to about 5 wt. %, from about 1 to about 4 wt. %, from about 1 to about 3 wt. %, from about 1 to about 2.5 wt. %, from about 1 to about 2 wt. %, from about 1 to about 1.5 wt. %, from about 1.5 to about 20 wt. %, from about 1.5 to about 15 wt. %, from about 1.5 to about 10 wt. %, from about 1.5 to about 7 wt. %, from about 1.5 to about 5 wt. %, from about 1.5 to about 4 wt. %, from about 1.5 to about 3 wt. %, from about 1.5 to about 2.5 wt. %, from about 1.5 to about 2 wt. %, or any ranges created thereby, of delivery particles, by weight of the dryer sheet.

### Clay

The dryer sheets can comprise a fabric care composition that comprises a clay. The clay can be bentonite. The clay can be sodium bentonite, calcium bentonite, or a mixture thereof. Clay may be formulated into the fabric care composition to manage viscosity during processing to make dryer sheets. The amount of clay may be changed depending on the specific formulation wherein said fabric care composition comprises from about 0 to about 10 wt. %, from about 0.1 to about 10 wt. %, from about 0.5 to about 10 wt. %, from about 1 to about 10 wt. %, from about 2 to about 10 wt. %, from about 5 to about 10 wt. %, or any range created thereby, by weight of said fabric care composition, of clay. In examples, the dryer sheet may include from about 0 to about 20 wt. %, from about 0 to about 15 wt. %, from about 0 to about 10 wt. %, from about 0 to about 8 wt. %, from about 0 to about 6 wt. %, from about 0.1 to about 20 wt. %, from about 0.1 to about 15 wt. %, from about 0.1 to about 10 wt. %, from about 0.1 to about 8 wt. %, from about 0.1 to about 6 wt. %, from about 0.5 to about 20 wt. %, from about 0.5 to about 15 wt. %, from about 0.5 to about 10 wt. %, from about 0.5 to about 8 wt. %, from about 0.5 to about 6 wt. %, from about 1 to about 20 wt. %, from about 1 to about 15 wt. %, from about 1 to about 10 wt. %, from about 1 to about 8 wt. %, from about 1 to about 6 wt. %, from about 3 to about 20 wt. %, from about 3 to about 15 wt. %, from about 3 to about 10 wt. %, from about 3 to about 8 wt. %, from about 3 to about 6 wt. %, from about 4 to about 20 wt. %, from about 4 to about 15 wt. %, from about 4 to about 10 wt. %, from about 4 to about 8 wt. %, from about 4 to about 6 wt. %, from about 5 to about 20 wt. %, from about 5 to about 15 wt. %, from about 5 to about 10 wt. %, from about 5 to about 8 wt. %, from about 5 to about 6 wt. %, or any range created thereby, of clay, by weight of the dryer sheet.

### Nonwoven Fibrous Substrate

Nonwoven fibrous substrates provide for adequate function as a carrier of fabric care compositions. Fabric care compositions comprise fabric softening actives. The nonwoven fibrous substrate can be a polyester nonwoven fibrous substrate. For example, the nonwoven fibrous substrate can be polyester terephthalate. The nonwoven fibrous substrate can be a spun bonded polyester terephthalate. Optionally, the nonwoven fibrous substrate can be continuous filament spun bonded polyester terephthalate. Nonwovens are flat, porous sheets made from a web or sheet of fibers that are bonded together. Spun bond, carded, point bonded and bicontinuous fiber non-wovens can also be used. Nonwovens may be made from synthetic polymer fibers or natural fibers. Nonwovens may be biodegradable substrates. Biodegradable substrates are nonwovens made from biodegradable fibers that may decompose into simpler substances (such as, as nonlimiting examples, carbon dioxide, water, and biomass) over time in the environment. Biodegradable nonwovens may be advantageous to reduce or eliminate synthetic polymer waste. Suitable biodegradable nonwoven fibrous substrates may include rayon, viscose, lyocell, flax, hemp, polybutylene adipate terephthalate (PBAT), or polylactic acid. Biodegradability can be determined by measuring carbon dioxide (CO2) evolution or oxygen demand, assessing weight loss in compost, and analyzing disintegration using for example a test method such as ASTM D6094.

The nonwoven fibrous substrate can have a basis weight from about 10 g/m² to about 50 g/m2. Such fibrous substrates have sufficient constitution to carry the desired quantity of fabric care composition. To provide for the desired release of the fabric care composition, the nonwoven fibrous substrate can have a permeability of from about 50 Darcys to about 150 Darcys, optionally about 90 Darcys to about 140 Darcys. The fibers constituting the nonwoven fibrous substrate can have a denier from about 2 to about 6. The nonwoven fibrous substrate can have a caliper from about 0.1 mm to about 0.5 mm, or optionally from about 0.1 mm to about 0.4 mm. The greater the caliper, the more space within the nonwoven fibrous substrate to hold fabric care composition. The nonwoven fibrous substrate can have a basis weight from about 10 g/m² to about 40 g/m², optionally, from about from about 12 g/m² to about 20 g/m2.

The nonwoven fibrous substrate can be a continuous filament of polyester homopolymer and binder filaments formed of a polyester copolymer. The nonwoven fibrous substrate can be a polyolefin nonwoven. The nonwoven fibrous substrate can be spunbonded nonwoven. The nonwoven fibrous substrate can be an area bonded or point bonded nonwoven. The nonwoven fibrous substrate can be a spun bonded polyethylene terephthalate having trilobal fibers having a denier from about 5 to about 6. The nonwoven fibrous substrate can be a spun bonded a bicomponent fiber having a polyethylene terephthalate core and copolyethylene terephthalate with isophthatlate and or mixture thereof.

The nonwoven fibrous substrate can comprise bicomponent fibers. The bicomponent fibers can be core-sheath constructions or lobed constructions. The nonwoven fibrous substrate can comprise bicomponent fibers that are polyethylene/polyethylene terephthalate core-sheath constructions, with either constituent forming the core or sheath. The bicomponent fibers can be polyethylene/polypropylene, with either constituent forming the core or sheath.

The nonwoven fibrous substrate can be the nonwoven fibrous substrate used presently or in the past or like that used presently or in the past in BOUNCE dryer sheets, available from The Procter & Gamble Company, Cincinnati, OH, United States of America, SNUGGLE dryer sheets, available from Henkel Corporation, Stamford, Connecticut, United States of America, and or SUAVITEL dryer sheets, available from Colgate-Palmolive Company, New York, New Yok, United States of America. The nonwoven fibrous substrate can be cellulose.

In examples, the dryer sheet may include from about 5 to about 50 wt. %, from about 5 to about 40 wt. %, from about 5 to about 35 wt. %, from about 10 to about 50 wt. %, from about 10 to about 40 wt. %, from about 10 to about 35 wt. %, from about 15 to about 50 wt. %, from about 15 to about 40 wt. %, from about 15 to about 35 wt. %, from about 20 to about 50 wt. %, from about 20 to about 40 wt. %, from about 20 to about 35 wt. %, from about 25 to about 50 wt. %, from about 25 to about 40 wt. %, from about 25 to about 35 wt. %, from about 30 to about 50 wt. %, from about 30 to about 40 wt. %, from about 30 to about 35 wt. %, and any ranges created thereby, of the nonwoven fibrous substrate, by weight of the dryer sheet.

### Process of Manufacture

The dryer sheet can be practically formed using a continuous web converting process. A nonwoven fibrous substrate can be provided. A melt of the fabric care composition can be applied to the nonwoven fibrous substrate. The melt can cool and solidify so as to be carried on, within, or a combination of on and within the nonwoven fibrous substrate. The fabric care composition can be positioned, at least partially or entirely, in the interstitial spaces amongst the fibers constituting the nonwoven fibrous substrate.

The melt of fabric care composition can be applied to the nonwoven fibrous substrate by slot coating, blade coating, spray coating, kiss rolling, roll coating, reverse roll coating printing, rotogravure coating, printing and other processes for applying the fabric care composition as a melt. One practical approach for applying fabric care composition to a nonwoven fibrous substrate is to slot coat the nonwoven fibrous substrate and use a scraper set at or just above the nonwoven fibrous substrate to scrape off fabric care composition at some level at or above the surface of the nonwoven fibrous substrate so that excess fabric care composition is removed.

Neat perfume or silicic acid perfume esters and mixtures thereof can be applied to the nonwoven by incorporating into the melted fabric care composition before coating the nonwoven. Additionally or alternatively, neat perfume or silicic acid perfume esters and mixtures thereof can be applied by spraying onto the nonwoven fibrous substrate after coating with the fabric care composition. Spray on application of the neat perfume or silicic acid perfume ester or mixture thereof can be continuous or intermittent using spray nozzles known to those of ordinary skill in the art.

The fabric care composition may comprise a fabric softening active (FSA), a silicic acid perfume ester and a neat perfume (i.e., perfume). The fabric care composition is applied to a nonwoven as a melt in the process. The silicic acid perfume ester and the perfume may be injected into the fabric care composition melt during manufacture or the silicic acid perfume ester and perfume can be applied in a separate step after the non-woven has been coated. Silicic acid perfume ester and perfume may be combined or applied separately. When perfume is applied after the nonwoven coating step, the application may occur in the process just after the FSA has been applied or at a later step in the process prior to the cutting and folding of coated nonwoven before packaging the dryer sheets.

A method of making the dryer sheet of the present disclosure may include the steps of: providing said nonwoven fibrous substrate; providing a melt of said fabric care composition; and applying said melt of said fabric care composition to said nonwoven fibrous substrate. Coated non-woven may be converted to discreet dryer sheets that can be removed from conventional package such as a box, a flow wrap, resealable bag or alternatively provided to the consumer as a perforated roll that may be packaged in a box, plastic wrap, a tube, or a tub. The box may be made of cardboard, plastic, paper, or combinations thereof. Dryer sheets may be perforated or non-perforated, wherein perforated dryer sheets have a frangible boundary having at least a first portion, and a second portion. Coated non-woven may be cut and folded to various dimensions and folded in various ways. In examples, the dryer sheet may be folded along a first fold line and along a second fold line substantially parallel to the first fold line to have a z-fold. In examples, a z-fold dryer sheet may be folded along a third fold line substantially perpendicular to the first fold line to have a c-fold. U.S. Pat. No. 10,676,702 and related family members are hereby incorporated by reference.

### Method of Use

The dryer sheet of the present disclosure may be used in a commercial or residential or laundromat dryer unit. Dryer units may be heat pump, condenser, vented or non-vented types. Dryers may be traditional or high efficiency machines that use a timed cycle or sensors to end the drying time. The method includes the step whereby the consumer may place the dryer sheet within the dryer unit when adding a load of laundry to the drying unit drum. A consumer may add one or more dryer sheets to the drying unit before or after the laundry load is added. The laundry load may be wet or damp. Alternatively, dryer sheets may also be added to a dry clothing item or items or even a load to impart benefits to one or more dry textiles (e.g. to freshen clothes).

### Methods

Small Scale Fabric Care Composition Coat Mix Preparation Method. Dryer sheet fabric care composition coat mixes (hereafter referred to as coat mixes) are prepared by melting the raw material ingredients: 1) FSA (fabric softening active, e.g., quaternary ammonium compound) and 2) fatty acid in an oven set at 80 ° C until fluid and homogeneous. FSA, fatty acid and clay are weighed and combined into a pre-heated glass vessel in a heating mantle set to 80 ° C with mixing using a 2″ pitched impeller blade at 350 RPM for 3 min until fully mixed. Perfume, silicic acid perfume esters, and encapsulated perfume (i.e. perfume delivery particles) are added and stirred for 3 min. The dryer sheet coat mix composition is poured onto a flat surface covered with aluminum foil to cool. Coat mixes made without perfume may be cooled, and re-melted then finished with perfume, Silicic acid perfume esters, and encapsulated perfume delivery particles by mixing using a high speed mixer such as a Flaktek mixer at 3600 rpm for 1 min then poured onto a flat surface covered with aluminum foil. Cooled coat mix is broken into pieces and stored until handmade sheets are prepared.

Handmade Sheet Coating Method. Fabric care composition coat mixes are applied as a melt to a polyester non-woven such as spun bond PET 17.8 gsm (available under the tradename Berry White R²). Fabric Care composition coat mix that has been prepared and cooled to room temperature is applied to a pre-heated stainless-steel plate at 80 ° C to make a uniform coating, then a pre-cut non-woven (19.3 cm×19.3 cm, 0.66 g) is placed on the melted thin film of coat mix to transfer the melt to the non-woven. The coated non-woven is cooled and is weighed and the process repeated until a level of 1.47-1.57 g coat mix per nonwoven sheet is achieved for a total coated sheet weight of 2.2 g per coated dryer sheet. Coated non-woven dryer sheets are cooled in ambient conditions and stored in aluminum foil until ready for use.

Slot Coating Non-Woven Method. Rolls of spun bond PET non-woven are coated in a continuous process by applying melted fabric care composition using a slot coater where the nip gap and speed controls the coating. FSA (such as a quaternary ammonium compound) and fatty acid are melted at 80 ° C and clay is added with mixing in a CAM tank that is fed into a colloid mill for mixing and is followed by injection of encapsulated perfume, perfume, and silicic acid perfume ester. Coated non-woven passes through chill rolls and is rewound. The silicic acid ester can be introduced to the non-woven via a separate injection or by combining with neat perfume or a perfume accord as a pre-mix. The coated non-woven is cooled then is converted using a slitting machine, folded and is packaged, for example cardboard cartons.

Fabric Treatment Method. Before testing for Dry Fabric Odor (DFO) or Dry Fabric Headspace (DFHS), the test fabrics are prepared and treated according to the procedures described below. Fabrics are typically “de-sized” and/or “stripped” of any manufacturer's finish that may be present (according to A, below), dried, and then treated with a commercial detergent composition such as Tide® without any perfume in a front-loading machine (according to B below) and dried in a tumble dryer such a Maytag Commercial series dryer on the permanent press/medium setting for 45 minutes with dryer sheets of the present disclosure.

A. Fabric De-sizing Method. New fabrics are de-sized by washing two cycles with 49 ° C (120 ° F), using zero grain water in a top loading washing machine such as Maytag Commercial series. All fabrics are tumble-dried after the second cycle for 45 minutes on permanent press setting in a Kenmore series dryer.

B. Fabric Treatment Method in a Front-Loading Washing Machine. De-sized fabrics are treated with compositions of the present disclosure by dispensing the detergent compositions into the wash cycle of a front-loading washing machine such as a Whirlpool Duet Model 9200 (Whirlpool, Benton Harbor, Michigan, USA). The detergent composition (48.9 g) is added to the dosing drawer of the washing machine, and 2.7 kg of de-sized 100% cotton terry towels (32 cm×32 cm, such as RN37002LL from Calderon Textiles, Indianapolis, Indiana, USA) are added to the drum of the machine. The de-sized fabrics are treated with a detergent composition using the normal cycle with 18.9 L of water with 120 mg/L of calcium carbonate equivalents (7 grains per gallon) and 32 ° C wash temperature and 16 ° C rinse temperature.

Treated fabrics are then dried using two dryer sheets using a standard US tumble dryer such as Maytag Commercial series dryer on the permanent press/medium setting for 45 minutes. Treated fabrics, and specimens cut from treated fabrics are equilibrated in controlled temperature and humidity rooms or chambers prior to assessment at 50% relative humidity/32 ° C for a minimum period of 4 h up to 2 weeks.

Dry Fabric Headspace Analysis Method. Dry Fabric headspace (DFHS) analysis is performed using Solid-phase Micro Extraction Gas Chromatography Mass Spectrometry (SPME GC-MS) described below. Typically, greater perfume intensity (as measured by headspace analysis) correlates with higher concentrations of perfume on fabric or greater perfume in the headspace above a box of dryer sheets or a single dryer sheet. Perfume headspace analysis is carried out on treated 100% cotton terry towels (32 cm×32 cm, RN37000ITL, Calderon Textiles, LLC, Indianapolis, IN, USA) that have been prepared and treated according to the fabric preparation method that is described above and equilibrated at 50% relative humidity as outlined in the examples below.

Headspace analysis is done on six treated fabrics from two different laundry loads for a total of twelve fabrics. Each treated fabric is die-cut into ten 1.4 cm-diameter circle test specimens using a pneumatic press (Atom Clicker Press SE20C available from Manufacturing Suppliers Services, Cincinnati, OH). The ten test specimens are placed into a 20 mL headspace sample vial (#24694, available from Restek, Bellefonte, PA), the weight is recorded (ten 1.4 cm circles weigh about 0.70 g±0.07 g), and the vial is capped (#093640-094-00 available from Gerstel, Linthicum, MD). The samples vials are then loaded onto a Gerstel MPS2 Autosampler (Gerstel Inc., Linthicum, MD, USA). Prior to the headspace analysis, each sample is pre-conditioned in the machine at 65 ° C for 10 minutes. Headspace is extracted onto an Agilent 7890B/5977A GC-MS system (Agilent Technologies, Santa Clara, CA, USA) equipped with a Supelco 50/30 micrometer DVB/CAR/PDMS 23Ga. Solid Phase Micro Extraction fiber (Supelco Inc., Bellefonte, PA, USA). GC analysis is conducted on a non-polar capillary column (DB-5 MS UI, 30 meters nominal diameter, 0.25 millimeter nominal diameter, 25 micrometer thickness) and the headspace constituents (i.e. the perfume raw materials) are monitored by Mass Spectrometry (EI, 70 eV detector). Headspace intensity is calculated utilizing a single point calibration of the perfume raw materials. The total headspace concentration for each vial is calculated from the sum of the concentration of each detected perfume raw material, and the headspace is averaged for the twelve treated fabrics. Headspace improvement may be determined relative to the reference treatment.

In the case of determining headspace over a box of dryer sheets, headspace is collected using a collection device at 1 mL/min to collect 1 L of headspace onto a Tenex trap (Restek-Tenax TA 35/60 part #25701) that is loaded onto a Gerstel MPS2 Autosampler (Gerstel Inc., Linthicum, MD, USA) and measured using the Agilent 7890B/5977A GC-MS as described above. The collection sample was introduced to the GC by a Gerstel Thermal Desorption Unit. Prior to the headspace analysis, the box was equilibrated at 50%/21C for 2 h prior to measurement.

Dry Fabric Odor Performance Method. Dry Fabric Odor (DFO) assessment is performed on equilibrated fabrics by trained perfumers that grade the olfactive intensity of treated fabrics on a scale of 0 to 100 where a higher the DFO score is higher the freshness intensity. Perfumer intensity scores are reported as an average of the perfumer scores (n=2 minimum) and character change assessment is given. A DFO difference of 5 units is minimum to be described as different by perfumers and a difference of 10 units is minimum to be considered different by average consumers.

Durometer Method. Fabric care composition coat mixes are prepared according to the Small Scale Fabric Care Composition Coat Mix Preparation method and 65 g are poured into a silicone mold (4″long×1″ wide×1″ deep). The melt is cooled to room temperature at ambient conditions for a minimum of 16 h, removed from the mold and hardness is measured using a Shore B durometer (#511B digital e2000 available from PTC Instruments). Before usage, the operational performance of the durometer is verified using the PTC® Durometer Test Block ASTM Type B #401B. A total of 10 maximum hardness measurements are taken across the fabric care composition coat mix sample and the average is reported.

### EXAMPLES

DRYER SHEET COMPOSITIONS. Dryer sheet compositions are shown in Tables 1.1 to 1.5 as weight % active material including the non-woven and fabric care composition coat mix ingredients where fabric care composition ingredients include, but are not limited to, a Fabric Softening Active (FSA), Fatty Acid, Clay, Perfume, Encapsulated Perfume Delivery Particles, and Silicic Acid Perfume Esters where the FSA is a quaternary ammonium compound, a non-ionic lubricant, or mixtures thereof. Suitable nonionic materials may include C16-C18 glyceride esters, poly(glycerol esters) made from C16-C22 feedstocks, C16-C22 fatty alcohol esters of polyoxyalkylene glycols, C16-C22 fatty alcohol esters of polyoxyalkylene glycols, ethoxylates of long chained alcohols of from 8 to 30 carbon atoms such as the ethoxylates of coconut, palm, tallow alcohols or hydrogenated alcohols with 4 to 40 moles of ethylene oxide, and alkanolamides.

Comparative examples with free PRM (i.e. PRM that is not bound to a silicic acid perfume ester) are also exemplified. Dryer Sheet Compositions are normalized to include the free PRM or PRM delivered as Silicic acid perfume ester or commercially available pro-perfumes with composition described in each example. The fabric care composition is applied as a melt to a polyester non-woven such as spun bond PET using the Handmade Sheet Coating Method or on a larger scale using a transfer process such as slot coating, blade coating, spray coating, kiss rolling, roll coating, reverse roll coating printing, rotogravure coating, printing and other processes for applying the fabric care composition as a melt. The perfume may be combined with the coat mix or sprayed on in a final finishing step of the process.

Table 1.6 shows fabric care composition examples where the fabric care composition is applied to the non-woven wherein the dryer sheet comprises from about 50 wt. % to about 95 wt. %, preferably 60 wt. % to about 90 wt. %, even more preferably from about 65 wt. % to about 85 wt. % of the fabric care composition, by weight of the dryer sheet.

TABLE 1.1
Dryer Sheet Compositions

| | Dryer Sheet Composition Example Weight % (Active) | | | | | | | | | |
|---|---|---|---|---|---|---|---|---|---|---|
| Raw Material | A-1 | B-1 | B-2 | B-3 | B-4 | B-5 | C-1 | C-2 | C-3 | C-4 |
| Non-woven^{a} | 30.0 | 30.8 | 30.7 | 30.6 | 30.5 | 30.2 | 30.3 | 30.0 | 29.7 | 29.4 |
| Fatty Acid^{b} | 24.0 | 20.5 | 20.5 | 20.4 | 20.3 | 20.1 | 20.2 | 20.0 | 19.8 | 19.6 |
| Quaternary | 36.0 | 41.0 | 40.9 | 40.8 | 40.6 | 40.3 | 40.4 | 40.0 | 39.6 | 39.2 |
| Ammonium | | | | | | | | | | |
| Compound^{c} | | | | | | | | | | |
| Bentonite Clay | 5.5 | 5.6 | 5.5 | 5.6 | 5.5 | 5.5 | 5.5 | 5.4 | 5.4 | 5.3 |
| Neat Perfume | 2.1 | 2.1 | 2.1 | 2.1 | 2.0 | 2.1 | 2.1 | 2.0 | 2.0 | 2.0 |
| Encapsulated | — | — | — | — | — | — | 1.5^{d} | 1.6^{d} | 1.6^{d} | 1.6^{d} |
| Perfume^{d} | | | | | | | | | | |
| Silicic Acid | 2.4 | — | 0.3 | 0.5 | 1.2 | 1.8 | — | 1.0 | 1.9 | 2.9 |
| Perfume Ester^{e} | | | | | | | | | | |

TABLE 1.2
Dryer Sheet Compositions (continued)

| | Dryer Sheet Composition Example Weight % (Active) | | | | | | | | |
|---|---|---|---|---|---|---|---|---|---|
| Raw Material | D-1 | D-2 | D-3 | D-4 | E-1 | E-2 | F-1 | F-2 | F-3 |
| Non-woven^{a} | 29.9 | 29.5 | 29.2 | 28.8 | 30.3 | 29.5 | 30.3 | 30.2 | 30.1 |
| Fatty Acid^{b} | 23.9 | 23.6 | 23.3 | 23.0 | 24.2 | 23.6 | 24.3 | 24.1 | 24.1 |
| Quaternary | 35.9 | 35.4 | 35.0 | 34.6 | 36.4 | 35.5 | 36.4 | 36.3 | 36.1 |
| Ammonium | | | | | | | | | |
| Compound^{c} | | | | | | | | | |
| Bentonite Clay | 5.4 | 5.4 | 5.3 | 5.2 | 5.5 | 5.4 | 5.5 | 5.5 | 5.5 |
| Neat Perfume | 2.0 | 2.0 | 2.0 | 2.0 | 2.1 | 2.0 | 2.1 | 2.1 | 21 |
| Encapsulated | 1.6^{f} | 1.6^{f} | 1.6^{f} | 1.6^{f} | 0.8^{g} | 0.8^{g} | — | — | — |
| Perfume oil^{f, g} | | | | | | | | | |
| Silicic Acid | — | 1.2^{e} | 2.3^{a} | 3.5^{e} | — | 2.5^{e} | — | 1.8^{h} | 2.2^{h} |
| Perfume | | | | | | | | | |
| Ester^{e, h} | | | | | | | | | |
| Free PRMⁱ | — | — | — | — | — | — | 1.4ⁱ | — | — |
| Minors | 1.3 | 1.3 | 1.3 | 1.3 | 0.7 | 0.7 | — | — | — |

TABLE 1.3
Dryer Sheet Compositions (continued)

| | Dryer Sheet Composition Example Weight % (Active) | | | | | | | | |
|---|---|---|---|---|---|---|---|---|---|
| Raw Material | G-1 | G-2 | G-3 | G-4 | G-5 | G-6 | H-1 | H-2 | H-3 |
| Non-woven^{a} | 32.8 | 32.5 | 32.9 | 32.6 | 32.3 | 33 | 30.5 | 29.6 | 30.5 |
| Fatty Acid^{b} | 23.6 | 23.4 | 23.7 | 23.4 | 23.2 | 23.7 | 23.1 | 22.4 | 20.3 |
| Quaternary | 35.4 | 35.0 | 35.5 | 35.1 | 34.9 | 35.4 | 43.3 | 42.2 | 40.6 |
| Ammonium | | | | | | | | | |
| Compound^{c} | | | | | | | | | |
| Bentonite Clay | 5.4 | 5.3 | 5.4 | 5.3 | 5.3 | 5.4 | 0 | 2.8 | 5.5 |
| Neat Perfume | 2.2 | 2.2 | 1.5 | 1.5 | 1.5 | 1.5 | 2.1 | 2 | 2.1 |
| Encapsulated | 0.3^{j} | 0.3^{j} | 0.6^{j} | 0.6^{j} | 0.5^{j} | — | — | — | — |
| Perfume Oil^{j} | | | | | | | | | |
| Silicic Acid | — | 1.0 | — | 1.0 | 2.0 | 1.0 | 1.0 | 1.0 | 1.0 |
| Perfume | | | | | | | | | |
| Ester^{e} | | | | | | | | | |
| Minors | 0.26 | 0.26 | 0.52 | 0.52 | 0.43 | — | — | — | — |

TABLE 1.4
Dryer Sheet Compositions (continued)

| | Dryer Sheet Composition Example Weight % (Active) | | | | | | | | | |
|---|---|---|---|---|---|---|---|---|---|---|
| Raw Material | I-1 | I-2 | J-1 | J-2 | J-3 | J-4 | J-5 | J-6 | J-7 | J-8 |
| Non-woven^{a} | 30.8 | 30.2 | 30.8 | 30.2 | 30.1 | 29.5 | 30.1 | 29.5 | 30.1 | 29.5 |
| Fatty Acid^{b} | 17.6 | 17.3 | 30.8 | 30.2 | 5.7 | 5.6 | 10.4 | 10.2 | 46.8 | 46.0 |
| Quaternary | 44.0 | 43.2 | 30.8 | 30.2 | 56.8 | 55.7 | 52.0 | 51.1 | 15.6 | 15.3 |
| Ammonium | | | | | | | | | | |
| Compound^{c} | | | | | | | | | | |
| Bentonite Clay | 5.6 | 5.5 | 5.6 | 5.5 | 5.5 | 5.4 | 5.4 | 5.4 | 5.5 | 5.4 |
| Neat Perfume | 2.1 | 2.1 | 2.1 | 2.1 | 2.1 | 2.0 | 2.1 | 2.0 | 2.1 | 2.0 |
| Silicic Acid | — | 1.8 | — | 1.8 | — | 1.8 | — | 1.8 | — | 1.8 |
| Perfume | | | | | | | | | | |
| Ester^{e} | | | | | | | | | | |

TABLE 1.5
Dryer Sheet Compositions (continued)

| | Dryer Sheet Composition Example Weight % (Active) | | | | | | | |
|---|---|---|---|---|---|---|---|---|
| Raw Material | K-1 | K-2 | K-3 | K-4 | K-5 | K-6 | K-7 | K-8 |
| Non-woven^{a} | 29.8 | 31.9 | 24.1 | 25.0 | 16.1 | 33.1 | 34.3 | 32.1 |
| Fatty Acid^{b} | 20.2 | 23.5 | 26.0 | 26.9 | 29.0 | 23.8 | 23.2 | 23.1 |
| Quaternary | 40.4^{k} | 35.3^{l} | 38.9^{c} | 40.3^{c} | 43.5^{c} | 35.6^{l} | 34.8^{l} | 34.6^{c} |
| Ammonium | | | | | | | | |
| Compound^{c, k, l} | | | | | | | | |
| Bentonite Clay | 5.5 | 5.3 | 5.9 | 6.1 | 6.6 | 5.4 | 5.3 | 5.2 |
| Neat Perfume | 1.9 | 1.5 | 3.5 | 0.7 | 2.5 | 1.6 | 1.1 | 1.3 |
| Encapsulated | — | 1.5^{f} | 0.6^{g} | 0.2^{d} | 1.0^{d} | — | 0.4^{g} | 0.8^{m} |
| Perfume | | | | | | | | |
| Oil^{d, f, g, m} | | | | | | | | |
| Silicic Acid | 2.2 | 1.0 | 0.5 | 0.8 | 0.8 | 0.5 | 1.0 | 2.9 |
| Perfume Ester^{e} | | | | | | | | |
| Minors | 0.5 | — | 0.5 | — | 0.5 | — | — | — |

TABLE 1.6
Fabric Care Compositions

| | Fabric Care Composition Example Weight % (Active) | | | | | | | |
|---|---|---|---|---|---|---|---|---|
| Raw Material | L-1 | L-2 | L-3 | L-4 | L-5 | L-6 | L-7 | L-8 |
| Fatty Acid^{b} | 36.7 | 35.3 | 34.8 | 33.0 | 29.3 | 35.6 | 31.9 | 28.3 |
| Quaternary | 55.0 | 53.0 | 52.2 | 49.5 | 44.0 | 53.4 | 47.9 | 42.4 |
| Ammonium | | | | | | | | |
| Compound^{c} | | | | | | | | |
| Bentonite Clay | 8.3 | 8.0 | 7.9 | 7.5 | 6.6 | 8.0 | 7.2 | 6.4 |
| Neat Perfume | — | — | — | — | — | 3.0 | 3.0 | 3.0 |
| Silicic Acid | — | 3.7 | 5.1 | 10.0 | 20.0 | — | 10.0 | 19.9 |
| Perfume Ester^{e} | | | | | | | | |

a) Spunbond PET non-woven available under the tradename Berry White
b) TRT T-1855, C₁₈, IV O (fully saturated) Stearic acid available from Twin Rivers Technologies, Quincy MA
c) C16-C18 Unsaturated DEEHMAMS (Diethyl Ester Hydroxyethyl Methyl Ammonium Methyl Sulphate) with IV 20 available from Evonik (Janesville, WI).
d) Encapsulated perfume oil 1 based on melamine formaldehyde delivery particles with 31% activity available from Encapsys, LLC (Portage, WI).
e) Silicic acid ester made from Geraniol (79% activity made according to the process below) f) Encapsulated Perfume Oil 2 based on cross-linked poly(acrylate) delivery particles with 25.5% activity available from Encapsys, LLC (Portage, WI).
g) Encapsulated Perfume Oil 3 based on cross-linked poly(acrylate) delivery particles with 25.9% activity available from Encapsys, LLC (Portage, WI).
h) Silicic acid ester made from Cinnamyl alcohol (77.8% activity), Phenyl ethyl alcohol (77% activity), undecavertol (63.1% activity), made according to the process below) specified in Example 7.
i) Free PRM Phenyl Ethyl Alcohol, Cinnamyl alcohol, undecavertol specified in Example 7.
j) A 1:1 blend of Encapsulated Perfume Oil 3 and Encapsulated Perfume Oil 2 delivery particles.
k) C16-C18 Unsaturated DEEHMAMS (Diethyl Ester Hydroxyethyl Methyl Ammonium Methyl Sulphate) with IV 42 available from Evonik (Janesville, WI).
l) Fully saturated C16-C18 DEEHMAMS, IV 0 available from Stepan (Northbrook, IL).
m) Encapsulated Perfume Oil 4 based on melamine formaldehyde delivery particles with 31% activity available from Encapsys, LLC (Portage, WI).

Preparation of Silicic Acid Perfume Esters. Silicic acid perfume esters are synthesized via a trans-esterification reaction of ethyl polysilicate with a PRM alcohol using sodium methoxide as a catalyst with distillation of resulting ethanol. A representative procedure for silicic acid geraniol ester is given that can be reapplied to other perfume alcohols. To a flask, fitted with a condenser and Dean Stark trap is charged 40 g of ethyl polysilicate (such as Dynasylan® Silbond® 40 ex Evonik Industries), 85 g of geraniol, and 341 μL of sodium methoxide solution at 25 wt. % in methanol. The reaction is heated with stirring to a set point of 80 ° C and is placed under a vacuum of 500 mbar. During the reaction, pressure is progressively decreased from 500 mbar to 80 mbars and temperature is progressively increased to 130 ° C to remove alcohol generated via distillation. When no more alcohol is removed, the system is cooled to room temperature. The resulting product is confirmed through ²⁹Si NMR to be a silicic acid geraniol ester with about 96% of polymer with the structure Si(ORgeranyl)_{1.86} (ORethyl)_{0.39} O_{(1.75)/2} and about 4% of free geraniol. The molar ratio of (ORgeranyl)_{1.86} to (ORethyl)_{0.39} is calculated by adding the molar amounts of each (1.86+0.39=2.25), and taking the molar amount of (ORgeranyl)_{1.86} and dividing by the total (1.86/2.25-0.8267), which corresponds to a mol ratio of C₁₀ substituted alkoxy moieties (ORgeranyl) to the C₁₋₆ alkoxy moieties (ORethyl) in the silicic acid perfume ester is about 5:1. Therefore, the ratio of bound perfume moieties to unreacted bound C₁-C₆ alkoxy moieties is about 5:1.

In examples, the silicic acid perfume ester may include from 90% to 99%, from 90% to 98%, from 90% to 97%, from 90% to 96%, from 90% to 95%, from 90% to 94%, from 90% to 92%, from 92% to 99%, from 92% to 98%, from 92% to 97%, from 92% to 96%, from 92% to 95%, from 92% to 94%, from 94% to 99%, from 94% to 98%, from 94% to 97%, from 94% to 96%, from 94% to 95%, from 95% to 99%, from 95% to 98%, from 95% to 97%, from 95% to 96%, from 96% to 99%, from 96% to 98%, from 96% to 97%, from 96% to 96%, from 97% to 99%, from 97% to 98%, from 98% to 99%, or any combination of ranges created thereby, of polymer. In examples, the silicic acid perfume ester may include from 1% to 10%, from 1% to 8%, from 1% to 7%, from 1% to 6%, from 1% to 5%, from 1% to 4%, from 1% to 3%, from 1% to 2%, from 2% to 10%, from 2% to 8%, from 2% to 7%, from 2% to 6%, from 2% to 5%, from 2% to 4%, from 2% to 3%, from 3% to 10%, from 3% to 8%, from 3% to 7%, from 3% to 6%, from 3% to 5%, from 3% to 4%, from 4% to 10%, from 4% to 8%, from 4% to 7%, from 4% to 6%, from 4% to 5%, from 5% to 10%, from 5% to 8%, from 5% to 7%, from 5% to 6%, from 6% to 10%, from 6% to 8%, from 6% to 7%, from 7% to 10%, from 7% to 8%, from 8% to 10%, from 3.5% to 4.5%, or any combination of ranges created thereby, of free alcohol-based perfume. The free alcohol-based perfume may include geraniol.

### Example 1. Dry Fabric Odor is Improved in Fabrics Treated with Dryer Sheet Compositions Containing Silicic Acid Geraniol Ester Compared to Free Geraniol and HaloScent-G® Pro-Perfume

Dryer sheet compositions containing silicic acid perfume esters deliver improved freshness benefits to fabrics during tumble drying. Dryer sheets are typically formulated with free perfume oil, however most of the perfume is lost through the dryer vent due to volatilization during the drying process. When perfume is lost through the drying process, perfume is not deposited on fabric, and consumers are disappointed by the lack of freshness after using a dryer sheet. Pro-perfumes that covalently bind one equivalent of PRM to another molecule can protect a PRM from being volatilized during drying. However, conventional pro-perfumes such as the hexadecenoic acid ester of geraniol commercially available under the tradename Haloscent-G® (ex Firmenich), do not effectively deliver perfume through a dryer sheet. Silicic acid geraniol esters efficiently deliver perfume to the fabric since each silicic acid geraniol ester delivers 10 equivalents of geraniol per mole versus the 1 equivalent delivered by hexadecenoic acid ester of geraniol or free geraniol. Without wishing to be bound by theory, the geraniol and the neat perfume formulated into the dryer sheet composition adsorbs onto the hydrophobic portion of the silicic acid perfume ester protecting the perfume thereby preventing loss due to volatility in the drying process resulting in higher freshness on fabric.

Table 1A shows dryer sheet compositions made with different geraniol delivery routes of Silicic Acid Geraniol Ester (A-1) and Haloscent-G® (A-2) compared to free geraniol (A-3) and no additional free geraniol or geraniol pro-perfume (comparative example A-0). The dryer sheet compositions in Table 1A are normalized to deliver the same equivalents of neat perfume and geraniol per sheet by adjusting the level of coat mix to make a comparison between the efficiency of the different delivery means (Table 1B).

TABLE 1A
Dryer Sheet Compositions made with Silicic Acid Geraniol
Ester, HaloScent-G ® or Free Geraniol

| | Dryer Sheet Composition Example Weight % (Active) | | | |
|---|---|---|---|---|
| Raw Material | A-1 | A-2 | A-3 | A-0 |
| Non-woven^{a} | 30.0 | 28.2 | 30.3 | 30.8 |
| Fatty Acid^{b} | 24.0 | 22.5 | 24.3 | 24.6 |
| Quaternary | 36.0 | 33.8 | 36.4 | 36.9 |
| Ammonium | | | | |
| Compound^{c} | | | | |
| Bentonite Clay | 5.4 | 5.1 | 5.5 | 5.6 |
| Neat Perfume | 2.0 | 1.9 | 2.1 | 2.1 |
| Geraniol | 2.4^{d} | 8.4^{e} | none | none |
| Pro-perfume | | | | |
| Free Geraniol | none | none | 1.4 | none |

^{a}Spunbond PET non-woven available under the tradename Berry White
^{b}TRT T-1855, C18, IV 0 fully saturated Stearic acid available from Twin Rivers Technologies, Quincy MA
^{c}C16-C18 Unsaturated DEEHMAMS (Diethyl Ester Hydroxyethyl Methyl Ammonium Methyl Sulphate) with IV 20 available from Evonik (Janesville, WI)
^{d}Silicic Acid Geraniol ester pro-perfume, made according to the process previously described
^{e}Hexadecanoic acid ester of Geraniol [(2E)-3,7-dimethylocta-2,6-dien-1-yl available under the tradename HaloScent-G ® at 39% activity from Firmenich (Geneva, Switzerland).

Table 1B shows that compositions A-1, A-2 and A-3 deliver the same number of equivalents of geraniol per dryer sheet. Silicic acid geraniol ester delivers 10 equivalents of covalently-bound geraniol compared to 1 equivalent for HaloScent-G® and free geraniol. Since the molecular weight of the pro-perfumes is higher than free geraniol, the relative percentage of fatty acid, quaternary ammonium compound, bentonite clay and neat perfume oil were adjusted to deliver the same number of equivalents of geraniol. Compositions were used to prepare fabrics according the Fabric Treatment Method.

TABLE 1B
Compositions A-1, A-2, A-3 Deliver the
Same Equivalents of Geraniol Per Sheet

| Example Composition | A-1 | A-2 | A-3 |
|---|---|---|---|
| Geraniol delivery form | Silicic Acid | HaloScent- | Free |
| | Geraniol Ester | G ® | Geraniol |
| % geraniol (free | 2.4% | 8.4% | 1.4% |
| or pro-perfume) | | | |
| mg/sheet (active) | 39 | 76 | 30 |
| Molecular weight (g/mol) | 1820.5 | 392.65 | 153.25 |
| mmol/sheet (active) | 0.02 | 0.2 | 0.2 |
| eq Geraniol/mol | 10 | 1 | 1 |
| meq Geraniol/sheet | 0.2 | 0.2 | 0.2 |

Table 1C shows Dry Fabric Odor (DFO) from fabrics treated with dryer sheets made from Silicic acid geraniol esters (Inventive 1.1) compared to the commercially available pro-perfume HaloScent-G® (ex Firmenich, Comparative Example 1.2) and Free Geraniol (Comparative Example 1.3). Dry Fabric Odor (DFO) is olfactively graded by trained perfumers on a Primavera scale of 0-100 where a higher score is a higher DFO intensity. Comparative Examples 1.2 and 1.3 each have a 5 point lower DFO after initial 4 h grading than the Silicic acid geraniol ester in Inventive Example 1.1 which is a noticeable difference.

After 14 days of storage at controlled humidity (50% RH), this difference is even larger with Inventive Example 1.1 having the highest DFO of 40 and Comparative Example 1.3 having 12.5 points lower DFO, and Comparative Example 1.2 having 7.5 points lower DFO than Inventive Example 1.1. Table 1C also shows that Inventive Example 1.1 better retains the DFO over time than Comparative Examples 1.2 and 1.3 since Example 1.1 has the smallest loss in DFO from initial assessment at 4 h to assessment after 14 days of storage of 7.5 points. Comparative Example 1.3 has a 15-point loss and Comparative Example 1.2 has a 10-point loss showing that the Silicic Acid Geraniol Ester has higher dry fabric odor intensity than free perfume oil or HaloScent-G® pro-perfume that that is better maintained over time.

TABLE 1C
Dry Fabric Odor Perfumer Grading of Treated Fabrics

| | | | | | | | DFO |
|---|---|---|---|---|---|---|---|
| | | Geraniol | | Delta vs | | Delta vs | Change |
| | | Delivery | 4 h | Ex. 1.3 | 14 d | Ex. 1.3 | Over Time |
| Example | Composition | Form | DFO^{a} | after 4 h | DFO^{a} | after 14 d | (14 d − 4 h) |
| 1.1 | A-1 | Silicic Acid | 47.5 | REF | 40 | REF | 7.5 pt loss |
| (Inv) | | Geraniol | | | | | after 14 d |
| | | ester | | | | | |
| 1.2 | A-2 | Haloscent | 42.5 | −5 | 32.5 | −7.5 | 10 pt loss |
| (Comp) | | G ® Pro- | | | | | after 14 d |
| | | perfume | | | | | |
| 1.3 | A-3 | Free | 42.5 | −5 | 27.5 | −12.5 | 15 pt loss |
| (Comp) | | Geraniol | | | | | after 14 d |

^{a}Fabrics equilibrated at 50% Relative Humidity before assessment.

Fabrics treated with dryer sheets may have a DFO change over time (from 4 hours to 14 days) of less than 15 points, less than 10 points, less than 9 points, less than 8.5 points, or less than 8 points. Fabrics treated with dryer sheets may have a DFO change over time (from 4 hours to 14 days) of from 1 to 14 points, from 1 to 9 points, from 1 to 8.5 points, from 1 to 8 points, from 3 to 14 points, from 3 to 9 points, from 3 to 8.5 points, from 3 to 8 points, from 5 to 14 points, from 5 to 9 points, from 5 to 8.5 points, from 5 to 8 points, from 6 to 14 points, from 6 to 9 points, from 6 to 8.5 points, from 6 to 8 points, from 7 to 14 points, from 7 to 9 points, from 7 to 8.5 points, from 7 to 8 points, or any combination of ranges created thereby.

### Example 2. Dry Fabric Headspace Is Higher in Dryer Sheet Compositions Containing Silicic Acid Geraniol Ester Compared to Free Geraniol and HaloScent-G®

Consumers desire for clothes to smell fresh over time under different environmental conditions including dry and humid conditions. Moisture releases perfume from fabric, however when environmental conditions are dry with low relative humidity, less perfume is released from fabrics and consumers do not experience sufficient freshness release on their clothes. There remains a need to deliver perfume consistently over time throughout the day or even in storage. Table 2A shows dry fabric headspace for fabrics treated with dryer sheets and equilibrated at 15% and 50% relative humidity for 4 h and 14d reported in nmol/L where a higher number is a higher concentration of perfume in the headspace.

Table 2A shows that fabrics treated with dryer sheets containing silicic acid geraniol ester in Inventive Example 2.1 release at least 10× more perfume than HaloScent-G® in Comparative Example 2.2 and free geraniol in Comparative Example 2.3 after being equilibrated at 15% and 50% relative humidity for 4 h and 14 days. After 4 h/15% RH, Comparative Examples 2.2 and 2.2 have 3 and 5 nmol/L, respectively which is at least 10× less than the Inventive Example 2.1 that has 51 nmol/L dry fabric headspace. After 14d at 15% RH, Comparative Examples 2.2 and 2.3 show increases of +4 nmol/L and +3 nmol/L, respectively which is an order of magnitude lower than the increase observed in Inventive Example 2.1 of +25 nmol/L. This data shows that even at low relative humidity, the silicic acid geraniol esters release a higher amount of the PRM than free geraniol or a typical pro-perfume.

Perfume release after storage at 50% relative humidity is higher than storage at 15% relative humidity due to moisture release of perfume from the fabric. The silicic acid geraniol ester Example 2.1 has higher DFHS release than the comparative examples 2.2 and 2.3 due to geraniol hydrolysis from the backbone. Table 2A shows that the relative increase in DFHS after storage at 14d at 50% RH compared to 14d at 15% RH for Example 2.1 is 3× and higher than the relative increase for Example 2.2 that is 1.7× and Example 2.3 that is 2.2×. This data shows that the silicic acid perfume ester having multiple equivalents of PRM that can be released by moisture is a more effective way to deliver PRM than free geraniol or known pro-perfumes such as HaloScent-G® since the silicic acid ester prevents the geraniol from being lost during the drying process.

TABLE 2A

| | | | Dry Fabric Headspace (DFHS) of Fabrics | | | | | | |
|---|---|---|---|---|---|---|---|---|---|
| | | | Equilibrated at 15% and 50% RH | | | | | | Rel Increase |
| | | Geraniol | 15% RH (nmol/ L) | | | 50% RH (nmol/ L) | | | 50% RH/ 15% |
| | | Delivery | | | Δ 14 d − | | | Δ 14 d − | RH after 14 d |
| Example | Composition | Form | 4 h | 14 d | 4 h | 4 h | 14 d | 4 h | storage |
| 2.1 | A-1 | Silicic | 51 | 76 | +25 | 93 | 231 | +138 | 3.0x |
| (Inv) | | Acid | | | | | | | |
| | | Geraniol | | | | | | | |
| | | ester | | | | | | | |
| 2.2 | A-2 | Haloscent | 3 | 7 | +4 | 5 | 12 | +7 | 1.7x |
| (Comp) | | G ® | | | | | | | |
| 2.3 | A-3 | Free | 5 | 8 | +3 | 10 | 18 | +8 | 2.2x |
| (Comp) | | Geraniol | | | | | | | |

Fabrics treated with dryer sheets may exhibit a DFHS equilibrated at 15% RH change over time (from 4 hours to 14 days) of an increase greater than 3 nmol/L, greater than 4 nmol/L, greater than 4.5 nmol/L, greater than 5 nmol/L, greater than 7 nmol/L, greater than 10 nmol/L, greater than 13 nmol/L, greater than 15 nmol/L, greater than 18 nmol/L, greater than 20 nmol/L, greater than 22 nmol/L, or greater than 24 nmol/L. Fabrics treated with dryer sheets may exhibit a DFHS equilibrated at 15% RH change over time (from 4 hours to 14 days) of an increase from 3.5 to 50 nmol/L, from 3.5 to 40 nmol/L, from 3.5 to 35 nmol/L, from 3.5 to 30 nmol/L, from 4.5 to 50 nmol/L, from 4.5 to 40 nmol/L, from 4.5 to 35 nmol/L, from 4.5 to 30 nmol/L, from 5 to 50 nmol/L, from 5 to 40 nmol/L, from 5 to 35 nmol/L, from 5 to 30 nmol/L, from 7 to 50 nmol/L, from 7 to 40 nmol/L, from 7 to 35 nmol/L, from 7 to 30 nmol/L, from 10 to 50 nmol/L, from 10 to 40 nmol/L, from 10 to 35 nmol/L, from 10 to 30 nmol/L, from 12 to 50 nmol/L, from 12 to 40 nmol/L, from 12 to 35 nmol/L, from 12 to 30 nmol/L, from 15 to 50 nmol/L, from 15 to 40 nmol/L, from 15 to 35 nmol/L, from 15 to 30 nmol/L, from 18 to 50 nmol/L, from 18 to 40 nmol/L, from 18 to 35 nmol/L, from 18 to 30 nmol/L, from 20 to 50 nmol/L, from 20 to 40 nmol/L, from 20 to 35 nmol/L, from 20 to 30 nmol/L, from 22 to 50 nmol/L, from 22 to 40 nmol/L, from 22 to 35 nmol/L, from 22 to 30 nmol/L, from 24 to 50 nmol/L, from 24 to 40 nmol/L, from 24 to 35 nmol/L, from 24 to 30 nmol/L, or any combination of ranges created thereby.

Fabrics treated with dryer sheets may exhibit a DFHS equilibrated at 50% RH change over time (from 4 hours to 14 days) of an increase greater 7 nmol/L, greater than 8 nmol/L, greater than 10 nmol/L, greater than 20 nmol/L, greater than 30 nmol/L, greater than 50 nmol/L, greater than 70 nmol/L, greater than 90 nmol/L, greater than 100 nmol/L, greater than 110 nmol/L, greater than 120 nmol/L, or greater than 130 nmol/L. Fabrics treated with dryer sheets may exhibit a DFHS equilibrated at 50% RH change over time (from 4 hours to 14 days) of an increase from 7.5 to 300 nmol/L, from 7.5 to 200 nmol/L, from 7.5 to 175 nmol/L, from 7.5 to 150 nmol/L, from 8.5 to 300 nmol/L, from 8.5 to 200 nmol/L, from 8.5 to 175 nmol/L, from 8.5 to 150 nmol/L, from 10 to 300 nmol/L, from 10 to 200 nmol/L, from 10 to 175 nmol/L, from 10 to 150 nmol/L, from 20 to 300 nmol/L, from 20 to 200 nmol/L, from 20 to 175 nmol/L, from 20 to 150 nmol/L, from 30 to 300 nmol/L, from 30 to 200 nmol/L, from 30 to 175 nmol/L, from 30 to 150 nmol/L, from 50 to 300 nmol/L, from 50 to 500 nmol/L, from 50 to 175 nmol/L, from 50 to 150 nmol/L, from 70 to 300 nmol/L, from 70 to 200 nmol/L, from 70 to 175 nmol/L, from 70 to 150 nmol/L, from 90 to 300 nmol/L, from 90 to 200 nmol/L, from 90 to 175 nmol/L, from 90 to 150 nmol/L, from 100 to 300 nmol/L, from 100 to 200 nmol/L, from 100 to 175 nmol/L, from 100 to 150 nmol/L, from 110 to 300 nmol/L, from 110 to 200 nmol/L, from 110 to 175 nmol/L, from 110 to 150 nmol/L, from 120 to 300 nmol/L, from 120 to 200 nmol/L, from 120 to 175 nmol/L, from 120 to 150 nmol/L, or any combination of ranges created thereby.

Fabrics treated with dryer sheets may exhibit a relative increase in DFHS after storage at 14d at 50% RH compared to 14d at 15% RH of greater than 1.8×, greater than 2.3×, greater than 2.5×, greater than 2.7×, or greater than 2.9×. Fabrics treated with dryer sheets may exhibit a relative increase in DFHS after storage at 14d at 50% RH compared to 14d at 15% RH of from 1.8× to 10×, from 1.8× to 5×, from 1.8× to 4×, from 1.8× to 3.5×, from 2.3× to 10×, from 2.3× to 5×, from 2.3× to 4×, from 2.3× to 3.5×, from 2.5× to 10×, from 2.5× to 5×, from 2.5× to 4×, from 2.5× to 3.5×, from 2.7× to 10×, from 2.7× to 5×, from 2.7× to 4×, from 2.7× to 3.5×, or any combination of ranges created thereby.

The silicic acid ester also protects full perfume in the dryer sheet composition from being lost during the drying process. Table 2B shows the DFHS for the neat perfume excluding geraniol and geraniol-related molecules such as geranial, myrcene, neral, nerol, and ocimene from the full perfume that is formulated in the composition. Table 2B shows that Example 2.1 has 2× more DFHS for the neat perfume than Comparative Example 2.4 reference containing full perfume only (i.e. no added geraniol or geraniol delivery active) and the Comparative Examples 2.2 and 2.3 have about the same DFHS as the reference with 0.9× and 0.75×, respectively. This data shows that the Comparative Examples 2.2 and 2.3 do not have an impact on the DFHS of the full perfume whereas the Inventive Example 2.1 has higher neat perfume on fabrics because the silicic acid ester can protect other PRM in the full perfume not covalently bound to the silicic acid ester PRM by adsorbing onto the silicic acid geraniol ester pro-perfume.

TABLE 2B

| | | | | DFHS excluding | Rel Increase |
|---|---|---|---|---|---|
| | | | Total | Geraniol and | in PRM not |
| | Dryer Sheet | Geraniol | DFHS | Geraniol-related | including |
| Example | Composition | Delivery Form | (nmol/L) | products (nmol/L) | Geraniol |
| 2.1 | A-1 | Silicic Acid | 231 | 24 | 2x |
| (Inv) | | Geraniol ester | | | |
| 2.2 | A-2 | Haloscent G ® | 12 | 11 | Same as REF |
| (Comp) | | | | | (0.9x) |
| 2.3 | A-3 | Free Geraniol | 18 | 9 | Same as REF |
| (Comp) | | | | | (0.75x) |
| 2.4 | A-4 | none | 12 | 12 | REF |
| (comp) | | | | | |

The dryer sheet composition of the present disclosure may have a relative increase in PRM not including geraniol of greater than 1.1×, greater than 1.3×, greater than 1.5×, greater than 1.7×, greater than 1.9×, less than 10×, less than 7×, less than 5×, less than 4×, less than 3×, or any combination of ranges created thereby, when compared to a dryer sheet composition that does not include silicic acid geraniol ester.

The dryer sheet composition may have a DFHS excluding geraniol and geraniol-related products of greater than 10 nmol/L, greater than 11 nmol/L, greater than 12 nmol/L, greater than 13 nmol/L, greater than 15 nmol/L, greater than 18 nmol/L, greater than 20 nmol/L, greater than 22 nmol/L, less than 50 nmol/L, less than 45 nmol/L, less than 40 nmol/L, less than 35 nmol/L, less than 30 nmol/L, less than 25 nmol/L, or any combination of ranges created thereby.

### Example 3. Silicic Acid Geraniol Ester Increases Delivery of Other PRM

Full perfumes are complex formulations with many different PRM that are formulated into laundry products to deliver scent at different consumer touchpoints. Perfumes are designed to include top, middle and bottom notes to deliver a well-balanced character that can be olfactively detected. Full perfumes are formulated with many PRM across a broad concentration range depending on the properties of the PRM such as scent character, volatility, odor detection threshold (ODT), and cost. Very low levels of PRM may be included to balance character especially if they are an impactful PRM that is volatile and readily detected, however these types of PRM may only be detected at the neat product touchpoint because these PRM do not always survive the laundry process. In dryer sheets, full perfume contributes to the neat product odor to deliver a noticeable scent in the package at the store or in storage in the home. However, during tumble drying, many PRM can be volatilized and diffuse through the dryer vent rather than depositing on fabric. This is problematic since the scent of the neat product odor may not be consistent with the scent on treated fabrics after drying. Therefore, there remains a need to maintain volatile PRM in the dryer so that they deliver scent benefits to fabrics.

Surprisingly, Silicic Acid Geraniol Esters increase delivery of other perfume raw materials (PRM) present in the neat perfume oil in the dryer sheet composition. Table 3A shows a 2.5× increase in DFHS of PRM other than Geraniol and Geraniol-related compounds (geranial, myrcene, neral, nerol, and ocimene) when silicic acid geraniol ester is present. Diffusion into the headspace is related to vapor pressure where low boiling point liquids have high vapor pressures and more readily diffuse into the headspace for sensory detection, however these PRM are more likely to be lost during the drying process.

TABLE 3A
Increase in Neat Perfume PRM with Silicic Acid Geraniol Ester

| | | Silicic Acid | | | |
|---|---|---|---|---|---|
| | | Geraniol | | DFHS excluding | |
| | | Ester wt. % | Total | Geraniol and | Increase in PRM |
| | Dryer Sheet | in Dryer | DFHS | Geraniol-related | Delivered by Silicic |
| Example | Composition | Sheets | (nmol/L) | products (nmol/L) | acid perfume ester |
| 3.1 | B-1 | 0 | 2 | 2 | REF |
| (Comp) | | | | | |
| 3.2 | B-4 | 1.2% | 25 | 5 | 2.5X |
| (Inv) | | | | | |

The dryer sheet composition of the present disclosure may have a relative increase in PRM delivered by silicic acid perfume ester of greater than 1.1×, greater than 1.3×, greater than 1.5×, greater than 1.7×, greater than 1.9×, less than 10×, less than 7×, less than 5×, less than 4×, less than 3×, or any combination of ranges created thereby, when compared to a dryer sheet composition that does not include silicic acid perfume ester.

The dryer sheet composition may have a DFHS excluding geraniol and geraniol-related products of greater than 2 nmol/L, greater than 3 nmol/L, greater than 4 nmol/L, less than 20 nmol/L, less than 15 nmol/L, less than 10 nmol/L, less than 8 nmol/L, less than 6 nmol/L, or any combination of ranges created thereby.

The dryer sheet composition may have a total DFHS of greater than 2 nmol/L, greater than 3 nmol/L, greater than 4 nmol/L, greater than 5 nmol/L, greater than 8 nmol/L, greater than 10 nmol/L, greater than 12 nmol/L, greater than 15 nmol/L, greater than 18 nmol/L, greater than 20 nmol/L, greater than 23 nmol/L, less than 60 nmol/L, less than 50 nmol/L, less than 40 nmol/L, less than 35 nmol/L, less than 30 nmol/L, or any combination of ranges created thereby.

Table 3B shows the DFHS improvement in PRM having a boiling point of 300 ° C or below, which represents the PRM that are most likely to be partially or fully lost due to evaporation during the drying process. Table 3B also shows that some PRM (e.g. citronellol, linalool, linalyl acetate, and para cymene) are not even detected in comparative Example 3.1, whereas these PRM are detected with the silicic acid geraniol ester in Example 3.2. Table 3B shows 30% to 430% relative increase in PRM when Silicic acid Geraniol ester is used compared to the reference without Silicic acid ester. This data shows that Silicic acid esters deliver PRM to fabrics that are normally lost during tumble drying.

TABLE 3B
Relative DFHS Increase of PRM Typically Lost in Tumble Drying

| | | | Fabric DFHS (nmol/L) | | |
|---|---|---|---|---|---|
| Perfume Raw | | Bp | after 7 d/50% RH | | REL |
| Material | CAS | (°C) | Ex. 3.1 | Ex. 3.2 | Increase |
| CITRONELLOL | 106-22-9 | 217 | 0 | 0.018 | N/A |
| FRUTENE | 68912-13-0 | 294 | 0.003 | 0.013 | 4.3x |
| HABANOLIDE | 111879-80-2 | 300 | 0.221 | 0.360 | 1.6x |
| HELIOTROPIN | 120-57-0 | 273 | 0.007 | 0.013 | 1.9x |
| LINALOOL | 78-70-6 | 204 | 0 | 0.060 | N/A |
| LINALYL ACETATE | 51685-40-6 | 218 | 0 | 1.874 | N/A |
| P.T.BUCINAL | 80-54-6 | 289 | 0.154 | 0.220 | 1.4x |
| PARA CYMENE | 99-87-6 | 274 | 0 | 0.040 | N/A |
| PHENYL HEXANOL | 55066-48-3 | 287 | 0.067 | 0.091 | 1.4x |
| PYRANOL | 63500-71-0 | 237 | 0.108 | 0.149 | 1.4x |
| UNDECALACTONE | 104-67-6 | 228 | 0.188 | 0.247 | 1.3x |

The Relative DFHS Increase of PRM Typically Lost in Tumble Drying may increase by greater than 1.1×, greater than 1.2×, greater than 1.3×, greater than 1.4×, greater than 1.5×, greater than 1.7×, greater than 1.8×, greater than 2×, greater than 2.5×, greater than 3×, greater than 3.5×, greater than 4×, less than 20×, less than 10×, less than 8×, less than 6×, less than 5×, or any combination of ranges created thereby.

### Example 4. Increasing Silicic Acid Geraniol Ester Level in Dryer Sheets Increases Freshness Benefit

Table 4A shows that increasing the level of Silicic acid geraniol ester in the fabric care composition that is coated onto the dryer sheet not only increases the freshness intensity but can impact the perceived character on the treated fabric. Table 4A shows that the total DFHS increases from 2 nmol/L in comparative Example 4.0 that does not contain silicic acid geraniol ester to 7 nmol/L in Example 4.1 to 12.2 nmol/L in Example 4.2, and to 25.4 nmol/L in Example 4.3. DFHS from the neat perfume oil also increases as shown in the DHFS excluding geraniol and geraniol-related materials (geranial, myrcene neral, nerol, and ocimene) from 2.0 nmol/L in Comparative example 4.0 to 4.7 nmol/L in Comparative Example 4.3.

Table 4A also shows that olfactive intensity is increased as the amount of silicic acid ester increases and the 2w DFO increases from 37.5 in Comparative Example 4.0 with no silicic acid ester to 5 points higher in Example 4.1, 7.5 points higher in Example 4.2 and 12.5 points higher in Example 4.3. The balance between the geraniol that is released from the silicic acid ester and the neat perfume contributes to the perceived character and character differences can be detected as the silicic acid ester is changed. This data shows that silicic acid ester delivery of the covalently attached PRM can be designed to complement the additional PRM delivered by silicic acid ester based on the amount of silicic acid ester used.

TABLE 4A

| | | | DFHS (nmol/ L) | | | | |
|---|---|---|---|---|---|---|---|
| | | | | Excluding | | | |
| | | Silicic Acid | | Geraniol + | Dry Fabric Odor | | |
| | | Geraniol Ester | | Geraniol- | (0-100 scale) | | |
| | Dryer Sheet | Active Wt. % in | | related | 2 w | Increase | Character |
| Example | Composition | Dryer Sheet | Total | PRM | DFO | vs REF | Shift |
| 4.0 | B-1 | none | 2.0 | 2.0 | 37.5 | REF | REF |
| 4.1 | B-2 | 0.3% | 7.0 | 2.8 | 42.5 | +5 | Rose + |
| | | | | | | | Citronellol |
| 4.2 | B-3 | 0.5% | 12.2 | 3.1 | 45.0 | +7.5 | Rose |
| 4.3 | B-4 | 1.2% | 25.4 | 4.7 | 50.0 | +12.5 | Strong Rose |

The dryer sheet composition of the present disclosure may exhibit a total DFHS of greater than 2 nmol/L, greater than 3 nmol/L, greater than 4 nmol/L, greater than 5 nmol/L, greater than 6 nmol/L, greater than 7 nmol/L, greater than 10 nmol/L, greater than 12 nmol/L, greater than 15 nmol/L, greater than 18 nmol/L, greater than 20 nmol/L, greater than 23 nmol/L, less than 50 nmol/L, less than 40 nmol/L, less than 35 nmol/L, less than 30 nmol/L, less than 25 nmol/L, less than 23 nmol/L, less than 20 nmol/L, less than 18 nmol/L, less than 15 nmol/L, less than 12 nmol/L, less than 10 nmol/L, less than 8 nmol/L, or any combination of ranges created thereby.

The dryer sheet composition of the present disclosure may exhibit a total DFHS Excluding Geraniol+Geraniol-related PRM of greater than 2 nmol/L, greater than 2.5 nmol/L, greater than 3 nmol/L, greater than 3.5 nmol/L, greater than 4 nmol/L, greater than 4.5 nmol/L, less than 20 nmol/L, less than 18 nmol/L, less than 15 nmol/L, less than 12 nmol/L, less than 10 nmol/L, less than 8 nmol/L, less than 6 nmol/L, less than 5 nmol/L, less than 4 nmol/L, less than 3.5 nmol/L, less than 3 nmol/L, or any combination of ranges created thereby.

### Example 5. Benefit of Silicic Acid Geraniol Ester with Neat and Encapsulated Perfume

Dryer sheet compositions containing silicic acid perfume esters with neat and encapsulated perfume in perfume delivery particles improved freshness benefits to the fabric during tumble drying. Dryer sheets can be formulated with neat perfume only as described in Examples 1-4, or dryer sheets may be formulated with neat and encapsulated perfume as shown in Example 5. Encapsulated perfume in perfume delivery particles is known to improve perfume deposition in the wash and rinse stage of the laundry process, however encapsulated perfume can have low deposition efficiency when perfume delivery particles are in a dryer sheet. Perfume can be lost during the dryer sheet making process during production as well as during the drying process in tumble dryers, therefore there remains a need to maximize efficiency of dryer sheets formulated with neat and encapsulated perfume. Table 5A shows that as the amount of Silicic Acid Geraniol Ester is increased in the dryer sheet, the DFHS increases linearly from 5×-15× as compared to dryer sheets without Silicic acid geraniol ester.

TABLE 5A

| | | Silicic Acid | | |
|---|---|---|---|---|
| | Dryer Sheet | Geraniol Ester | DFHS | DFHS Relative |
| Example | Composition | Dryer Sheet wt % | (nmol/L) | Increase |
| 5.1 | C-1 | 0 | 5.3 | REF for |
| | | | | Ex. 5.2-5.4 |
| 5.2 | C-2 | 1.0% | 34.4 | 6x |
| 5.3 | C-3 | 1.9% | 51.4 | 10x |
| 5.4 | C-4 | 2.9% | 78.5 | 15x |
| 5.5 | D-1 | 0 | 5.3 | REF for |
| | | | | Ex. 5.6-5.8 |
| 5.6 | D-2 | 1.2% | 27.6 | 5x |
| 5.7 | D-3 | 2.3% | 45.8 | 9x |
| 5.8 | D-4 | 3.5% | 65.3 | 12x |

### Example 6. Dryer Sheets with Silicic Acid Geraniol Ester Release More Scent from a Box of Dryer Sheets

It is desirable for consumers to experience freshness from a box of opened or unopened dryer sheets to freshen the laundry storage area. Consumers may even use dryer sheets to freshen clothing storage areas such as closets, drawers, seasonal storage containers, or to keep luggage, clothing bags, and backpacks smelling fresh. Perfume release from a box of dryer sheets may be lower than intended if perfume is evaporated during the making process, or dissatisfying to the consumers if the perfume is not released from the dryer sheet coating onto the clothing. Thus, improving scent from a dryer sheet or a box of dryer sheets remains an unmet need.

Table 6 shows the results from measuring the headspace (HS) from an opened box of dryer sheets after 10d and 21d of storage at ambient conditions. Table 6 shows 3× more Total Headspace Release from the box of dryer sheets prepared with silicic acid geraniol ester Example 6.2 than the Comparative Example 6.1 after 10d of storage at ambient. After 21d of being open at ambient conditions, Example 6.2 has 5×more headspace release than Comparative Example 6.1 after 21d. This data shows that the silicic acid geraniol ester contributes more intensity to room bloom.

Table 6 also shows that the Headspace Release of other PRM excluding Geraniol and geraniol-related compounds is 1.4×higher in Example 6.2 than the Comparative Example 6.1 after 10d and 1.9×higher after 21d storage. This data shows that other PRM in the neat or encapsulated perfume can be protected from being lost during the making process and better expressed when silicic acid geraniol esters are used.

TABLE 6

| | | | | | Box Release HS | |
|---|---|---|---|---|---|---|
| | | Silicic Acid | Total HS Release from a | | excluding Geraniol and | |
| | | Geraniol Ester | Box of Dryer Sheets | | Geraniol-related | |
| | Dryer Sheet | weight % in | (nmol/L) | | products (nmol/ L) | |
| Example | Composition | dryer sheet | Time = 10 d | Time = 21 d | Time = 10 d | Time = 21 d |
| 6.1 (Comp) | E-1 | 0 | 3.0 | 0.7 | 2.8 | 0.6 |
| 6.2 (Inv) | E-2 | 2.5 | 9.5 | 3.5 | 3.8 | 1.1 |

| | | | | |
|---|---|---|---|---|
| Relative Increase | 3x | 5x | 1.4x | 1.9x |

The HS Release excluding geraniol and geraniol-related products from a Box of Dryer Sheets at 10 days may be greater than 3 nmol/L, greater than 3.5 nmol/L, less than 10 nmol/L, less than 7 nmol/L, less than 5 nmol/L, or any combination of ranges created thereby.

The HS Release excluding geraniol and geraniol-related products at 21 days may be greater than 0.7 nmol/L, greater than 0.8 nmol/L, greater than 1 nmol/L, less than 10 nmol/L, less than 7 nmol/L, less than 5 nmol/L, less than 4 nmol/L, less than 3 nmol/L, less than 2 nmol/L, or any combination of ranges created thereby.

The HS Release excluding geraniol and geraniol-related products at 10 days from a Box of Dryer Sheets according the present disclosure may have a relative increase in comparison to the total HS release from a box of dryer sheets that does not include a silicic acid perfume ester greater than 1.1×, greater than 1.2×, greater than 1.3×, less than 10×, less than 5×, less than 3×, less than 2×, or any combination of ranges created thereby.

The HS Release excluding geraniol and geraniol-related products at 21 days from a Box of Dryer Sheets according the present disclosure may have a relative increase in comparison to the total HS release from a box of dryer sheets that does not include a silicic acid perfume ester greater than 1.1×, greater than 1.5×, greater than 1.7×, less than 10×, less than 8×, less than 5×, less than 3×, or any combination of ranges created thereby.

The total HS Release from a Box of Dryer Sheets at 10 days may be greater than 3 nmol/L, greater than 4 nmol/L, greater than 5 nmol/L, greater than 7 nmol/L, greater than 9 nmol/L, less than 30 nmol/L, less than 20 nmol/L, less than 15 nmol/L, less than 13 nmol/L, less than 10 nmol/L, or any combination of ranges created thereby.

The total HS Release from a Box of Dryer Sheets at 21 days may be greater than 0.7 nmol/L, greater than 0.8 nmol/L, greater than 1 nmol/L, greater than 1.5 nmol/L, greater than 2 nmol/L, greater than 2.5 nmol/L, greater than 3 nmol/L, less than 20 nmol/L, less than 15 nmol/L, less than 13 nmol/L, less than 10 nmol/L, less than 7 nmol/L, less than 5 nmol/L, less than 4 nmol/L, or any combination of ranges created thereby.

The total HS Release at 10 days from a Box of Dryer Sheets according the present disclosure may have a relative increase in comparison to the total HS release from a box of dryer sheets that does not include a silicic acid perfume ester greater than 1.1×, greater than 1.5×, greater than 2×, greater than 2.5×, less than 10×, less than 5×, or any combination of ranges created thereby.

The total HS Release at 21 days from a Box of Dryer Sheets according the present disclosure may have a relative increase in comparison to the total HS release from a box of dryer sheets that does not include a silicic acid perfume ester greater than 1.1×, greater than 1.5×, greater than 2×, greater than 2.5×, greater than 3×, greater than 4×, less than 10×, less than 8×, or any combination of ranges created thereby.

### Example 7. Different Variants of Silicic Acid Perfume Esters Deliver Freshness

Silicic acid esters can be made from primary and secondary alcohols and converted into dryer sheet compositions to deliver improved freshness benefits to the fabric during tumble drying. Table 7 shows the DFHS comparison of dryer sheets formulated with free PRM alcohol or as the silicic acid ester of cinnamyl alcohol which is an allylic alcohol (Ex. 7.2), phenyl ethyl alcohol (ex. 7.4) which is a primary alcohol and undecavertol (ex. 7.6) which is a secondary alcohol. The dryer sheet compositions in Table 7 are normalized to deliver the same mass of PRM per dryer sheet as the free PRM and PRM delivered as a silicic acid PRM ester (30 mg per sheet) by adjusting the wt. % of fabric care composition actives to compare of the efficiency of the different delivery means.

Table 7 shows adding the PRM via the silicic acid ester surprisingly delivers 5× to 14×more DFHS than when free PRM is formulated into the dryer sheet. Without wishing to be bound by theory, free PRM becomes volatilized during the drying especially materials that have low boiling point, however when free PRM is formulated with the silicic acid PRM ester, the silicic acid PRM ester prevents the PRM from being volatilized and lost in the drying process. As a result of using silicic acid PRM esters, more perfume transfers to fabric resulting in higher DFHS since the PRM adsorbs onto the hydrophobic portion of the silicic acid perfume ester protecting it from loss during heating.

TABLE 7

| | | | | PRM | Rel. |
|---|---|---|---|---|---|
| | Dryer Sheet | | Delivery | DFHS | Increase vs |
| Example | Composition | PRM | Form | (nmol/L) | Comparative |
| 7.1 | F-1 | Cinnamyl alcohol | Free PRM | 1.5 | Comp. |
| 7.2 | F-2 | Cinnamyl alcohol | Silicic | 7.4 | 5x |
| | | | Acid ester | | |
| 7.3 | F-1 | Phenyl ethyl alcohol | Free PRM | 1.1 | Comp. |
| 7.4 | F-2 | Phenyl ethyl alcohol | Silicic | 12.3 | 11x |
| | | | Acid ester | | |
| 7.5 | F-1 | undecavertol | Free PRM | 3.0 | Comp. |
| 7.6 | F-3 | undecavertol | Silicic | 41.2 | 14x |
| | | | Acid ester | | |

### Example 8. Dryer Sheet Compositions with Different Clay Levels

Clay may be formulated into the dryer sheet fabric care composition to manage viscosity during processing. The amount of clay may be changed depending on the specific formulation.

Table 8 shows Silicic acid geraniol esters deliver DFHS and DFO in dryer sheet compositions with or without clay.

TABLE 8

| | | Silicic Acid | | | |
|---|---|---|---|---|---|
| | | Geraniol Ester | | | |
| | | Active Wt. % | | | |
| | Dryer Sheet | active in | | DFHS | |
| Example | Composition | Dryer Sheet | Clay | (nmol/L) | DFO |
| 8.0 | H-1 | 1.0% | 0 | 22.8 | 32 |
| 8.1 | H-2 | 1.0% | 2.8% | 19.0 | 30 |
| 8.2 | H-3 | 1.0% | 5.5% | 18.6 | 35 |

### Example 9. Dryer Sheet Compositions with Different Quaternary Ammonium Compound and Fatty Acid Levels

Formulation flexibility in dryer sheet compositions is important to manage fluctuations in raw material supply chain that may result in the need to alter the quaternary ammonium compound ratio with fatty acid. Formula flexibility may also be needed to aid processing during manufacture due to compatibility with different perfume compositions. Thus, it is important that the silicic acid perfume esters deliver freshness benefits across a broad range of dryer sheet compositions. Table 9 shows that inventive compositions with silicic acid geraniol ester with a ratio of quaternary ammonium compound to fatty acid from 2.5:1 to 1:1 deliver a 10-point increase in DFO versus the comparative example reference without silicic acid geraniol ester, that is consistent with a DFHS of at least 20× higher than the comparative examples without silicic acid geraniol ester. This data shows that the silicic acid geraniol ester can deliver higher perfume release across a wide range of formulation compositions to enable formulation flexibility.

TABLE 9

| | | Quaternary | | | | |
|---|---|---|---|---|---|---|
| | Dryer | Ammonium | Silicic Acid | | Rel. Increase | |
| | Sheet | Compound:Fatty | Geraniol | | vs | |
| Example | Comp | Acid | Ester wt % | DFO | Comparative | DFHS(nmol/ L) |
| 9.1 | I-1 | 2.5:1 | 0 | 40 | REF | 5.5 |
| (Comp) | | | | | | |
| 9.2 | I-2 | 2.5:1 | 1.8 | 50 | +10 | 101.3 |
| (Inv) | | | | | | |
| 9.3 | B-1 | 2:1 | 0 | 35 | REF | 4.3 |
| (Comp) | | | | | | |
| 9.4 | B-5 | 2:1 | 1.8 | 45 | +10 | 92.6 |
| (Inv) | | | | | | |
| 9.5 | A-4 | 1.5:1 | 0 | 35 | REF | 4.1 |
| (Comp) | | | | | | |
| 9.6 | F-4 | 1.5:1 | 1.8 | 45 | +10 | 90.4 |
| (Inv) | | | | | | |
| 9.7 | J-1 | 1:1 | 0 | 35 | REF | 3.7 |
| (Comp) | | | | | | |
| 9.8 | J-2 | 1:1 | 1.8 | 45 | +10 | 75.7 |
| (Inv) | | | | | | |

### Example 10. Fabric Care Composition Compatibility with Silicic Acid Geraniol Ester

Dryer sheet compositions are prepared by applying a fabric care composition as a melt to a polyester non-woven using a transfer process such as slot coating on a production scale. Melted fabric care composition is applied as a coating to the non-woven at high-speed using rubber-coated rollers that form a nip gap to control the coating thickness on the non-woven. The applied coating is then rapidly cooled to a solid. If the fabric care composition is too soft when cooled, problems can occur during production if the fabric care composition builds up on the rollers. Manufacturing may even need to be stopped to clean the rolls which is problematic because of production downtime and high levels of scrap. When the perfume level is too high, the coating can become plasticized making the hardness of the solid too low leading to problems during production. Thus, it is important that fabric care compositions comprising the silicic acid perfume esters be at a level where the coating is a cohesive solid that is non-tacky and brittle. Shore B hardness of the solidified fabric care composition is measured using a durometer to determine whether the fabric care composition will lead to build up during production. When cooled fabric care compositions have a Shore Hardness that is greater than 20, the coating on the non-woven is cohesive and brittle enough that production will be possible, however when the hardness drops below 20, the solidified coating is too soft and transfer to the production rolls is more likely which leads to production downtime caused by residue build up.

Table 10 shows that fabric care compositions comprising up to 10% silicic acid perfume esters have a Shore B Hardness greater than 20 for examples 10.2, 10.3, and 10.4 that drops to 16 when the silicic acid perfume ester is at 20% (Ex. 10.5). Neat perfume may also be present with silicic acid perfume esters, and Example 10.7 shows that 10% silicic acid perfume ester with 3% neat perfume for a total of 13% neat perfume and perfume delivered via the silicic acid perfume ester has a Shore Hardness B value of 22 which is above the hardness criteria for production.

A dryer sheet comprising a nonwoven fibrous substrate and a fabric care composition associated with the nonwoven comprises from 50 wt. % to about 95 wt % of fabric care composition by weight of the dryer sheet for a ratio of fabric care composition to non-woven from 20:1 to 1:1 thus the maximum level of silicic acid perfume ester in the fabric care composition may be up to 10% to make a coating with sufficient hardness to be efficiently converted to dryer sheets on a large production scale.

TABLE 10
Dryer Sheet Fabric Care Composition Brittleness and Shore B Hardness

| | | | | Total Neat | | |
|---|---|---|---|---|---|---|
| | | Neat | Silicic Acid | Perfume + | Cohesive | |
| | Fabric Care | Perfume | Perfume Ester | Silicic | Solid and | Shore B |
| Example | Composition | Amount | Amount | Acid Ester | Brittle | Hardness |
| 10.1 | L-1 | — | — | — | YES | 44 |
| (Comparative) | | | | | | |
| 10.2 | L-2 | — | 3.7% | 3.7% | YES | 39 |
| 10.3 | L-3 | — | 5.1% | 5.1% | YES | 36 |
| 10.4 | L-4 | — | 10.0% | 10.0% | YES | 29 |
| 10.5 | L-5 | — | 20.0% | 20.0% | NO | 16 |
| (Comparative) | | | | | | |
| 10.6 | L-6 | 3.0% | — | 3.0% | YES | 33 |
| (Comparative) | | | | | | |
| 10.7 | L-7 | 3.0% | 10.0% | 13.0% | YES | 22 |
| 10.8 | L-8 | 3.0% | 19.9% | 22.9% | NO | Below |
| (Comparative) | | | | | | detection |

The dryer sheet fabric care composition may have a Shore B Hardness ranging from 5 to 50, from 5 to 40, from 5 to 35, from 5 to 30, from 5 to 25, from 5 to 20, from 5 to 15, from 5 to 10, from 10 to 50, from 10 to 40, from 10 to 35, from 10 to 30, from 10 to 25, from 10 to 20, from 10 to 15, from 15 to 50, from 15 to 40, from 15 to 35, from 15 to 30, from 15 to 25, from 15 to 20, from 20 to 50, from 20 to 40, from 20 to 35, from 20 to 30, from 20 to 25, from 25 to 50, from 25 to 40, from 25 to 35, from 25 to 30, from 30 to 50, from 30 to 40, from 30 to 35, from 35 to 50, from 35 to 40, from 40 to 50, or any combination of ranges created thereby.

### Aspects

The presently described subject matter may include one or more aspects, which should not be regarded as limiting on the teaching of the present disclosure.

A first aspect may include a dryer sheet comprising a nonwoven fibrous substrate and a fabric care composition associated with the nonwoven fibrous substrate, the fabric care composition comprising: about 40% to about 75% by weight of the fabric care composition, of a fabric softening active; about 0.2% to about 10%, about 0.2% to about 8%, about 0.2% to about 6%, 0.2% to about 5%, preferably 0.3% to about 4%, preferably from about 0.4% to about 2.5% by weight of the fabric care composition of a silicic acid perfume ester, wherein the silicic acid perfume ester comprises a silicon moiety and a fragrance moiety, wherein the fragrance moiety comprises an alcohol-based perfume; optionally a neat perfume; and wherein the dryer sheet comprises from about 50 wt. % to about 95 wt. %, preferably 60 wt. % to about 90 wt. %, even more preferably from about 65 wt. % to about 85 wt. % of the fabric care composition, by weight of the dryer sheet.

A second aspect may include a dryer sheet comprising a nonwoven fibrous substrate and a fabric care composition associated with the nonwoven fibrous substrate, the dryer sheet comprising: about 10 to about 60 wt. % of a fabric softening active, by weight of the dryer sheet; about 0.2% to about 10%, about 0.2% to about 8%, about 0.2% to about 6%, 0.2% to about 5%, preferably 0.3% to about 4%, preferably from about 0.4% to about 2.5% of a silicic acid perfume ester, by weight of the dryer sheet, wherein the silicic acid perfume ester comprises a silicon moiety and a fragrance moiety, wherein the fragrance moiety comprises an alcohol-based perfume; and optionally a neat perfume, wherein: the dryer sheet comprises from about 50 wt. % to about 95 wt. %, preferably 60 wt. % to about 90 wt. %, even more preferably from about 65 wt. % to about 85 wt. % of the fabric care composition, by weight of the dryer sheet.

Another aspect may include any of the previous aspects, wherein the fabric care composition further comprises a perfume delivery system comprising at least one of a polymer assisted delivery polymer; molecule assisted delivery; amine assisted deliver; a non-silicon pro-perfume; a plurality of delivery particles, wherein each of the plurality of particles comprises a core surrounded by a shell, wherein the core comprises a benefit agent; or combinations thereof.

Another aspect may include any of the previous aspects, wherein the fabric softening active comprises a quaternary ammonium compound and a fatty acid.

Another aspect may include any of the previous aspects, wherein a ratio of quaternary ammonium compound to fatty acid is from about 10:1 to about 1:5, or from about 5:1 to about 1:3, or from 0.5:1.0 to about 5:1, preferably 1:1 to about 3:1.

Another aspect may include any of the previous aspects, wherein the quaternary ammonium compound has an iodine value of from about 0 to about 65, more preferably 0 to about 45, more preferably from about 0 to 35.

Another aspect may include any of the previous aspects, wherein the fatty acid has an iodine value of from about 0 to about 45, from about 0 to about 35, more preferably 0 to about 25.

Another aspect may include any of the previous aspects, wherein the fabric care composition comprises neat perfume.

Another aspect may include any of the previous aspects, wherein the silicic acid perfume ester comprises the Formula 1:

[R₁R₂R₃SiO_{1/2}]_{(q+2r±2)}[R₄R₅SiO_{2/2}]ₚ[R₆SiO_{3/2}]_{q}[SiO_{4/2}]ᵣ Formula I
wherein:
p is an integer from 0 to 200, or from 0 to 100, preferably from 0 to 50, preferably from 0 to 20, even more preferably from 1 to 10 and most preferably from 1 to 5;
q is an integer from 0 to 150, more preferably 0 to 75, more preferably 0 to 50, more preferably 0 to 25, more preferably 0 to 15, most preferably 0 to 5;
r is an integer from 0 to 20, preferably 0 to 10, preferably 0 to 2;
p+q+r equals an integer greater than or equal to 1; and
each R1, R2, R3, R4, R5 and R6 moiety is independently selected from the group consisting of OH, C1-C32 alkoxy, C1-C32 substituted alkoxy, C6-C32 aryloxy, C6-C32 substituted aryloxy.

Another aspect may include any of the previous aspects, wherein the alcohol-based perfume comprises at least one of: geraniol, citronellol, beta-gamma-hexanol, 9-decen-1-ol, phenyl ethyl alcohol, cinnamic alcohol, undecavertol, cis-6-nonenol, hindinol, 1-octen-3-ol, 2,6-nonadien-1-ol, acetyl methyl carbinol, rosyfolia, (Z)-3-methyl-5-(2,2,3-trimethyl-1-cyclopent-3-enyl) pent-4-en-2-ol, coramber, laevo citronellol, borneol, laevo menthol, laevo trisandol, 2-methyl-3-[(1,7,7-trimethylbicyclo[2.2.1]hept-2-yl)oxy]propan-1-ol, (E)-3,3-dimethyl-5-(2,2,3-trimethyl-3-cyclopenten-1-yl)-4-penten-2-ol, nerol, octalynol, (1S,4R,6R)-1,7,7-trimethylbicyclo[2.2.1]heptan-6-ol, [2.2.1]heptan-6-ol, phenyl propyl alcohol, (Z)-non-6-en-1-ol, javanol, 2-tert-butylcyclohexan-1-ol, (Z)-3-methyl-5-(2,2,3-trimethyl-1-cyclopent-3-enyl) pent-4-en-2-ol, 1,3,3-trimethylbicyclo[2.2.1]heptan-2-ol, maltol, josenol, 2-pentylcyclopentan-1-ol, Dimethyloctanol, Benzyl alcohol, (3S)-3,7-dimethyloct-6-en-1-ol, aurantiol, bornafix, octan-1-ol, 5-(3-methylphenyl) pentan-1-ol, octalynol, 3-methoxyl-3-methyl-1-butanol, (E)-3,3-dimethyl-5-(2,2,3-trimethyl-3-cyclopenten-1-yl)-4-penten-2-ol, Hydroxycitronellol, Ethyl maltol, 2-(4-methyl-1,3-thiazol-5-yl) ethanol, Sulfurol, thymol, 2,6-nonadien-1-ol, 2-cyclododecylpropan-1-ol, farnesol, and combinations thereof.

Another aspect may include any of the previous aspects, wherein the fabric softening composition further comprises a clay, preferably a bentonite clay.

Another aspect may include any of the previous aspects, wherein said fabric care composition comprises clay, said clay comprises from about 0% to about 10%, preferably about 0.1% to about 10%, by weight of said dryer sheet.

Another aspect may include any of the previous aspects, wherein the dryer sheet comprises bentonite clay from about 0% to about 10%, preferably about 0.1% to about 10%, by weight of said dryer sheet.

Another aspect may include any of the previous aspects, wherein said fabric care composition comprises from about 0.2 wt. % to about 2 wt. % delivery particles by weight of the dryer sheet, wherein each of the plurality of particles comprises a core surrounded by a shell, wherein the core comprises a benefit agent.

Another aspect may include any of the previous aspects, wherein the dryer sheet comprises from about 0.2 to about 5 wt. % of delivery particles, by weight of the dryer sheet, wherein each of the plurality of particles comprises a core surrounded by a shell, wherein the core comprises a benefit agent.

Another aspect may include any of the previous aspects, wherein the shell comprises at least one of melamine formaldehyde, cross-linked polyacrylate, cross-linked polyurea, or cross-linked bio-polymer, silica encapsulates, or combinations thereof.

Another aspect may include any of the previous aspects, wherein the plurality of delivery particles has a volume-weighted median size of from about 1 to about 150 microns, preferably from about 10 to about 100 microns, preferably from about 15 to about 75 microns, or more preferably from about 20 to about 50 microns.

Another aspect may include any of the previous aspects, wherein the plurality of delivery particles has a ratio of core to shell of at least 75:25, or 85:15, or 90:10, or even up to 99:1, or even at least 99.5:0.5, on the basis of weight.

Another aspect may include any of the previous aspects, wherein a shell is present at a level of from about 1% to about 25%, preferably from about 1% to about 20%, preferably from about 1% to 15%, more preferably from about 5% to about 15%, even more preferably from about 10% to about 15%, even more preferably from about 10% to about 12%, by weight of the delivery particle.

Another aspect may include any of the previous aspects, wherein the plurality of delivery particles further comprises a deposition aid coated thereon, wherein the deposition aid comprises a cationic material, such as a cationic polymer, a non-ionic polymer, an anionic polymer, or mixtures thereof.

Another aspect may include any of the previous aspects, wherein said fabric softening active comprises bis-(2-hydroxypropyl)-dimethylammonium methylsulfate fatty acid ester and isomers of bis-(2-hydroxypropyl)-dimethylammonium methylsulfate fatty acid ester and/or mixtures thereof, N,N-bis(stearoyl-oxy-ethyl)-N-(2 hydroxyethyl)-N-methyl ammonium methylsulfate, N,N-bis-(stearoyl-2-hydroxypropyl)-N,N-dimethylammonium methylsulfate, N,N-di(tallowyl-oxy-ethyl)-N-methyl, N-(2-hydroxyethyl) ammonium methyl sulfate, N,N-bis-(tallowoyl-2-hydroxypropyl)-N,N-dimethylammonium methylsulfate, N,N-bis-(palmitoyl-2-hydroxypropyl)-N,N-dimethylammoniummethylsulfate, dicanoladimethylammonium methylsulfate, 1-methyl-1-stearoylamidoethyl-2-stearoylimidazolinium methylsulfate, 1-tallowylamidoethyl-2-tallowylimidazoline, dipalmylmethyl hydroxyethylammonium methylsulfate and combinations thereof, preferably wherein said fabric softening active comprises N,N-bis-(stearoyl-2-hydroxypropyl)-N,N-dimethylammonium methylsulfate or N,N-di(tallowyl-oxy-ethyl)-N-methyl, N-(2-hydroxyethyl) ammonium methyl sulfate.

Another aspect may include any of the previous aspects, wherein the fabric softening active comprises stearic acid, isostearic acid, palmitic acid, coconut oil, palm kernel oil, stearic acid palmitic acid blend, oleic acid, linoleic acid, alpha-linolenic acid, myristic acid, behenic acid, erucic acid, vegetable oil, partially hydrogenated vegetable oil, or mixtures thereof.

Another aspect may include any of the previous aspects, wherein a weight ratio of fabric care composition to nonwoven substrate from about 0.3:1 to about 10:1, from about 0.3:1 to about 8:1, from about 0.3:1 to about 5:1, from about 0.3:1 to about 3:1, from about 0.3:1 to about 2:1, from about 0.3:1 to about 1:1, from about 0.5:1 to about 10:1, from about 0.5:1 to about 8:1, from about 0.5:1 to about 5:1, from about 0.5:1 to about 3:1, from about 0.5:1 to about 2:1, from about 0.5:1 to about 1:1, from about 1:1 to about 10:1, from about 1:1 to about 8:1, from about 1:1 to about 5:1, from about 1:1 to about 3:1, from about 1:1 to about 2:1, from about 2:1 to about 10:1, from about 2:1 to about 8:1, from about 2:1 to about 5:1, from about 2:1 to about 3:1, from about 3:1 to about 10:1, from about 3:1 to about 8:1, from about 3:1 to about 5:1, from about 5:1 to about 10:1, from about 5:1 to about 8:1, from about 8:1 to about 10:1, or any ranges created thereby.

Another aspect may include any of the previous aspects, wherein the dryer sheet includes from about 50 wt. % to about 95 wt. %, preferably about 60 wt. % to about 90 wt. %, even more preferably from about 65 wt. % to about 85 wt. %, or any ranges created thereby, of the fabric care composition by weight of the dryer sheet.

Another aspect may include any of the previous aspects, wherein the dryer sheet includes from 40% to 75%, from 40% to 70%, from 40% to 65%, from 40% to 60%, from 40% to 55%, from 40% to 50%, from 40% to 45%, from 45% to 75%, from 45% to 70%, from 45% to 65%, from 45% to 60%, from 45% to 55%, from 45% to 50%, from 50% to 75%, from 50% to 70%, from 50% to 65%, from 50% to 60%, from 50% to 55%, from 55% to 75%, from 55% to 70%, from 55% to 65%, from 55% to 60%, from 60% to 75%, from 60% to 70%, from 60% to 65%, from 65% to 75%, from 65% to 70%, or from 70% to 75% fabric softening active, by weight of the dryer sheet.

Another aspect may include any of the previous aspects, wherein the dryer sheet includes from about 10 to about 60 wt. %, from about 10 to about 55 wt. %, from about 10 to about 50 wt. %, from about 10 to about 45 wt. %, from about 10 to about 40 wt. %, from about 15 to about 60 wt. %, from about 15 to about 55 wt. %, from about 15 to about 50 wt. %, from about 15 to about 45 wt. %, from about 15 to about 40 wt. %, from about 20 to about 60 wt. %, from about 20 to about 55 wt. %, from about 20 to about 50 wt. %, from about 20 to about 45 wt. %, from about 20 to about 40 wt. %, from about 25 to about 60 wt. %, from about 25 to about 55 wt. %, from about 25 to about 50 wt. %, from about 25 to about 45 wt. %, from about 25 to about 40 wt. %, from about 30 to about 60 wt. %, from about 30 to about 55 wt. %, from about 30 to about 50 wt. %, from about 30 to about 45 wt. %, from about 30 to about 40 wt. %, from about 35 to about 60 wt. %, from about 35 to about 55 wt. %, from about 35 to about 50 wt. %, from about 35 to about 45 wt. %, from about 35 to about 40 wt. %, or any ranges created thereby, of quaternary ammonium compound, by weight of the dryer sheet.

Another aspect may include any of the previous aspects, wherein the dryer sheet includes from about 5 to about 50 wt. %, from about 5 to about 40 wt. %, from about 5 to about 35 wt. %, from about 5 to about 30 wt. %, from about 10 to about 50 wt. %, from about 10 to about 40 wt. %, from about 10 to about 35 wt. %, from about 10 to about 30 wt. %, from about 15 to about 50 wt. %, from about 15 to about 40 wt. %, from about 15 to about 35 wt. %, from about 15 to about 30 wt. %, from about 20 to about 50 wt. %, from about 20 to about 40 wt. %, from about 20 to about 35 wt. %, from about 20 to about 30 wt. %, from about 25 to about 50 wt. %, from about 25 to about 40 wt. %, from about 25 to about 35 wt. %, from about 25 to about 30 wt. %, from about 20 to about 25 wt. %, or any ranges created thereby, of fatty acid, by weight of the dryer sheet.

Another aspect may include any of the previous aspects, wherein the dryer sheet includes from about 0.1 to about 8 wt. %, from about 0.1 to about 6 wt. %, from about 0.1 to about 5 wt. %, from about 0.1 to about 4 wt. %, from about 0.1 to about 3 wt. %, from about 0.1 to about 2.5 wt. %, from about 0.1 to about 2 wt. %, from about 0.1 to about 1.5 wt. %, from about 0.1 to about 1.2 wt. %, from about 0.1 to about 1 wt. %, from about 0.1 to about 0.8 wt. %, from about 0.3 to about 8 wt. %, from about 0.3 to about 6 wt. %, from about 0.3 to about 5 wt. %, from about 0.3 to about 4 wt. %, from about 0.3 to about 3 wt. %, from about 0.3 to about 2.5 wt. %, from about 0.3 to about 2 wt. %, from about 0.3 to about 1.5 wt. %, from about 0.3 to about 1.2 wt. %, from about 0.3 to about 1 wt. %, from about 0.3 to about 0.8 wt. %, from about 0.5 to about 8 wt. %, from about 0.5 to about 6 wt. %, from about 0.5 to about 5 wt. %, from about 0.5 to about 4 wt. %, from about 0.5 to about 3 wt. %, from about 0.5 to about 2.5 wt. %, from about 0.5 to about 2 wt. %, from about 0.5 to about 1.5 wt. %, from about 0.5 to about 1.2 wt. %, from about 0.5 to about 1 wt. %, from about 0.5 to about 0.8 wt. %, from about 0.7 to about 8 wt. %, from about 0.7 to about 6 wt. %, from about 0.7 to about 5 wt. %, from about 0.7 to about 4 wt. %, from about 0.7 to about 3 wt. %, from about 0.7 to about 2.5 wt. %, from about 0.7 to about 2 wt. %, from about 0.7 to about 1.5 wt. %, from about 0.7 to about 1.2 wt. %, from about 0.7 to about 1 wt. %, from about 0.7 to about 0.8 wt. %, from about 0.8 to about 8 wt. %, from about 0.8 to about 6 wt. %, from about 0.8 to about 5 wt. %, from about 0.8 to about 4 wt. %, from about 0.8 to about 3 wt. %, from about 0.8 to about 2.5 wt. %, from about 0.8 to about 2 wt. %, from about 0.8 to about 1.5 wt. %, from about 0.8 to about 1.2 wt. %, from about 0.8 to about 1 wt. %, from about 1 to about 8 wt. %, from about 1 to about 6 wt. %, from about 1 to about 5 wt. %, from about 1 to about 4 wt. %, from about 1 to about 3 wt. %, from about 1 to about 2.5 wt. %, from about 1 to about 2 wt. %, from about 1 to about 1.5 wt. %, from about 1 to about 1.2 wt. %, or any ranges created thereby, of silicic acid perfume ester, by weight of the dryer sheet.

Another aspect may include any of the previous aspects, wherein the dryer sheet includes from about 0.1 to about 20 wt. %, from about 0.1 to about 15 wt. %, from about 0.1 to about 10 wt. %, from about 0.1 to about 7 wt. %, from about 0.1 to about 5 wt. %, from about 0.1 to about 4 wt. %, from about 0.3 to about 20 wt. %, from about 0.3 to about 15 wt. %, from about 0.3 to about 10 wt. %, from about 0.3 to about 7 wt. %, from about 0.3 to about 5 wt. %, from about 0.3 to about 4 wt. %, from about 0.5 to about 20 wt. %, from about 0.5 to about 15 wt. %, from about 0.5 to about 10 wt. %, from about 0.5 to about 7 wt. %, from about 0.5 to about 5 wt. %, from about 0.5 to about 4 wt. %, from about 0.7 to about 20 wt. %, from about 0.7 to about 15 wt. %, from about 0.7 to about 10 wt. %, from about 0.7 to about 7 wt. %, from about 0.7 to about 5 wt. %, from about 0.7 to about 4 wt. %, from about 1 to about 20 wt. %, from about 1 to about 15 wt. %, from about 1 to about 10 wt. %, from about 1 to about 7 wt. %, from about 1 to about 5 wt. %, from about 1 to about 4 wt. %, from about 1.3 to about 20 wt. %, from about 1.3 to about 15 wt. %, from about 1.3 to about 10 wt. %, from about 1.3 to about 7 wt. %, from about 1.3 to about 5 wt. %, from about 1.3 to about 4 wt. %, from about 1.5 to about 20 wt. %, from about 1.5 to about 15 wt. %, from about 1.5 to about 10 wt. %, from about 1.5 to about 7 wt. %, from about 1.5 to about 5 wt. %, from about 1.5 to about 4 wt. %, from about 2 to about 20 wt. %, from about 2 to about 15 wt. %, from about 2 to about 10 wt. %, from about 2 to about 7 wt. %, from about 2 to about 5 wt. %, from about 2 to about 4 wt. %, from about 2.5 to about 20 wt. %, from about 2.5 to about 15 wt. %, from about 2.5 to about 10 wt. %, from about 2.5 to about 7 wt. %, from about 2.5 to about 5 wt. %, from about 2.5 to about 4 wt. %, from about 3 to about 20 wt. %, from about 3 to about 15 wt. %, from about 3 to about 10 wt. %, from about 3 to about 7 wt. %, from about 3 to about 5 wt. %, from about 3 to about 4 wt. %, or any ranges created thereby, of neat perfume, by weight of the dryer sheet.

Another aspect may include any of the previous aspects, wherein the dryer sheet includes from about 0.1 to about 20 wt. %, from about 0.1 to about 15 wt. %, from about 0.1 to about 10 wt. %, from about 0.1 to about 7 wt. %, from about 0.1 to about 5 wt. %, from about 0.1 to about 4 wt. %, from about 0.1 to about 3 wt. %, from about 0.1 to about 2.5 wt. %, from about 0.1 to about 2 wt. %, from about 0.1 to about 1.5 wt. %, from about 0.1 to about 1 wt. %, from about 0.1 to about 0.7 wt. %, from about 0.1 to about 0.5 wt. %, from about 0.5 to about 20 wt. %, from about 0.5 to about 15 wt. %, from about 0.5 to about 10 wt. %, from about 0.5 to about 7 wt. %, from about 0.5 to about 5 wt. %, from about 0.5 to about 4 wt. %, from about 0.5 to about 3 wt. %, from about 0.5 to about 2.5 wt. %, from about 0.5 to about 2 wt. %, from about 0.5 to about 1.5 wt. %, from about 0.5 to about 1 wt. %, from about 0.5 to about 0.7 wt. %, from about 0.7 to about 20 wt. %, from about 0.7 to about 15 wt. %, from about 0.7 to about 10 wt. %, from about 0.7 to about 7 wt. %, from about 0.7 to about 5 wt. %, from about 0.7 to about 4 wt. %, from about 0.7 to about 3 wt. %, from about 0.7 to about 2.5 wt. %, from about 0.7 to about 2 wt. %, from about 0.7 to about 1.5 wt. %, from about 0.7 to about 1 wt. %, from about 1 to about 20 wt. %, from about 1 to about 15 wt. %, from about 1 to about 10 wt. %, from about 1 to about 7 wt. %, from about 1 to about 5 wt. %, from about 1 to about 4 wt. %, from about 1 to about 3 wt. %, from about 1 to about 2.5 wt. %, from about 1 to about 2 wt. %, from about 1 to about 1.5 wt. %, from about 1.5 to about 20 wt. %, from about 1.5 to about 15 wt. %, from about 1.5 to about 10 wt. %, from about 1.5 to about 7 wt. %, from about 1.5 to about 5 wt. %, from about 1.5 to about 4 wt. %, from about 1.5 to about 3 wt. %, from about 1.5 to about 2.5 wt. %, from about 1.5 to about 2 wt. %, or any ranges created thereby, of delivery particles, by weight of the dryer sheet.

Another aspect may include any of the previous aspects, wherein the dryer sheet includes from about 0 to about 20 wt. %, from about 0 to about 15 wt. %, from about 0 to about 10 wt. %, from about 0 to about 8 wt. %, from about 0 to about 6 wt. %, from about 0.1 to about 20 wt. %, from about 0.1 to about 15 wt. %, from about 0.1 to about 10 wt. %, from about 0.1 to about 8 wt. %, from about 0.1 to about 6 wt. %, from about 0.5 to about 20 wt. %, from about 0.5 to about 15 wt. %, from about 0.5 to about 10 wt. %, from about 0.5 to about 8 wt. %, from about 0.5 to about 6 wt. %, from about 1 to about 20 wt. %, from about 1 to about 15 wt. %, from about 1 to about 10 wt. %, from about 1 to about 8 wt. %, from about 1 to about 6 wt. %, from about 3 to about 20 wt. %, from about 3 to about 15 wt. %, from about 3 to about 10 wt. %, from about 3 to about 8 wt. %, from about 3 to about 6 wt. %, from about 4 to about 20 wt. %, from about 4 to about 15 wt. %, from about 4 to about 10 wt. %, from about 4 to about 8 wt. %, from about 4 to about 6 wt. %, from about 5 to about 20 wt. %, from about 5 to about 15 wt. %, from about 5 to about 10 wt. %, from about 5 to about 8 wt. %, from about 5 to about 6 wt. %, or any range created thereby, of clay, by weight of the dryer sheet.

Another aspect may include any of the previous aspects, wherein the dryer sheet includes from about 5 to about 50 wt. %, from about 5 to about 40 wt. %, from about 5 to about 35 wt. %, from about 10 to about 50 wt. %, from about 10 to about 40 wt. %, from about 10 to about 35 wt. %, from about 15 to about 50 wt. %, from about 15 to about 40 wt. %, from about 15 to about 35 wt. %, from about 20 to about 50 wt. %, from about 20 to about 40 wt. %, from about 20 to about 35 wt. %, from about 25 to about 50 wt. %, from about 25 to about 40 wt. %, from about 25 to about 35 wt. %, from about 30 to about 50 wt. %, from about 30 to about 40 wt. %, from about 30 to about 35 wt. %, and any ranges created thereby, of the nonwoven fibrous substrate, by weight of the dryer sheet. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an example of the present disclosure or to emphasize alternative or additional features that may or may not be utilized in a particular example of the present disclosure.

It is also noted that recitations herein of “at least one” component, element, etc., should not be used to create an inference that the alternative use of the articles “a” or “an” should be limited to a single component, element, etc.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any composition or method disclosed or claimed herein or that it alone, or in any combination with any other reference or references, teaches, suggests or discloses any such composition or method. Further, to the extent that any meaning or definition of a term in this document conflicts with any meaning or definition of the same term in a document incorporated by reference, the meaning or definition assigned to that term in this document shall govern.

While particular examples of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the 5 present disclosure.

What is claimed is:

1. A dryer sheet comprising a nonwoven fibrous substrate and a fabric care composition associated with the nonwoven fibrous substrate, the dryer sheet comprising:
about 10 to about 60 wt. % of a fabric softening active, by weight of the dryer sheet;
about 0.2 to about 10 wt. % of a silicic acid perfume ester, by weight of the dryer sheet, wherein the silicic acid perfume ester comprises a silicon moiety and a fragrance moiety, wherein the fragrance moiety comprises an alcohol-based perfume; and
optionally a neat perfume, wherein:
the dryer sheet comprises from about 50 to about 95 wt. % of the fabric care composition, by weight of the dryer sheet.

2. The dryer sheet of claim 1, wherein the fabric care composition further comprises a perfume delivery system comprising at least one of a polymer assisted delivery polymer; a molecule assisted delivery molecule; an amine-assisted delivery polymer or molecule; a non-silicon pro-perfume; a plurality of delivery particles, wherein each of the plurality of particles comprises a core surrounded by a shell, wherein the core comprises a benefit agent; or
combinations thereof.

3. The dryer sheet of claim 1, wherein the fabric softening active comprises a quaternary ammonium compound and a fatty acid.

4. The dryer sheet of claim 2, wherein a ratio of quaternary ammonium compound to fatty acid is from about 10:1 to about 1:5.

5. The dryer sheet of claim 2, wherein the quaternary ammonium compound has an iodine value of from about 0 to about 65.

6. The dryer sheet of claim 2, wherein the fatty acid has an iodine value of from about 0 to about 45.

7. The dryer sheet of claim 1, wherein the fabric care composition comprises neat perfume.

8. The dryer sheet of claim 1, wherein the silicic acid perfume ester comprises the Formula 1:
[R₁R₂R₃SiO_{1/2}]_{(q+2r+2)}[R₄R₅SiO_{2/2}]ₚ[R₆SiO_{3/2}]_{q}[SiO_{4/2}]Formula I wherein:
p is an integer from 0 to 200;
q is an integer from 0 to 150;
r is an integer from 0 to 20;
p+q+r equals an integer greater than or equal to 1; and
each R¹, R², R₃, R⁴, R⁵ and R⁶ moiety is independently selected from the group consisting of OH, C₁-C₃₂ alkoxy, C₁-C₃₂ substituted alkoxy, C₆-C₃₂ aryloxy, C₆-C₃₂ substituted aryloxy.

9. The dryer sheet of claim 8, wherein:
p is an integer from 1 to 5;
q is an integer from 0 to 5;
r is an integer from 0 to 2;
each R₁, R₂, R₃, R₄, R₅ and R₆ moiety is independently selected from the group consisting of (i) a C₁₋₆ alkoxy moiety and (ii) a geraniol moiety;
the mol ratio of (ii) the geraniol moieties to (i) the C₁-6 alkoxy moieties in the silicic acid perfume ester ranges from about 4:1 to about 10:1; and
the silicic acid perfume ester comprises less than 5 wt. % of unreacted hydroxyl-containing perfume raw material.

10. The dryer sheet of claim 1, wherein the alcohol-based perfume comprises at least one of: geraniol, citronellol, beta-gamma-hexanol, 9-decen-1-ol, phenyl ethyl alcohol, cinnamic alcohol, undecavertol, cis-6-nonenol, hindinol, 1-octen-3-ol, 2,6-nonadien-1-ol, acetyl methyl carbinol, rosyfolia, (Z)-3-methyl-5-(2,2,3-trimethyl-1-cyclopent-3-enyl) pent-4-en-2-ol, coramber, laevo citronellol, borneol, laevo menthol, laevo trisandol, 2-methyl-3-[(1,7,7-trimethylbicyclo[2.2.1]hept-2-yl)oxy]propan-1-ol, (E)-3,3-dimethyl-5-(2,2,3-trimethyl-3-cyclopenten-1-yl)-4-penten-2-ol, nerol, octalynol, (1S,4R,6R)-1,7,7-trimethylbicyclo[2.2.1]heptan-6-ol, [2.2.1]heptan-6-ol, phenyl propyl alcohol, (Z)-non-6-en-1-ol, javanol, 2-tert-butylcyclohexan-1-ol, (Z)-3-methyl-5-(2,2,3-trimethyl-1-cyclopent-3-enyl) pent-4-en-2-ol, 1,3,3-trimethylbicyclo[2.2.1]heptan-2-ol, maltol, josenol, 2-pentylcyclopentan-1-ol, Dimethyloctanol, Benzyl alcohol, (3S)-3,7-dimethyloct-6-en-1-ol, aurantiol, bornafix, octan-1-ol, 5-(3-methylphenyl) pentan-1-ol, octalynol, 3-methoxyl-3-methyl-1-butanol, (E)-3,3-dimethyl-5-(2,2,3-trimethyl-3-cyclopenten-1-yl)-4-penten-2-ol, Hydroxycitronellol, Ethyl maltol, 2-(4-methyl-1,3-thiazol-5-yl) ethanol, Sulfurol, thymol, 2,6-nonadien-1-ol, 2-cyclododecylpropan-1-ol, farnesol, and combinations thereof.

11. The dryer sheet of claim 10, wherein the dryer sheet comprises bentonite clay from about 0.1% to about 10%, by weight of said dryer sheet.

12. The dryer sheet of claim 1, wherein the dryer sheet comprises from about 0.2 to about 5 wt. % of delivery particles, by weight of the dryer sheet, wherein each of the plurality of particles comprises a core surrounded by a shell, wherein the core comprises a benefit agent.

13. The dryer sheet of claim 12, wherein the shell comprises at least one of melamine formaldehyde, cross-linked polyacrylate, cross-linked polyurea, or cross-linked bio-polymer, silica encapsulates, or combinations thereof.

14. The dryer sheet of claim 12, wherein the plurality of delivery particles has a volume-weighted median size of from about 1 to about 150 microns.

15. The dryer sheet of claim 12, wherein the plurality of delivery particles has a ratio of core to shell of at least 75:25 on the basis of weight.

16. The dryer sheet of claim 12, wherein a shell is present at a level of from about 1% to about 25% by weight of the delivery particle.

17. The dryer sheet of claim 12, wherein the plurality of delivery particles further comprises a deposition aid coated thereon, wherein the deposition aid comprises a cationic material, such as a cationic polymer, a non-ionic polymer, an anionic polymer, or mixtures thereof.

18. The dryer sheet of claim 1, wherein said fabric softening active comprises bis-(2-hydroxypropyl)-dimethylammonium methylsulfate fatty acid ester and isomers of bis-(2-hydroxypropyl)-dimethylammonium methylsulfate fatty acid ester and/or mixtures thereof, N,N-bis(stearoyl-oxy-ethyl)-N-(2 hydroxyethyl)-N-methyl ammonium methylsulfate, N,N-bis-(stearoyl-2-hydroxypropyl)-N,N-dimethylammonium methylsulfate, N,N-di(tallowyl-oxy-ethyl)-N-methyl, N-(2-hydroxyethyl) ammonium methyl sulfate, N,N-bis-(tallowoyl-2-hydroxypropyl)-N,N-dimethylammonium methylsulfate, N,N-bis-(palmitoyl-2-hydroxypropyl)-N,N-dimethylammoniummethylsulfate, dicanoladimethylammonium methylsulfate, 1-methyl-1-stearoylamidoethyl-2-stearoylimidazolinium methylsulfate, 1-tallowylamidoethyl-2-tallowylimidazoline, dipalmylmethyl hydroxyethylammonium methylsulfate and combinations thereof.

19. The dryer sheet of claim 1, wherein said fabric softening active comprises N,N-bis-(stearoyl-2-hydroxypropyl)-N,N-dimethylammonium methylsulfate or N,N-di(tallowyl-oxy-ethyl)-N-methyl, N-(2-hydroxyethyl) ammonium methyl sulfate.

20. The dryer sheet according to claim 1, wherein the fabric softening active comprises stearic acid, isostearic acid, palmitic acid, coconut oil, palm kernel oil, stearic acid palmitic acid blend, oleic acid, linoleic acid, alpha-linolenic acid, myristic acid, behenic acid, erucic acid, vegetable oil, partially hydrogenated vegetable oil, or mixtures thereof.
